(19) United States
(12) Patent Application Publication
(10) Pub. No.: US 2024/0045394 A1
(43) Pub. Date: Feb. 8, 2024

(54) DRIFT DETECTION APPARATUS, SYSTEM, AND METHOD

(71) Applicant: Baltimore Aircoil Company, Inc., Jessup, MD (US)

(72) Inventor: Yohann Lilian Rousselet, Baltimore, MD (US)

(21) Appl. No.: 18/229,958

(22) Filed: Aug. 3, 2023

Related U.S. Application Data
(60) Provisional application No. 63/394,687, filed on Aug. 3, 2022.

(51) Int. Cl. G05B 19/042; G05B 15/02; G05B 13/02

(52) U.S. Cl. CPC G05B 19/0428; G05B 15/02; G05B 13/0265

(57) ABSTRACT

In one aspect, an air contactor having an airflow generator to generate an airflow, a liquid distribution system operable to distribute liquid that is contacted by the airflow, and a sensor configured to detect an air variable of the airflow. A controller is configured to determine an operating variable of at least one of the airflow generator and the liquid distribution system. The controller is further configured to determine a drift condition of the air contactor based at least in part upon the air variable of the airflow and the operating variable of the at least one of the airflow generator and the liquid distribution system.

### CROSS-REFERENCE TO RELATED APPLICATION

This application claims the benefit of U.S. Provisional Patent Application No. 63/394,687, filed Aug. 3, 2023, which is hereby incorporated by reference herein in its entirety.

### FIELD

This disclosure relates to air contactors and, in particular, to monitoring drift in air contactors.

### BACKGROUND

Various types of air contactors are known, including heat exchanger systems such as direct heat exchanger systems and indirect heat exchanger systems. Some direct heat exchanger systems operate by distributing hot process liquid (e.g., water) over fill sheets and directing ambient air across the liquid-covered fill sheets to remove heat from the process fluid. As the air passes across the liquid-covered fill sheets, the process fluid is cooled as heat is transferred from the liquid to the air.

Some indirect heat exchanger systems are considered wet indirect heat exchanger systems and include an indirect heat exchanger such as a coil, a pillow-type heat exchanger, a plate heat exchanger, and/or a fin-and-tube heat exchanger. A hot process fluid (e.g., water, steam, refrigerant) is directed through a passageway of the indirect heat exchanger. The system distributes an evaporative liquid onto the indirect heat exchanger and generates airflow across the evaporative liquid-covered indirect heat exchanger. The evaporative liquid absorbs heat indirectly from the process fluid to cool the process fluid. Some of the evaporative liquid evaporates as the liquid travels along outer surfaces of the indirect heat exchanger.

One shortcoming of some existing heat exchangers systems that distribute liquid (e.g., distributing process liquid onto fill sheets or distributing evaporative liquid onto an indirect heat exchanger as described above) is that some of the liquid particles are swept up by the flow of air through the heat exchanger and are carried out of the heat exchanger. The liquid particles carried by the air flow, referred to herein as drift, may be undesirable due to chemicals and bacteria in the liquid particles. For example, the liquid particles may land on components outside of the heat exchanger resulting in corrosion and/or scale and mineral buildup. Some heat exchangers include drift eliminators to reduce the amount of drift leaving the heat exchanger, however, such drift eliminators are often not able to remove all drift from the air flowing through the heat exchanger.

### SUMMARY

In one aspect of the present disclosure, an air contactor is provided that includes an airflow generator to generate an airflow, a liquid distribution system operable to distribute liquid that is contacted by the airflow, and a sensor configured to detect an air variable of the airflow. The air variable may include, for example, relative humidity, temperature, and/or particulate matter of the airflow. The air contactor further includes a controller configured to determine an operating variable of at least one of the airflow generator and the liquid distribution system. For example, the airflow generator may include a fan assembly and the liquid distribution system includes a pump. The controller may determine an airflow generator operating variable including a speed of the fan assembly and a liquid distribution system operating variable including whether the pump is on or off. The controller is further configured to determine a drift condition of the air contactor based at least in part upon the air variable of the airflow and the operating variable of the at least one of the airflow generator and the liquid distribution system. In this manner, the controller is able to provide an accurate assessment of the drift of the air contactor using the air variable of the airflow in the air contactor and the operating variable of the at least one of the airflow generator and the liquid distribution system.

The present disclosure also provides a method of operating an air contactor having an airflow generator that produces an airflow. The method includes operating a liquid distribution system of the air contactor to distribute a liquid, the airflow contacting the liquid. The method further includes detecting, via a sensor of the air contactor, an air variable of the airflow; and determining an operating variable of at least one of the airflow generator and the liquid distribution system. The method includes determining a drift condition of the air contactor based at least in part upon the air variable of the airflow and the operating variable of the at least one of the airflow generator and the liquid distribution system. The method thereby facilitates determination of the drift condition using both an air variable of the airflow and an operating variable of the air contactor, rather than relying only on sensing the airflow.

In another aspect, an apparatus is provided for sensing drift in an airflow of an air contactor, the airflow having a first speed in the air contactor. The apparatus includes an inlet to receive a portion of the airflow and an outlet. The apparatus further includes an airflow generator configured to cause the portion of the airflow to have a second speed that corresponds to the first speed of the airflow of the air contactor. A sensor is operable to detect a variable of the portion of the airflow as the portion of the airflow travels at the second speed. The corresponding air speeds inside and outside of the apparatus encourage similar flow rates of particulate and water vapor inside and outside of the apparatus, so that sensing of a variable of the air inside of the apparatus is representative of sensing the air outside of the apparatus.

A method is also provided for sensing drift in an airflow of an air contactor. The method includes determining a variable representative of a first speed of the airflow of the air contactor. The method further includes controlling a drift sensing apparatus to cause a portion of the airflow that enters the drift sensing apparatus at the first speed to travel in a passageway of the drift sensing apparatus at a second speed that corresponds to the first speed. The method includes detecting, via a sensor, a variable of the portion of the airflow as the portion of the airflow travels in the passageway at the second speed. The corresponding air speeds inside and outside of the drift sensing apparatus permit the sensing of the variable of the portion of the airflow in the drift sensing apparatus to be representative of the variable of the airflow outside of the drift sensing apparatus.

### BRIEF DESCRIPTION OF THE DRAWINGS

FIG. 1A is a schematic diagram of a direct heat exchanger system including drift measurement sensors at an air outlet and air inlets of the heat exchanger system.

FIG. 1B is an example block diagram of the cooling tower of FIG. 1A.

FIG. 2 is an example graph illustrating a relationship between monitored variables of the heat exchanger system of FIG. 1A.

FIGS. 3A-3F are example charts indicating how changing conditions of the heat exchanger system of FIG. 1A are used to detect changes in drift.

FIG. 4 is a schematic diagram of a drift measurement sensor of FIG. 1A according to one embodiment.

FIGS. 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, and 35 are schematic diagrams of the drift measurement sensor of FIG. 1A according to other embodiments.

FIG. 36A is a schematic diagram of a heat exchange apparatus having indirect heat exchangers and drift measurement sensors at an air outlet and air inlets of the heat exchange apparatus.

FIG. 36B is a schematic diagram of an alternative configuration of the heat exchange apparatus of FIG. 36A, the heat exchange apparatus of FIG. 36B having a drift measurement sensor intermediate the indirect heat exchangers and fan of the heat exchange apparatus.

FIG. 37A is a schematic diagram of a heat exchange apparatus having indirect heat exchangers adiabatic precoolers upstream of the indirect heat exchangers, the heat exchange apparatus including drift measurement sensors at an air outlet and air inlets of the heat exchange apparatus.

FIG. 37B is a schematic diagram of an alternative configuration of the heat exchange apparatus of FIG. 37A, the heat exchange apparatus of FIG. 37B having drift measurement sensors intermediate the adiabatic coolers and indirect heat exchangers of the heat exchange apparatus.

FIGS. 38, 39, 40, 41, 42, 43, 44, 45, 46, 47, 48, 49, 50, 51, 52, 53 are schematic diagrams of drift measurement sensors according to other embodiments.

FIGS. 54 and 55 are schematic diagrams of the drift measurement sensor of FIG. 1A according to other embodiments.

FIGS. 56A-56E are example charts indicating how changing conditions of the heat exchanger system of FIG. 1A are used to detect changes in drift.

### DETAILED DESCRIPTION

In one aspect of the present disclosure, drift measurement sensors are disclosed that may be used for monitoring conditions of an air contactor to determine a drift rate and/or a change of a drift rate of the air contactor. An air contactor contacts a process fluid, such as a liquid or liquid/gas mixture (e.g. water and water vapor) with air. The air contactor may, for example, transfer heat and/or mass between the fluid and the air. Examples of air contactors include an air pollutant capture system, a packed absorption column, a rotary dryer system, and a heat exchange apparatus such as cooling tower 100. The drift measurement sensors may be mounted at an air inlet and/or an air outlet of the cooling tower and include one or more sensors to monitor air variables of the air flowing into and out of the cooling tower. The air variables may include variables representative of the air itself, such as dry bulb, wet bulb, and/or air pressure, as well as variables representative of particles carried by the air. The particles carried by the air may include, for example, liquid water, aqueous solutions, and/or other liquids such as CO2 capture solution. In one embodiment, drift (e.g., liquid water droplets) may be condensed and pooled, and the one or more sensors include a sensor to detect a variable of the liquid such as conductivity, pH, alkalinity, free chlorine, oxidation-reduction potential (ORP) and/or microorganisms of the pooled water. As another example, the air variables may include a particulate matter sensor configured to detect accumulation rates of differently sized particles, such as salts and other minerals dissolved in liquid water droplets of the drift. The cooling tower 100 may include a controller 162 configured to monitor operating variables of the cooling tower such as the speed of a fan assembly of the cooling tower, whether a liquid distribution system of the cooling tower is distributing liquid, and/or the variable of the liquid being distributed by the liquid distribution system. The controller 162 may be configured to determine a drift condition, e.g., an unacceptable change in drift rate, based upon changes of the air variables and the operating variables of the cooling tower 100.

The drift measurement sensors described herein may be used in a variety of air contactors to determine drift conditions. For example, one or more of the drift measurement sensors disclosed herein may be utilized with an air pollutant capture apparatus that removes pollutants from the air. For example, the air pollutant capture apparatus may utilize a capture medium such as liquid capture solution (e.g., a CO2 capture solution) and a support (e.g., fill sheets). The liquid capture solution may include, for example, an aqueous solution of hydroxide or potassium hydroxide. The liquid capture solution may be sprayed onto the fill sheets, the CO2 capture solution travels along the fill sheets and entrains CO2 from the air into the liquid, and the CO2 capture solution is collected in a sump of the air pollutant capture apparatus. The spraying of the CO2 capture solution onto the fill may create drift of CO2 capture solution within the air pollutant capture apparatus in some situations. A controller associated with the air pollutant capture apparatus may utilize air variables (e.g., the pH of CO2 capture solution drift) and operating variables of the air pollutant capture apparatus to determine whether a detected change in drift is unacceptable and adjust operation of the air pollutant capture apparatus to address the drift condition.

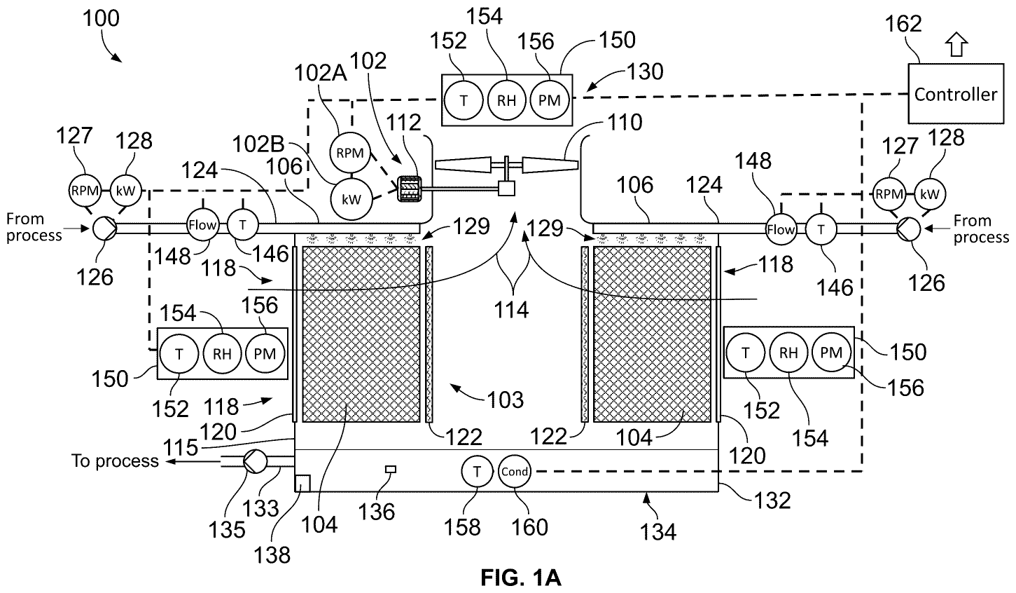

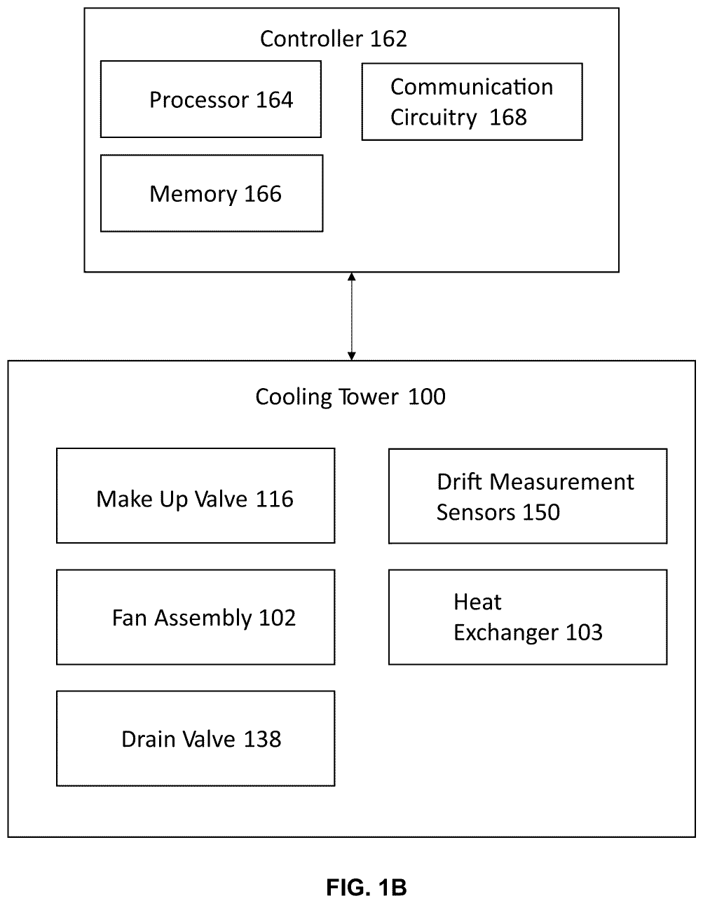

With respect to FIG. 1A, a heat exchange apparatus, such as cooling tower 100, is provided that monitors changes in drift within the cooling tower 100. While a cooling tower is provided by way of example herein, the concepts disclosed in the following discussion may similarly be used in other heat exchanger systems including, for example, swamp coolers, building humidification systems, air handlers, and various applications such as, for example, heat exchanger systems for hospitals, greenhouses, and/or livestock. The heat exchanger systems may utilize direct heat exchangers, wet indirect heat exchangers, and/or adiabatic cooling. Moreover, while a cooling tower 100 having a direct heat exchanger is provided by way of example, the concepts disclosed in the following discussion may similarly be used in other heat exchange systems that discharge liquid, such as indirect heat exchangers. The cooling tower 100 has an airflow generator, such as fan assembly 102 and a heat exchanger 103, such as a direct heat exchanger including fill 104 and a liquid distribution system 106 for distributing process fluid onto the fill 104.

The fan assembly 102 includes a fan 110 and a motor 112 that rotates the fan to generate airflow along paths 114 relative to a housing 115 of the cooling tower 100. Specifically, the fan assembly 102 draws air into air inlets 118 of the housing 115, across outer surfaces of the fill 104, and from the fill 104 to the outlet 130. The air inlets 118 may include a filter 120 mounted within openings of the inlets 118 that filters debris from the air upstream of the fill 104. Alternatively or additionally, the air inlets 118 may include dampers such as louvers that inhibit liquid from splashing out of or exiting the cooling tower 100 through the air inlets 118. The louvers may also prevent ultraviolet light from contacting the water directly which may, for example, inhibit algae growth. The fan assembly 102 includes one or more sensors to monitor operation of the motor 112, such as a motor speed sensor 102A and a motor power sensor 102B.

Upon flowing through the fill 104, the air flows through a drift eliminator 122. The drift eliminator 122 provides tortuous paths for the airflow that cause water in the air to impinge against and collect on surfaces of the drift eliminator 122 while the air travels through the drift eliminator 122. For example, the drift eliminator 122 may include blades or baffles through which air and drift flows from the fill 104 toward the outlet 130. The baffles may form curved and/or angled flow paths that change the direction of the air flowing through the drift eliminator 122 such that drift within the air impacts the baffles and collects in the drift eliminator 122. For instance, when the drift impacts the baffles, the drift loses velocity and collects on interior surfaces of the drift eliminator 122. The water collected by the drift eliminator 122 travels downward under the effect of gravity into the sump 132.

While the drift eliminators reduce the drift within the air, conventional drift eliminators are not able to remove all drift from the air and permit some drift to pass therethrough. Specifically, drift having small particle sizes (e.g., less than 10 micrometers) are often able to flow through conventional drift eliminators. Drift having such small particles sizes may be carried significant distances in the air and, as described above, may contain chemicals and/or bacteria. It may be desired to limit the drift in the cooling tower 100 downstream of the drift eliminators 122 as well as limit the drift being discharged from the cooling tower 100.

The liquid distribution system 106 includes a conduit 124 through which process fluid flows to the cooling tower 100. The process fluid may include, for example, water and/or a glycol (e.g., propylene, ethylene). The process fluid may be fluid heated by a chiller system and transported to the cooling tower 100 for cooling. The liquid distribution system 106 includes a pump 126 operable to pump process fluid through the conduit 124 and into the cooling tower 100. The pump 126 may be operated in response to control signals from a controller 162. For example, the pump 126 may receive a control signal to operate at a certain speed. A speed sensor 127 may be monitor a speed variable of the pump 126, such as pump RPM. The speed sensor 127 may collect and send speed data to the controller 162. A power sensor 128 may monitor a power variable associated with the power consumed by the pump 126, such as kW. The power sensor 128 may collect and communicate the power data to the controller 162. The liquid distribution system 106 may include a temperature sensor 146 for detecting a temperature variable, e.g. degrees Fahrenheit (° F.), of the process fluid in the conduit 124 flowing into the cooling tower 100. The liquid distribution system 106 may include a flowmeter 148 for detecting a flow variable, e.g. gallons per minute, of process fluid flowing into the cooling tower 100 through the conduit 124. The controller 162 may receive data from the temperature sensor 146 and/or flowmeter 148.

The liquid distribution system 106 includes one or more openings, such as nozzles 129, through which the process fluid is pumped and distributed over the fill 104. The nozzles 129 may be fluidly coupled to the conduit 124 such that process fluid pumped through the conduit 124 is pumped through the nozzles 129. The nozzles 129 spray the process fluid onto the fill 104 and the process fluid flows through the fill 104 and drains into the sump 132. The fill 104 may include cubes and/or sheets as some examples. In one embodiment, the fill 104 includes sheets and the process fluid travels downward along the ridges, valleys, etc. of the outer surfaces of the fill sheets under the influence of gravity. In another embodiment, the liquid distribution system may include one or more troughs having openings that permit the liquid to fall onto the fill below the troughs.

The process fluid is cooled by the air flow generated by the fan assembly 102 as the process fluid flows through the fill 104 to the sump 132. The rotation of the fan 110 causes air to move from the air inlets 118, through the fill 104, upward through the fan assembly 102, and out of the air outlet 130 of the cooling tower 100. In one approach, the process fluid flowing through the fill 104 has a higher temperature than the air flowing through the fill 104 such that heat transfers from the higher temperature process fluid to the cooler airflow moving through the fill 104.

The cooled process fluid is collected in the sump 132 and exits the cooling tower 100 via an outlet 133. For example, a pump 135 may direct the cooled process fluid to the chiller system. The cooling tower 100 may include fill level sensor 136, such as a float, that provides a signal indicative of the volume of liquid in the sump. The cooling tower 100 may include a temperature sensor 158 and a conductivity sensor 160 within the sump 132 for monitoring the temperature and conductivity of the fluid within the sump 132. The controller 162 may receive data from the temperature sensor 158 and/or the conductivity sensor 160. The cooling tower 100 may additionally or alternatively include sensors for measuring other variables of the fluid in the sump 132 such as pH, alkalinity, free chlorine, oxidation reduction potential (ORP), and/or microorganisms of the fluid within the sump 132. The sump 132 may have a drain valve 138 that may be opened to drain fluid from the sump 132 and out of circulation within the cooling tower 100. The drain valve 138 may be opened to drain fluid from the sump 132, for example, as part of a liquid changeover process, e.g., when the conductivity and/or pH of the process fluid exceeds a threshold(s).

The cooling tower 100 may include one or more drift measurement sensors 150 to monitor one or more variables of the cooling tower 100, for example, variables relating to air quality conditions. As shown in FIG. 1A, the cooling tower 100 may include a drift measurement sensor 150 at the air outlet 130 of the cooling tower 100 and one or both of the air inlets 118. The drift measurement sensors 150 may include sensors to monitor variables indicative of drift as discussed in greater detail below.

In one embodiment, one or more of the drift measurement sensors 150 include a temperature sensor 152, a relative humidity sensor 154, and a particulate matter sensor 156. The temperature sensor 152 may detect the dry bulb temperature of the air. The particulate matter sensor 156 is operable to detect the quantity of particles in the air, for example, water particles carried in the air and/or in liquid droplets in the air. The particulate matter sensor 156 may provide a rate of particulates (e.g., a particle count per minute or hour). The particulate matter sensors 156 may detect particles such as dust, soot, smoke and other chemicals or pollutants in the air, for example, those emitted from power plants, industries, and/or automobiles. Some particulate matter sensors 156 may include a membrane configured to permit certain sizes of particles to pass therethrough. The particulate matter sensor 156 may be operable to detect the particles passing through the membrane to measure the amount of particles in the air and drift. Some particulate matter sensors 156 may use a light scattering technique to detect the concentration of particles in the air, for example, passing a beam of light through a sample of the air and detecting the scatter of the light beam by the particles in the sample of air. The particulate matter sensor 156 may include multiple sensors for detecting particles of different size ranges for example, a PM2.5 sensor for detecting particles having a width less than 2.5 micrometers and a PM10 sensor for detecting particles having a width less than 10 micrometers. Other particulate matter sensors may additionally or alternatively be used to measure particulates of other sizes, for instance, a PM1 sensor for detecting particles having a width less than 1 micrometer.

With respect to FIG. 1B, the cooling tower 100 is associated with a controller 162 that controls the operation of the cooling tower 100 including the fan assembly 102 and liquid distribution system 106. The controller 162 may be integrated with or remote from the cooling tower 100. The controller 162 includes a processor 164, memory 166, and communication circuitry 168. The processor 164 communicates with the memory 166 to provide functionality to the cooling tower 100. The processor 164 may be configured to provide information processing capabilities and may include a plurality of processing units in communication with one another. The processor 164 may include, as examples, a digital processor, an analog processor, a PID controller, a microprocessor, a microcontroller, application-specific integrated circuit (ASIC), and/or a system-on-a-chip. The memory 166 may store logic, instructions, and operating variables accessible to the processor 164 for operating the cooling tower 100. The memory 166 may include, e.g., RAM, DRAM, SDRAM, EEPROM, ROM, flash memory, and/or a hard drive. The communication circuitry 168 may include, as examples, a wired and/or a wireless interface. Examples include an ethernet interface, a Wi-Fi network interface, and/or Bluetooth interface. The processor 164 receives data from the sensors of the cooling tower 100 to monitor the operation of the cooling tower 100. For instance, the processor 164 may receive data from the drift measurement sensors 150, inlet process fluid temperature sensor 146, flow rate sensor 148, pump speed sensor 127, pump power sensor 128, sump fluid temperature sensor 158, sump fluid conductivity sensor 160 and other sensors of the cooling tower 100. The processor 164 may receive control signals from, and communicates data with, a remote computer such as a HVAC system controller via the communication circuitry 168. As another example, the processor 164 may communicate with a remote device such as a server computer and/or a portable electronic device of a technician such as a smartphone, tablet computer, or laptop computer.

The processor 164 may receive a control signal including a set point temperature for the process fluid, e.g., the temperature of the process fluid leaving the cooling tower 100 via the outlet 133. The processor 164 may determine operating variables for the cooling tower 100 to meet the set point temperature. For example, the processor 164 may control the speed of the inlet pump 126, and/or fan assembly 102. The processor 164 may communicate control signals to the fan assembly 102 and/or the liquid distribution system 106 to meet the set point temperature. The processor 164 may communicate the control signals to the fan assembly 102 and/or the liquid distribution system 106 via the communication circuitry 168. The controller 162 may be connected to multiple cooling towers 100 and configured to operate each cooling tower 100 to meet the cooling demands of the associated building, as one example. The communication circuitry 168 may be configured to communicate via wired and/or wireless communication protocols, such as Ethernet, Wi-Fi, Bluetooth, cellular and the like.

The controller 162 operates the fan assemblies 102 to generate airflow through the cooling tower 100. The controller 162 may operate the fan assembly 102 to draw air through the fill 104 to cool the fluid flowing therethrough. The controller 162 may also operate the liquid distribution system 106 to control the distribution of the process fluid onto the fill 104. For example, the controller 162 may adjust the speed of the inlet pump 126 to increase or decrease the flow rate of process fluid through the conduit 124.

Operating the fan assembly 102 and/or inlet pump 126 at high or low speeds may increase the drift in the air downstream of the drift eliminators 122. As explained above, the drift eliminators 122 often are not able to remove all of the drift from the air and thus drift may flow to the fan assembly 102 and out of the cooling tower 100. Drift eliminators are typically most effective in the middle of the designed air velocity range, while being less effective at lower and higher air velocities in the designed air velocity range.

Drift from cooling towers is often undesirable due to, for example, corrosion caused by the drift, mineral deposits left behind from the drift, and the visual appearance of the drift exiting the cooling tower 100. The controller 162 is able to detect drift of the cooling tower 100 by monitoring variables of the cooling tower 100. In one embodiment, the controller 162 detects a change in drift based upon changes in the variables of the cooling tower 100 gathered by the sensors of the cooling tower 100 and responds accordingly. For example, if the controller 162 determines that the drift downstream of the drift eliminators 122 is increasing, the controller 162 may adjust operation of the cooling tower 100 to reduce drift and/or alert the user of the increasing drift such as by sending a SMS message or an email.

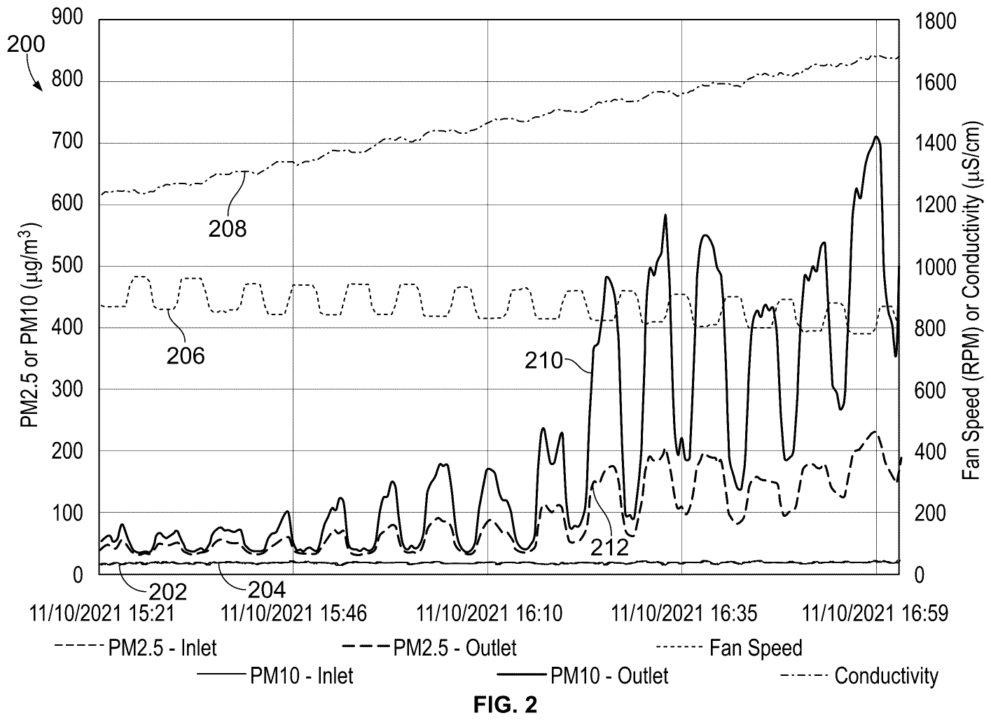

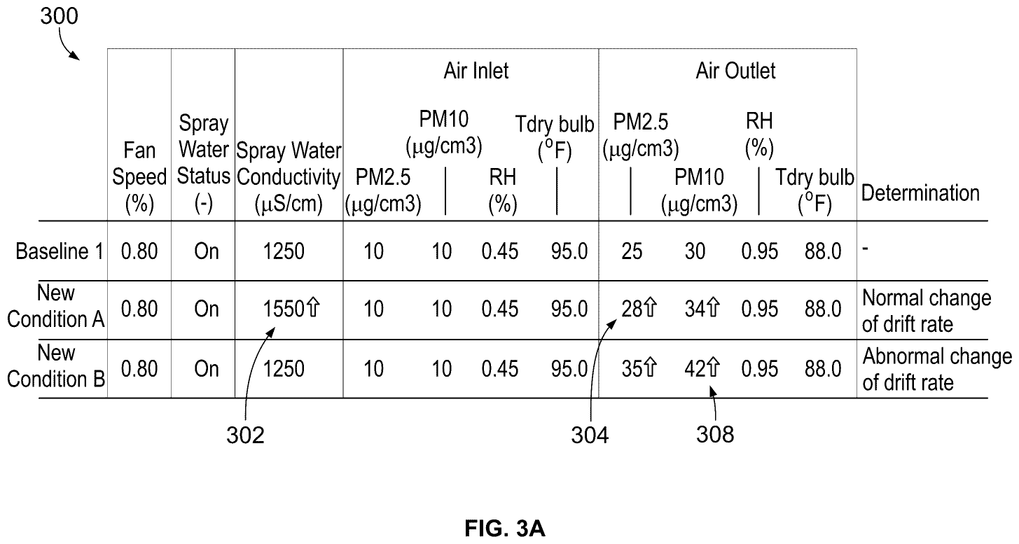

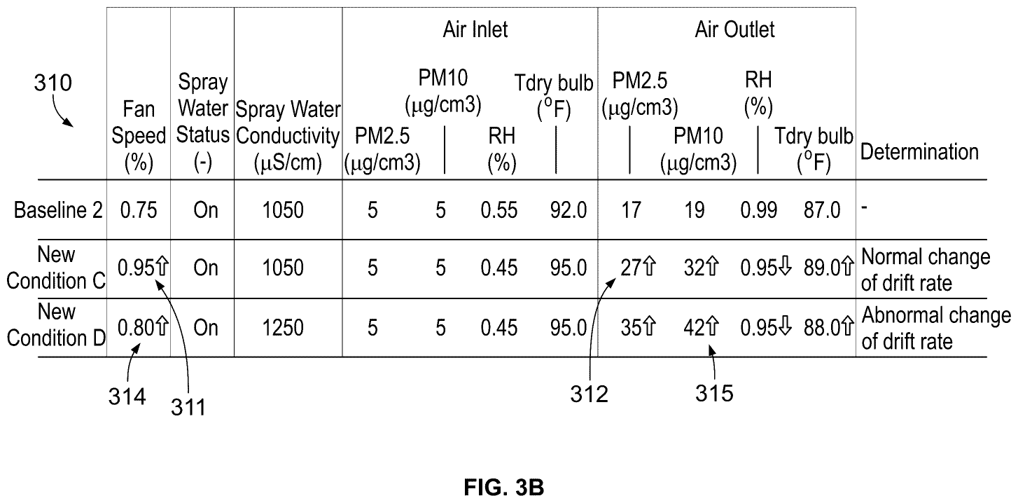

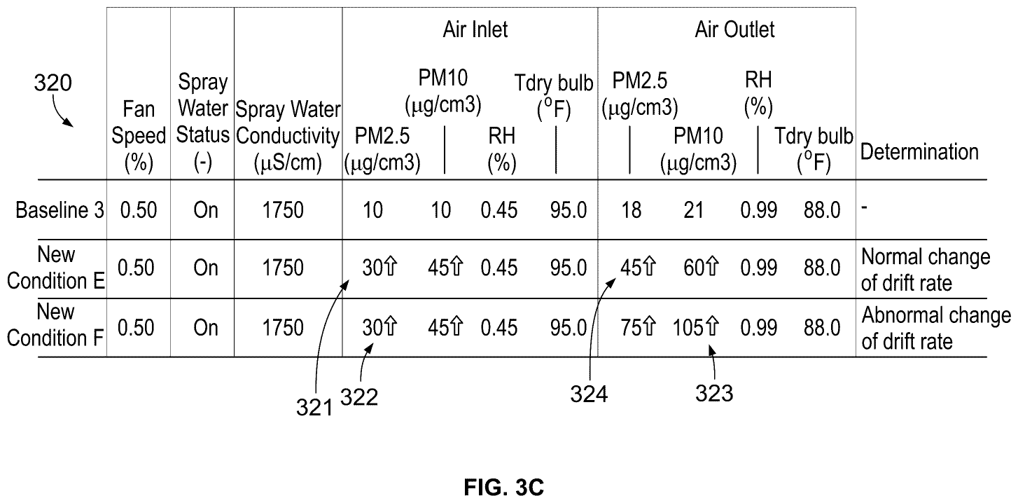

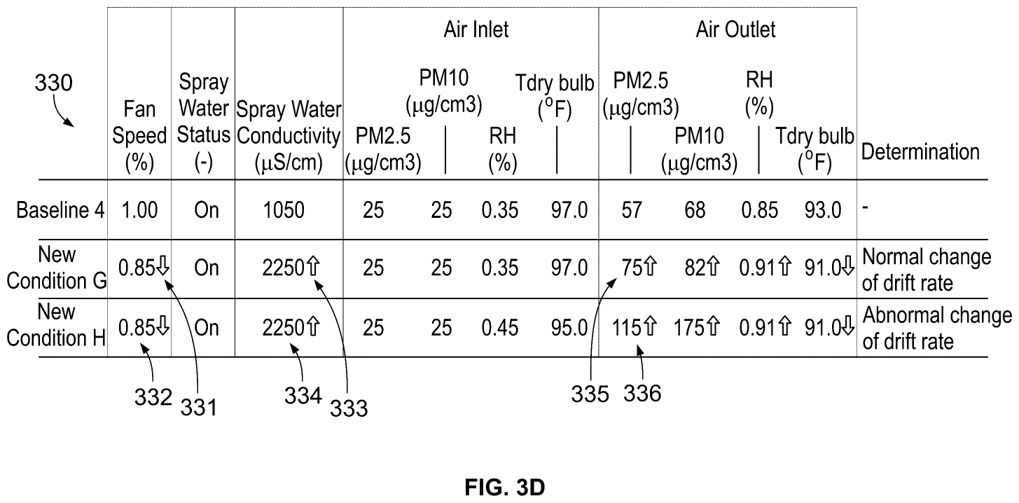

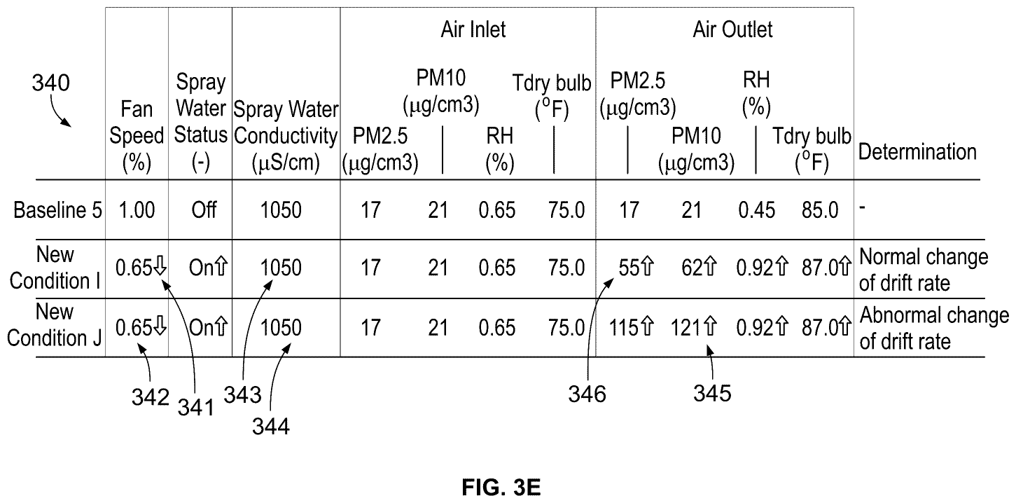

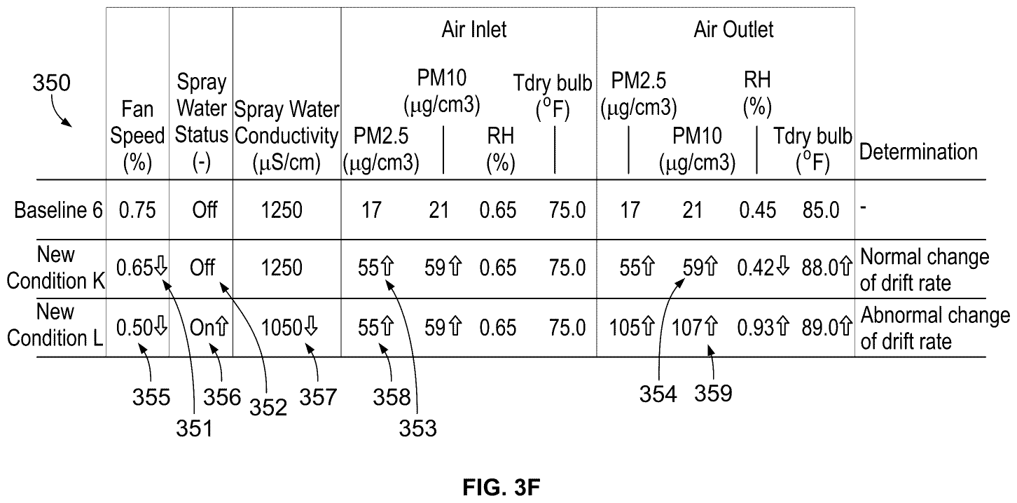

With respect to FIG. 2, an example graph 200 is provided illustrating the relationship between variables monitored by the cooling tower 100 that may be used to determine changes in the drift rate of the cooling tower 100. The controller 162 may receive data from the drift measurement sensors 150 mounted at the air inlet 118 and air outlet 130 of the cooling tower 100. Line 202 indicates the amount of particulate matter having a particle size less than 2.5 micrometers detected by the particulate matter sensor 156 of the drift measurement sensor 150 at the air inlet 118 of the cooling tower 100 over time. Line 204 indicates the amount of particulate matter having a particle size less than 10 micrometers detected by the particulate matter sensor 156 of the drift measurement sensor 150 at the air inlet 118 of the cooling tower 100 over time. Line 206 indicates the speed of the fan assembly 102 as the controller 162 operates the fan assembly 102 to cool the process fluid flowing through the fill 104 over time. Line 208 indicates the conductivity of the process fluid 134 (see FIG. 1A) in the sump 132 over time. The controller 162 may detect the conductivity of the liquid using the conductivity sensor 160 of the sump 132. As the process fluid is recirculated through the cooling tower 100, some of the water in the process fluid may evaporate which increases the concentration of salts and other particulates within the water and causes the conductivity of the liquid to increase. Line 210 indicates the amount of particulate matter having a particle size less than 2.5 micrometers detected by the particulate matter sensor 156 of the drift measurement sensor 150 at the air outlet 130 of the cooling tower 100 over time. Line 212 indicates the amount of particulate matter having a particle size less than 10 micrometers detected by the particulate sensor 156 at the air outlet 130 of the cooling tower 100 over time. The controller 162 may monitor the changes in particulate matter at the outlet 130 to determine whether the drift rate of the cooling tower 100 is increasing or whether the amount of particulate matter at the air outlet 130 is attributable to other factors as discussed in further detail with respect to FIGS. 3A-3F. As shown, as the conductivity of the fluid increases (as indicated by line 208), the amount of particulate matter detected at the air outlet 130 of the cooling tower 100 increases which may be indicative of an increase in the drift rate of the cooling tower 100.

With respect to FIGS. 3A-3F, example charts are provided showing how changing conditions of the cooling tower 100 may be used to detect changes in the drift rate of the cooling tower 100. In these examples, the controller 162 monitors cooling tower variables including cooling tower operating variables such as the speed of the fan assembly 102, whether the liquid distribution system 106 is distributing liquid, the conductivity of the liquid distributed by the liquid distribution system 106. The cooling tower operating variables further include air variables such as the particulate matter (PM2.5 and PM10) at the air inlets 118 and air outlet 130 of the cooling tower 100, and the relative humidity and temperature of the air at the air inlets 118 and air outlet 130 of the cooling tower 100. These conditions are provided by way of example and fewer or additional variables may be monitored and/or used to evaluate drift conditions. For example, the controller 162 may monitor a flow rate of the liquid distribution system 106. Based on the monitored variables, a change in drift rate of the cooling tower 100 may be detected. For example, a change in the amount of particulate matter at the air outlet 130 may be evaluated to determine whether the change is due to a change in drift rate or whether the change is attributable to another changing condition of the cooling tower 100. In some embodiments, the controller 162 may be programmed to evaluate the changing conditions of the cooling tower 100 to determine whether the drift rate of the cooling tower 100 is changing a normal amount or an abnormal amount based on the examples discussed below with respect to FIGS. 3A-3F. If the controller 162 determines the change in the drift rate is abnormal or unacceptable, the controller 162 may be programmed to change operation of the cooling tower 100 to decrease the drift rate such as changing the cooling tower 100 from a wet mode to a dry mode, decreasing fan speed, and/or notifying a maintenance worker. The fan speed is provided as a decimal representing a percentage, e.g., 0.80 indicates the fan assembly is operating at 80% of the maximum fan speed.

With respect to FIG. 3A, an example chart 300 is provided where the conditions of the cooling tower 100 change from a baseline condition (“Baseline 1”) to New Condition A or new Condition B. In changing from Baseline 1 to New Condition A, the conductivity 302 of the liquid of the liquid distribution system 106 increases from 1250 μS/cm to 1550 μS/cm. Likewise, the amount of PM2.5 and PM10 particulate matter 304 at the air outlet 130 increases from 25 μg/cm³ and 30 μg/cm³, respectively, to 28 μS/cm³ and 34 μS/cm³. The increase in the particulate matter at the air outlet 130 may be attributable to the increase in the conductivity of the liquid of the liquid distribution system 106. For example, the amount of particles in the liquid droplets of the drift carried from the fill 104 may have increased because the concentration of particles in the process fluid of the liquid distribution system 106 has increased as indicated by the increase in conductivity 302. The amount of liquid droplets carried in the air flow, however, may have increased within a predetermined range of an expected increase in the amount of liquid droplets carried in the air flow attributable to, for example, an increase in water surface tension due to the increase in concentration of particles in the process fluid. Thus, the system controller makes a determination that there has been an expected or normal change in the drift rate of the cooling tower 100.

In changing from the Baseline 1 to New Condition B, the amount of PM2.5 and PM10 particulate matter 308 detected at the air outlet 130 of the cooling tower 100 increases from 25 μS/cm³ and 30 μS/cm³, respectively, to 35 μS/cm³ and 42 μS/cm³ while the other monitored variables remain the same. The controller 162 determines that the drift rate of the cooling tower 100 has increased abnormally because no other variables of the cooling tower 100 have changed that could be causing the increased amount of particulate matter at the air outlet 130 and the change in the amount of particulate matter is outside of the predetermined range of expected change in the particulate matter. For example, the controller 162 may determine that the increase in particulate matter is not the result of a change in another monitored variable of the cooling tower 100 and is due to the drift rate of the cooling tower 100 increasing.

With respect to FIG. 3B, an example chart 310 is provided illustrating an evaluation of the change of the speed of the fan assembly 102 on the drift rate determination. In changing from Baseline 2 to New Condition C, the speed 311 of the fan assembly 102 increases by 20% and the amount of PM2.5 and PM10 particulate matter 312 at the air outlet 130 increases, respectively, from 17 μg/cm³ to 27 μg/cm³ and from 19 μg/cm³ to 32 μg/cm³. The increase in the PM2.5 and PM10 particulate matter may be attributable to the increase in the speed of the fan assembly 102 without the drift rate of the cooling tower 100 increasing significantly or beyond an expected drift rate at these operating conditions of the cooling tower 100. For example, increasing the speed of the fan assembly 102 may cause a larger volume of air to move relative to the PM2.5 and PM10 sensors resulting in higher PM2.5 and PM10 readings.

In changing from the Baseline 2 to New Condition D, the speed 314 of the fan assembly 102 increases by 5% and the amount of detected PM2.5 and PM10 particulate matter 315 more than doubles. The magnitude of the increase in PM2.5 and PM10 particulate matter is high given the increase in the speed of the fan assembly 102, for example, when compared to the increase in fan speed and particulate matter in changing from the same Baseline 2 to New Condition C. A determination may be made that the drift rate of the cooling tower 100 has increased because the increase in particulate matter at the air outlet 130 cannot be attributed entirely to the increase in the speed of the fan assembly 102 or any other monitored conditions. In other words, some increase in the PM2.5 and PM10 particulate matter readings may be attributed to the increase in the speed of the fan assembly 102 as with New Condition C; however, where the increase in the magnitude of the PM2.5 and PM10 particulate matter readings is disproportionately high compared to the increase in the speed of the fan assembly 102 in New Condition D, a determination may be made that the drift rate has increased abnormally, e.g., beyond an acceptable or expected drift rate at these operating conditions of the cooling tower 100. Although the particulate matter increases in changing from the Baseline 2 to New Condition C and New Condition D, only the increase in particulate matter from the Baseline 2 to New Condition D is considered anomalous and triggers a determination of an unacceptable or abnormal increase in drift.

With respect to FIG. 3C, an example chart 320 is provided illustrating an evaluation of the change in the magnitude of the particulate matter at the air inlet 118 of the cooling tower 100 while the other monitored variables remain the same. In changing from the baseline condition of Baseline 3 to New Conditions E and F, the amount of PM2.5 and PM10 particulate matter 321, 322 at the air inlet 118 increases the same amount. In changing to New Condition F, however, the amount of PM2.5 and PM10 particulate matter 323 at the air outlet 130 increases more than the amount of PM2.5 and PM10 particulate matter 324 increases during the transition from the Baseline 3 to New Condition E. For New Condition E, the increase in the PM2.5 and PM10 particulate matter 324 at the air outlet 130 may be attributable to the increase in particulate matter entering the cooling tower 100 at the air inlet 118 and thus a determination may be made that there has been no significant increase in drift rate. For New Condition F, the particulate matter 323 at the air outlet 130 increased significantly and/or disproportionately relative to the increase in the particulate matter at the air inlet 118 (e.g., when compared to the change from the baseline condition of Baseline 3 to New Condition E). Thus, a determination may be made that that the drift rate of the cooling tower 100 has increased abnormally beyond an acceptable or expected drift rate at these conditions.

With respect to FIG. 3D, an example chart 330 is provided illustrating an evaluation of the change in the speed of the fan assembly 102 and in the conductivity of the liquid of the liquid distribution system 106. In changing from the baseline condition of Baseline 4 to New Conditions G and H, the speed 331, 332 of the fan assembly is reduced 15% and the conductivity 333, 334 of the water increases. In New Condition H, however, the amount of PM2.5 and PM10 particulate matter 336 at the air outlet 130 of the cooling tower 100 is greater than the amount of particulate matter 335 in New Condition G. In New Condition G, the increase in the PM2.5 and PM10 particulate matter 335 at the air outlet 130 is attributable to the increase in the conductivity of the liquid of the liquid distribution system 106 despite the decrease in the speed 331 of the fan assembly 102 and thus there has been no significant increase in drift rate. In New Condition H, the amount of particulate matter 336 at the air outlet 130 increased significantly and/or disproportionately relative to the increase in the conductivity 334 of the liquid of the liquid distribution system 106 and reduced speed 332 of the fan assembly 102 (e.g., compared to the change to New Condition G). The controller 162 determines that the increase in particulate matter 336 at the air outlet 130 is the result of an abnormal increase in the drift rate of the cooling tower 100 beyond an acceptable or expected drift rate at these conditions because the increase in particulate matter 335 is not entirely attributable to the increase in conductivity 334 of the liquid or any other monitored condition.

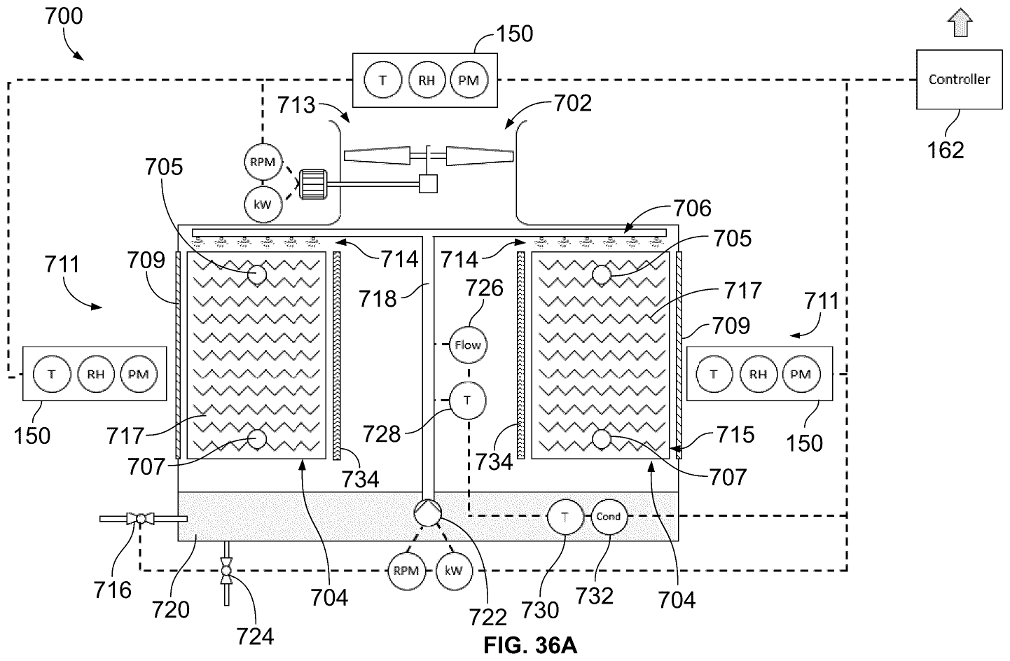

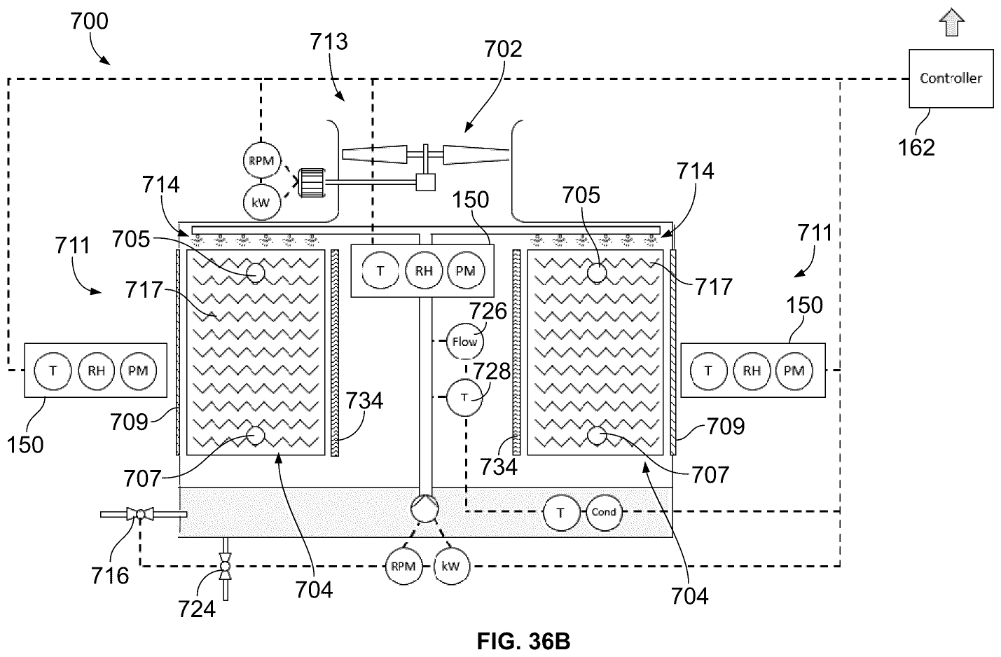

With respect to FIGS. 3E and 36A, an example chart 340 is provided for a heat exchange apparatus with an indirect heat exchanger such as heat exchange apparatus 700. The chart 340 illustrates an evaluation of a change in the speed of the fan assembly 702 and where liquid distribution system 706 begins distributing fluid on an indirect heat exchanger such as pillow plate heat exchangers 717. The liquid distribution system 706 may be turned on to spray water on the pillow plate heat exchangers 717 to aid in cooling to process fluid, for example, in addition to the cool air passed over the pillow plate heat exchangers 717 by the fan assembly 702. In changing from the baseline condition Baseline 5 to New Conditions I and J, the speed 341, 342 of the fan assembly 702 is reduced 35% and the liquid distribution system 706 is turned on 343, 344. The amount of PM2.5 and PM10 particulate matter 345 at the air outlet 713 of the heat exchange apparatus 700 in New Condition J is greater than the particulate matter 346 in New Condition I. Regarding the change to New Condition I, even where the speed of the fan assembly 702 was reduced, the increase in the PM2.5 and PM10 particulate matter at the air outlet 713 is attributable to the liquid distribution system 706 now spraying or distributing liquid and is not indicative of a significant increase in drift rate. Regarding the change to new condition J, the particulate matter 345 at the air outlet 713 increased significantly more than is attributable merely to spraying liquid via the liquid distribution system 706. Because increase in particulate matter 345 at the air outlet 713 is not entirely attributable to a monitored condition, the drift rate of the heat exchange apparatus 700 is determined to have increased beyond an acceptable or expected drift rate at these operating conditions of the heat exchange apparatus 700.

With respect to FIG. 3F, an example chart 350 is provided illustrating an evaluation of a change in particulate matter at the air outlet 713 of the heat exchange apparatus 700 to determine whether there has been a change in drift rate. In changing from the baseline condition Baseline 6 to New Condition K, the speed 351 of the fan assembly 702 is reduced, liquid distribution system 706 remains off 352 (e.g., is not spraying liquid), the particulate matter 353 at the air inlet 711 increases, and the particulate matter 354 at the air outlet 713 increases. In changing to New Condition K, there has been no increase in drift rate because there cannot be a significant amount of drift when the liquid distribution system 706 is off and not distributing liquid. When the liquid distribution system 706 is off, there are no liquid droplets being sprayed by the liquid distribution system 706 to be swept away in the air flowing from the air inlets 711 to the outlet 713. The increase in particulate matter at the air outlet 713 may thus be attributed to the increase in particulate matter entering the heat exchange apparatus at the air inlet 711.

In changing from the Baseline 6 to New Condition L, the speed 355 of the fan assembly 702 is reduced, the liquid distribution system 706 is turned on 356, the conductivity 357 of the liquid of the liquid distribution system decreases, the particulate matter 358 at the air inlet 711 increases, and the particulate matter 359 at the air outlet 713 increases. While the fan speed and conductivity of the liquid decreased, there was a significant increase in particulate matter at the air outlet 713. This significant increase in particulate matter at the air outlet 130 cannot be entirely attributed to the increase in particulate matter at the air inlets 711 and the liquid distribution system 706 being turned on. Thus, the controller 162 may determine that the drift rate of the heat exchange apparatus 700 has increased beyond an acceptable or expected drift rate at these conditions.

In some forms, the controller 162 of the heat exchange apparatus, such as cooling tower 100 or heat exchange apparatus 700, monitors the changes in the conditions of the heat exchange apparatus and determines whether the drift rate has increased. To determine whether the drift rate of the heat exchange apparatus has changed (e.g., increased), the controller 162 may compare changes in conditions of the heat exchange apparatus with datasets known to correspond to changes in drift conditions or datasets known to correspond to no significant change in drift conditions such as the datasets provided in the charts of FIGS. 3A-3F. In some forms, the controller 162 uses a machine learning algorithm to process the monitored variables to determine whether, for example, an increase in the particulate matter at an air outlet of the heat exchange apparatus is attributable to a change in a condition of the heat exchange apparatus or is the result of an increase in the drift rate of the heat exchange apparatus.

Where the controller 162 determines that the drift rate of the heat exchange apparatus has increased, the controller 162 may send an alert indicating that the drift rate of the heat exchange apparatus has increased. The controller 162 may alert an operator of the heat exchange apparatus to allow the operator to, for example, measure the amount of drift via another approach to validate whether there is drift and/or determine whether the drift is an acceptable amount, to determine whether to adjust the operation of the heat exchange apparatus, and/or to investigate why the drift rate is increasing. The controller 162 may enter a failsafe operating mode to operate the heat exchange apparatus to mitigate drift, such as operating in a dry mode or reducing the flow rate of evaporative liquid sprayed onto an indirect heat exchanger of the heat exchange apparatus. In some forms, the controller 162 may notify a controller of the HVAC system of the building that the drift rate of the heat exchange apparatus is increasing to permit the HVAC system to adjust operation of the HVAC system to reduce the drift of the heat exchange apparatus.

While the above examples describe the controller 162 determining whether the drift rate is acceptable based on changing variables of the cooling tower, the controller 162 may also be able to determine whether the drift rate of the cooling tower is acceptable based on the current variables of the cooling tower, for example, without evaluating the change in drift rate relative to a changing cooling tower variable. In other words, the controller 162 may evaluate whether the drift rate of the cooling tower is acceptable at a given time when operating at certain operating variables of the cooling tower given the air quality conditions the cooling tower is operating in. The controller 162 may, for example, determine whether the drift rate is normal or abnormal by comparing the variables of the cooling tower with datasets of cooling tower variables known to correspond to normal or abnormal drift conditions. As another example, the controller 162 may use a machine learning algorithm to evaluate whether the drift rate of the cooling tower is acceptable with the current cooling tower operating variables and the air variables.

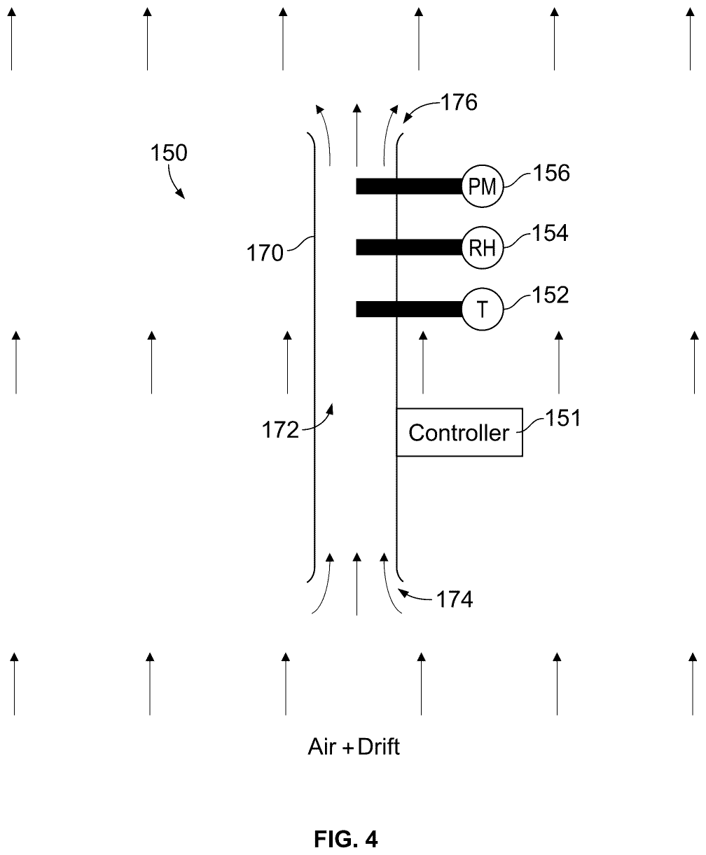

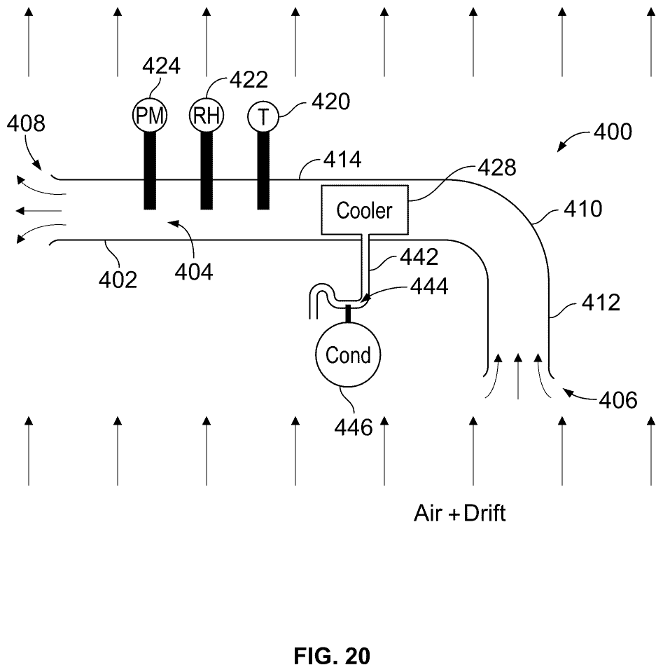

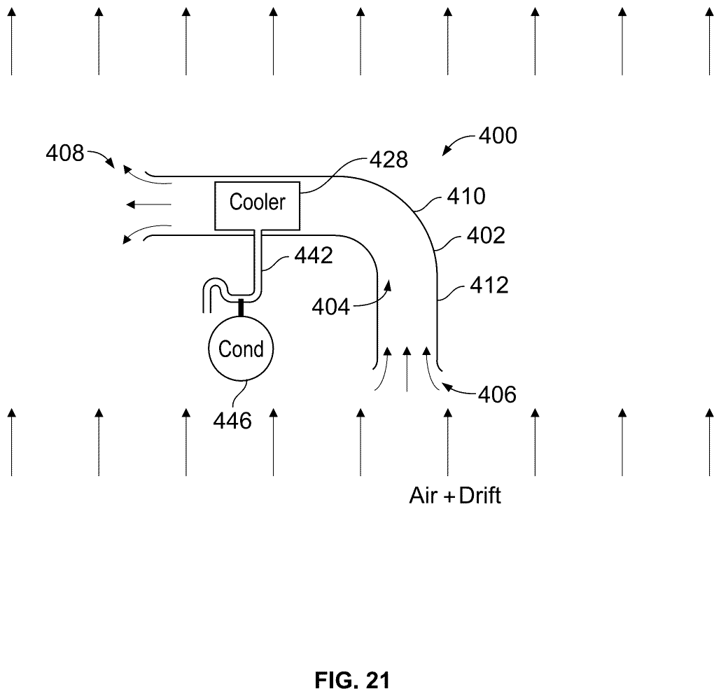

With respect to FIG. 4, the drift measurement sensor 150 is shown according to one embodiment. The drift measurement sensor 150 includes a conduit, such as a tube 170, defining a passageway 172 through which air may flow through the drift measurement sensor 150. The tube 170 may have a sidewall extending about the passageway 172. The drift measurement sensor 150 includes an inlet 174 through which air is able to flow into the passageway 172 and an outlet 176 through which air is able to exit the passageway 172. The drift measurement sensor 150 includes one or more sensors mounted to the conduit 170 for measuring conditions of the air flowing through passageway 172 of the drift measurement sensor 150. The drift measurement sensor 150 may include the temperature sensor 152, the relative humidity sensor 154, and the particulate matter sensor 156 (e.g., one or more sensors for measuring PM2.5 and PM10). These sensors may be mounted closer to the outlet 176 of the drift measurement sensor 150 than the inlet 174 which may, for example, aid to ensure that the airflow through the drift measurement sensor 150 is substantially uniform. The sensors may be mounted within the passageway 172 such that the obstruction of the flow of air, particles, and debris through the passageway 172 by the sensors is minimized. This may ensure an accurate reading of the air quality variables while minimizing the collection of the liquid droplets, particles and debris on the sensors and within the passageway 172. The drift measurement sensor 150 may be positioned in the path of the airflow 114 through the cooling tower 100 with the inlet 174 of the drift measurement sensor 150 upstream of the outlet 176 to direct airflow into the inlet 174 of the drift measurement sensor 150. As shown in FIG. 1, drift measurement sensors 150 may be positioned at the air inlets 118 and air outlets 130 of the cooling tower 100 to monitor conditions of the air as the air enters the cooling tower 100 and as the air exits the cooling tower 100. In one embodiment, the drift measurement sensor 150 includes a conductivity sensor for collecting water and detecting the conductivity of the collected water (see, e.g., FIGS. 20 and 21). The drift measurement sensor 150 may include a controller 151 that controls operation of the components of the drift measurement sensor 150 including the sensors 152, 154, 156. The controller 151 may be in communication with the controller 162 of the cooling tower 100 and facilitates communication of data between the sensors 152, 154, 156 and the controller 151. In some forms, the controller 151 is omitted and the controller 162 of the cooling tower 100 controls operation of the components of the drift measurement sensor 150. It will be appreciated that the other embodiments of drift measurement sensors disclosed herein may include a controller similar to the controller 151, but the controllers are generally omitted from the associated figures for clarity.

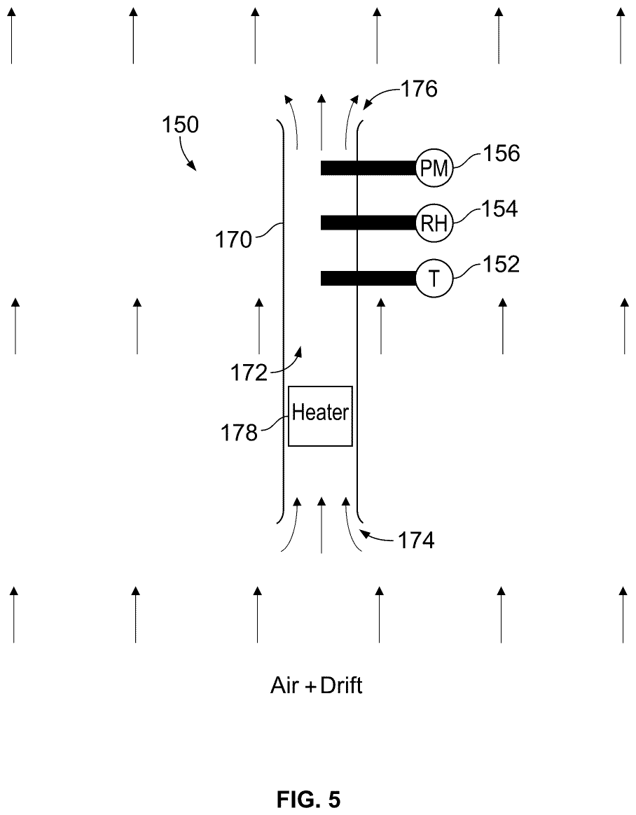

With respect to FIG. 5, the drift measurement sensor 150 may further include a dehumidifier such as a heater 178. The heater 178 may be mounted to the conduit 170 and may be operated to dry the air entering the inlet 174 of the drift measurement sensor 150. The heater 178 may be mounted upstream of the sensors of the drift measurement sensor 150 to dry the air before the air passes the sensors. The heater 178 dries the air by increasing the dry bulb temperature of the air which lowers the relative humidity or the air. The heater 178 may be used to lower the relative humidity of the air and/or to evaporate drift droplets so that the PM2.5 sensor, PM10 sensor, and other sensors of the drift measurement sensor are able to operate properly. In another embodiment, the dehumidifier of the drift measurement sensor 150 may include a vapor permeable membrane configured to remove water vapor from the air. The membrane may be water permeable, while being non-permeable to salts and other dissolved solids. The membrane may be sized and shaped to limit the particle collection on the membrane while allowing for efficient moisture removal.

Drying the air flowing into the drift measurement sensor 150 may reduce the accumulation of water droplets of the drift entering the drift measurement sensor 150 from accumulating on the sensors within the passageway 172. Accumulation of water on the sensors may reduce the accuracy of the measurements of the sensors and may cause the sensors to fail. In some forms, the particulate matter sensor 156 is able to detect the salts left behind by the evaporated water droplets. The drift measurement sensor 150 is therefore able to detect the particulate matter in the airflow even when the heater 178 causes the water of the water droplets of the drift to evaporate. The heater 178 may be mounted to minimize the obstruction of the passageway 172 while heating the air flowing therethrough. Such a configuration allows the heater 178 to heat the air while minimizing the collection of the liquid droplets, particles and debris on the heater 178 and within the passageway 172 that may interfere with the sensor readings downstream of the heater 178. For example, the heater 178 may be flush with an inner surface of the tube 170.

The controller 151 may operate the heater 178 based on the temperature and/or relative humidity of the air. For example, the controller 151 may operate the heater 178 when the humidity of the air is high to dry the air and inhibit water from collecting on the interior of the tube 170, sensors, or other portions of the drift measurement sensor 150. For example, the controller may be programed to calculate the probability of plume formation based on the temperature and humidity of the air and operate the heater 178 to reduce the probability of plume formation and condensation, for example, within the drift measurement sensor 150.

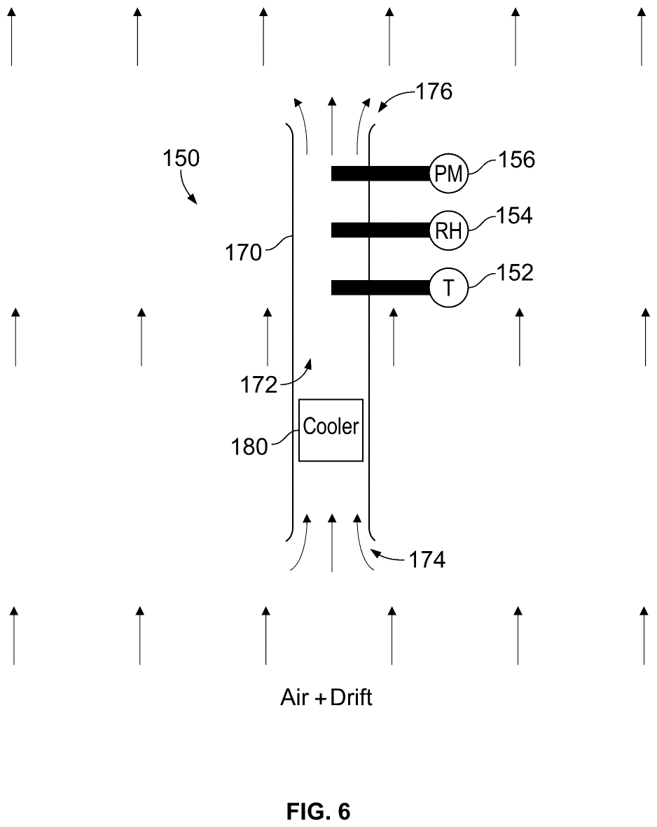

With respect to FIG. 6, the drift measurement sensor 150 may include a cooler 180, such as a cooling coil. The cooler 180 may be mounted within the passageway 172 and may be operated to cool the air entering the inlet 174 of the drift measurement sensor 150. The cooler 180 may be mounted upstream of the sensors of the drift measurement sensor 150 and used to condense the water from the air before the air flows past the sensors. As with the heater 178, drying the air flowing into the drift measurement sensor 150 may aid to reduce the accumulation of water and moisture on the sensors within the passageway 172. The cooler 180 may condense the moisture from the air and aggregate drift droplets within the passageway 172 before the droplets reach the sensors. The cooler 180 may be mounted in the passageway 172 to minimize the obstruction of the passageway 172 while cooling the air flowing therethrough. Such a configuration allows the cooler 180 to cool the air and condense moisture from the air while minimizing the collection of the liquid droplets, particles and debris on the cooler 180 and within the passageway 172 that may interfere with the sensor readings downstream of the cooler 180. For example, the cooler 180 may have a cooling surface that is flush with an inner surface of the tube 170. In some embodiments, the cooler 180 may collect the moisture condensed from the air and measure the conductivity of the condensation to determine a drift rate of the cooling tower as described in further detail below with respect to the drift measurement sensor 400 of FIG. 20.

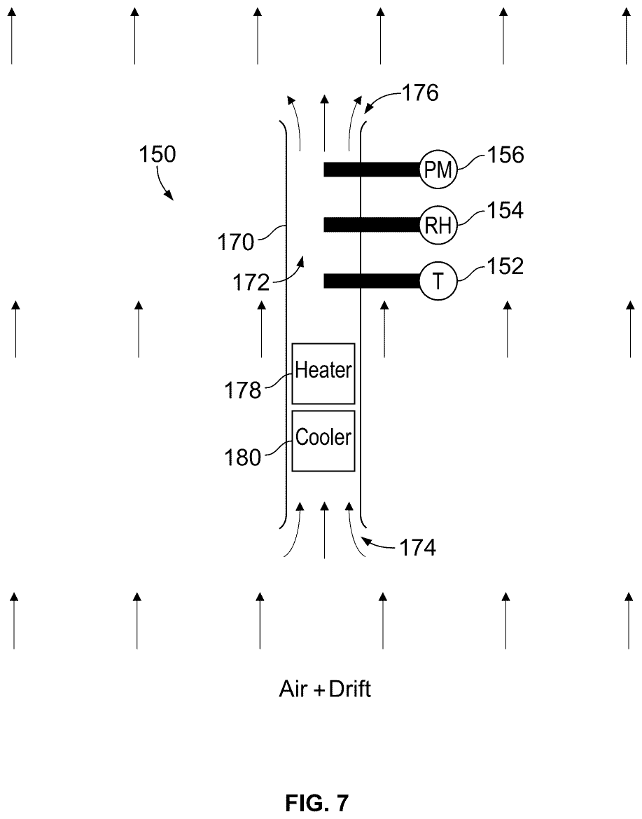

With respect to FIG. 7, in another embodiment the drift measurement sensor 150 may include both a heater 178 and a cooler 180. The heater 178 and the cooler 180 may be mounted within the passageway 172 to dry the air before the air reaches the sensors as described above. The cooler 180 may cool the air and condense the moisture from the air before the air flows through the heater 178. The heater 178 may heat the air and may further aid to dry the air before the air flows over the sensors. The heater 178 may be operated to return the temperature the air to the temperature of the air entering the inlet 174. While the heater 178 is shown downstream of the cooler 180, in other forms, the heater 178 may be upstream of the cooler 180 to increase the dry bulb temperature of the air before the moisture is condensed from the air by the cooler 180.

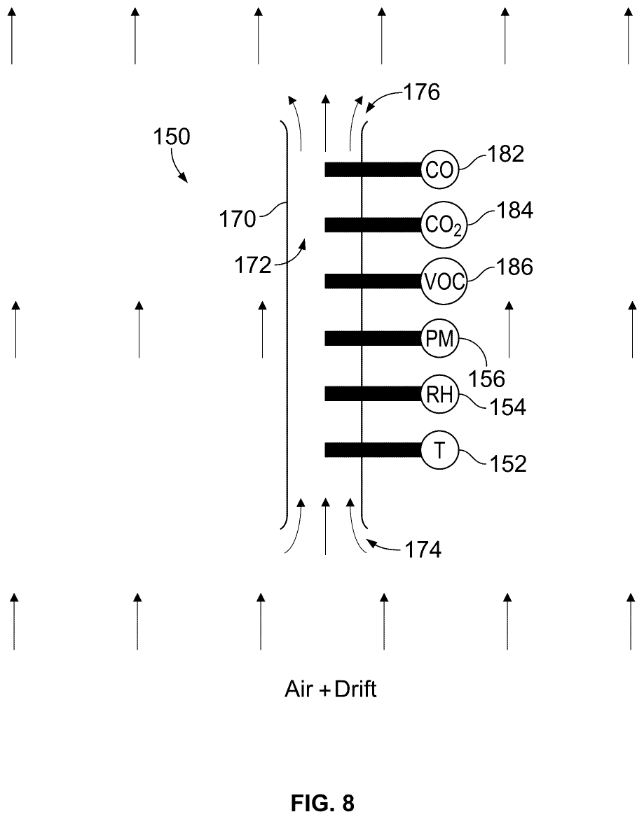

With respect to FIG. 8, the drift measurement sensor 150 may include additional sensors for monitoring other conditions of the air flowing through the drift measurement sensor 150. The drift measurement sensor 150 may include a carbon monoxide (CO) sensor 182, a carbon dioxide (CO2) sensor 184, and a volatile organic compounds (VOC) sensor 186. These sensors may be mounted within the passageway 172 of the drift measurement sensor 150 to monitor the amount of carbon monoxide, carbon dioxide, and volatile organic compounds within the air. Where the drift measurement sensor 150 includes a heater 178 and/or cooler 180, the CO sensor 182, CO2 sensor 184, and VOC sensor 186 may be mounted within the passageway 172 downstream from the heater 178 and/or cooler 180. Other sensors may similarly be included in the drift measurement sensor to measure the amount of other chemicals, bacteria, and/or organisms within the air.

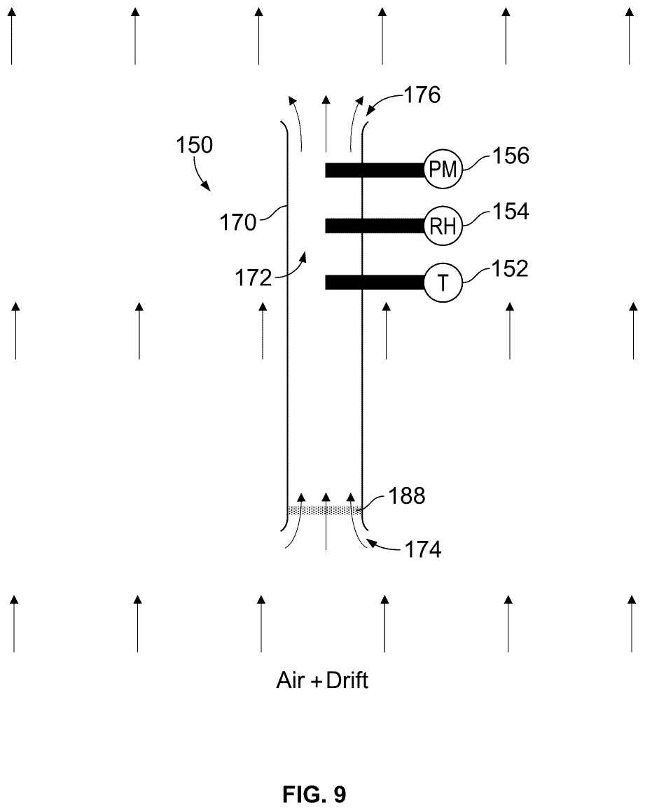

With respect to FIG. 9, the drift measurement sensor 150 may include a filter 188. The filter 188 may be mounted at the inlet 174 of the drift measurement sensor 150 and permits the air and drift particles to pass therethrough while inhibiting debris and larger particles from flowing through the drift measurement sensor 150. For instance, the filter 188 may inhibit leaves, dust, and other such debris from entering the drift measurement sensor 150. Such debris may interfere with the measurements of the sensors within the passageway 172 of the drift measurement sensor 150. Moreover, such debris may clog the passageway 172 which could restrict or limit the air flow through the passageway. For example, the filter 188 may include a mesh screen having a hole size in the range of about 1 mm to about 2 mm. The filter 188 may be a relatively coarse screen to inhibit entry of large particles and debris while reducing the interference of the filter 188 on the particulate matter carried in the air entering the drift measurement sensor 150.

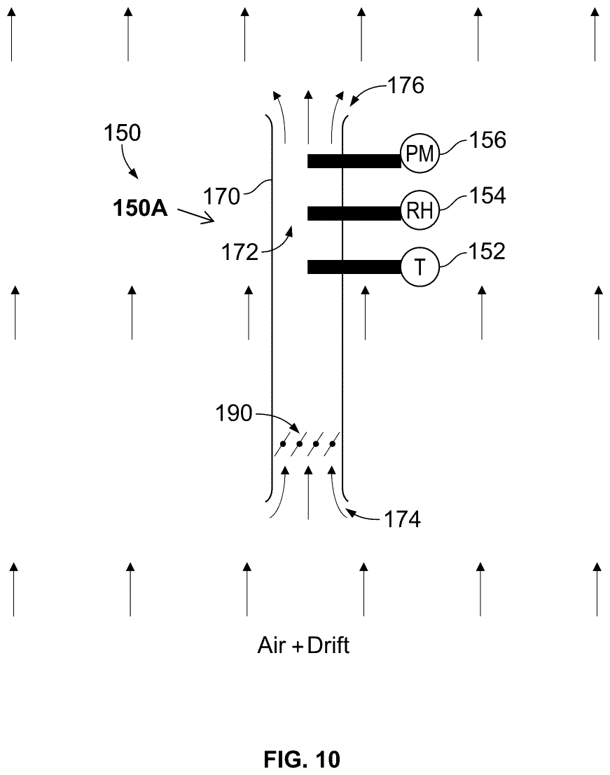

With respect to FIG. 10, the drift measurement sensor 150 has an air sampling apparatus 150A including the conduit 170 and dampers 190 that cooperate to provide a speed of the air in the conduit 170 that corresponds to a speed of the air outside of the conduit 170. The dampers 190 may be mounted at the inlet 174 and may inhibit debris (e.g., leaves) from entering the drift measurement sensor 150. The dampers 190 aid to keep debris from entering the passageway 172 and reaching the sensors which may interfere with the measurements taken by the sensors and/or may clog the passageway 172. The dampers 190 may also be adjusted to provide a particular air speed through the passageway 172.

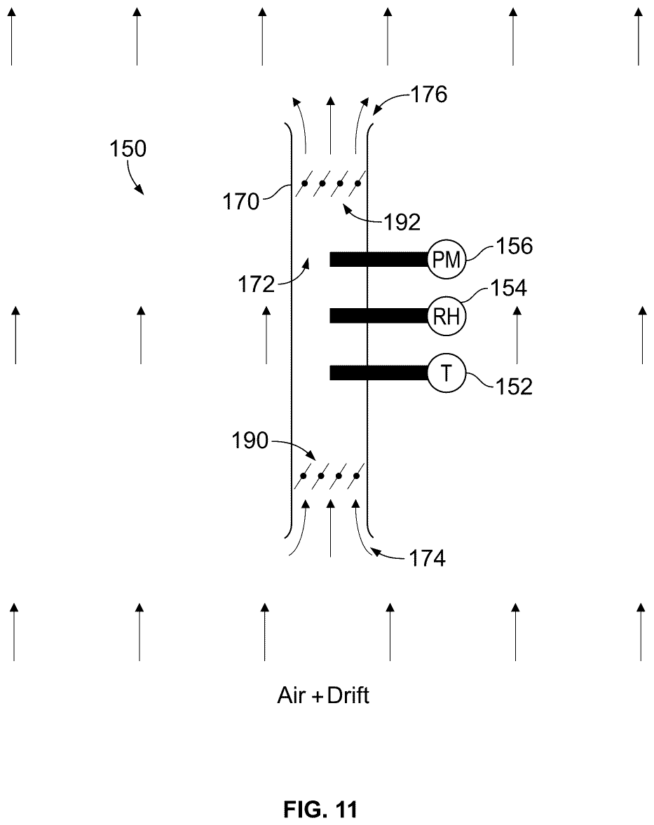

The dampers 190 may be pivoted to close or open the inlet 174 to inhibit or permit air to flow through the drift measurement sensor 150. For example, the dampers 190 may be closed when the drift measurement sensors 150 are not in use or when it is raining. The dampers 190 may be pivoted by a motor, for example, in response to a control signal from the controller 162. With respect to FIG. 11, in another embodiment the drift measurement sensor 150 may include dampers 192 mounted at the outlet 176 in addition to, or as an alternative to, the dampers 190 at the inlet 174. The dampers 192 may inhibit debris from entering the drift measurement sensor 150 via the outlet 176 which may interfere with the sensor measurements and/or clog the passageway 172. The dampers 192 may be pivoted to close or open the outlet 176 to inhibit or permit air to flow into or out the drift measurement sensor 150 via the outlet 176. For example, the dampers 192 may be closed when the drift measurement sensors 150 are not in use or when it is raining. The dampers 192 may be pivoted by a motor, for example, in response to a control signal from the controller 162. The dampers 192 may be adjusted to provide a particular air speed through the passageway 172.

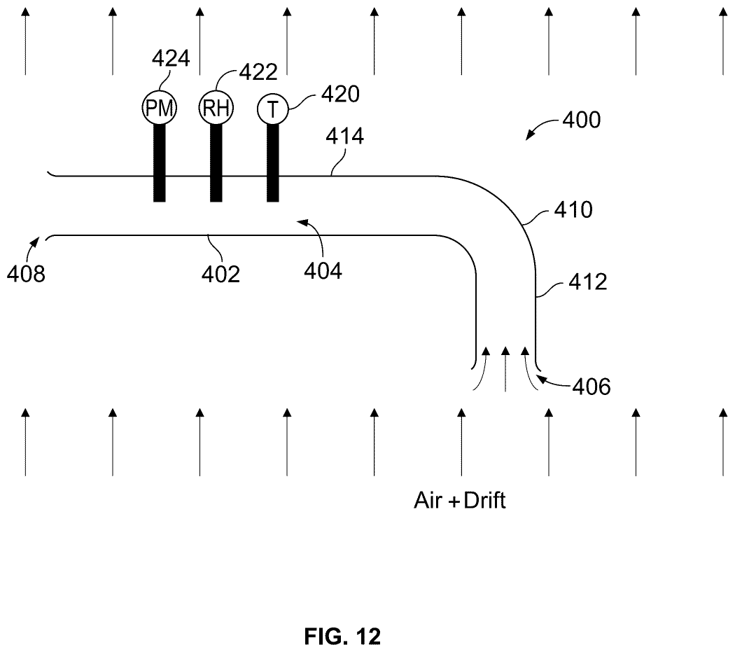

With respect to FIG. 12, a drift measurement sensor 400 is shown that is similar in many respects to the drift measurement sensor 150 discussed above such that the differences will be highlighted in the following discussion. The drift measurement sensor 400 may be mounted at the air inlets 118 and/or air outlet 130 of the cooling tower 100 to monitor the quality of the air entering and/or after exiting the cooling tower 100. The drift measurement sensor 400 includes a conduit, such as a tube 402, having a passageway 404 extending from an inlet 406 to an outlet 408. As with the drift measurement sensor 150 described above, the drift measurement sensor 400 may similarly include a temperature sensor 420, a relative humidity sensor 422, and a particulate matter sensor 424.

The conduit 402 of the drift measurement sensor 400 may have a curved portion such as bend 410 that changes the direction of the flow of air in the passageway 404 as the air extends from the inlet 406 to the outlet 408. The bend 410 redirects airflow in the conduit 402 and encourages an isokinetic or similar air speed within the passageway 404 relative to the airflow of the cooling tower 100. The similar air speeds inside and outside of the passageway 404 ensures that all particle sizes in the air stream external to the drift measurement sensor 400 enter the passageway 404 In the example embodiment shown, the conduit 402 has a first portion 412 that extends from the inlet 406 to the bend 410 and a second portion 414 that extends from the bend 410 to the outlet 408. The first and second portions 412, 414 extend transverse to one another. In one embodiment, the bend 410 is a 90-degree bend such that the air exits the drift measurement sensor 400 in a direction substantially perpendicular to the direction the air enters the drift measurement sensor 400. While a 90-degree bend is shown, bends of other angles may be used including, as examples, 10-89 degree bends. Including the bend 410 in the conduit 402 results in a portion of the air and drift impacting the sidewall of the passageway 404 as the bend 410 curves to direct the airflow in a different direction, for example, toward the outlet 408. As the air flows around the bend 410, drift carried in the air is separated from the air due to inertial impaction. In other words, as the air and drift flows around the bend 410, the air and drift impact the sidewall of the passageway 404 causing the drift in the air to lose velocity and/or collect on the sidewall of the passageway 404. Thus, some of the drift is removed from the airflow by the bend 410 which reduces the amount of water droplets that reach the sensors 420, 422, 424. As discussed above, water on the sensors may reduce the accuracy of the sensor data and/or may cause the sensors to fail. In one embodiment, the drift measurement sensor 400 is oriented with the first portion 412 being vertically lower than the second portion 414 such that gravity draws drift collected at the bend 410 downward and out of the tube 402 via the inlet 406.

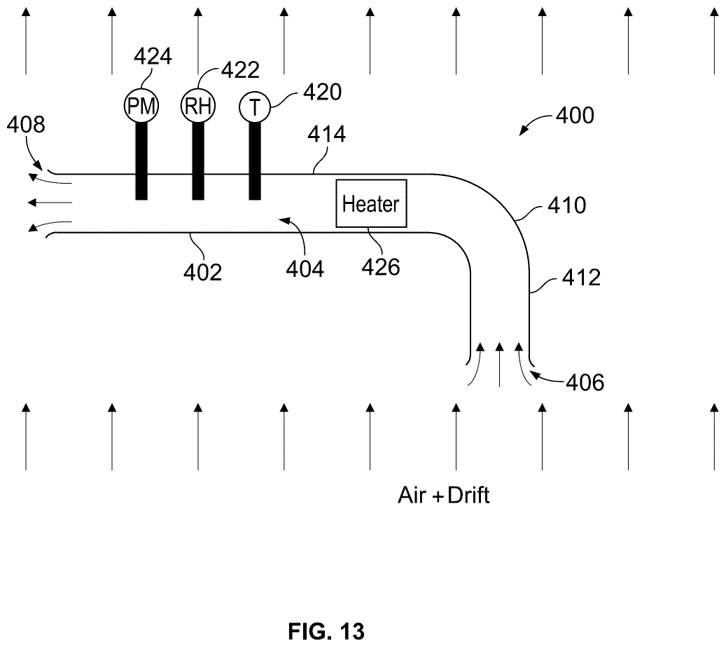

With reference to FIG. 13, in one embodiment, the drift measurement sensor 400 may include a heater 426 to heat and dry the air flowing through the passageway 404 before the air flows over the sensors 420, 422, 424. The heater 426 may be mounted downstream of the bend 410 to dry the air after some of the water is removed from the air flowing around the bend 410 as described above.

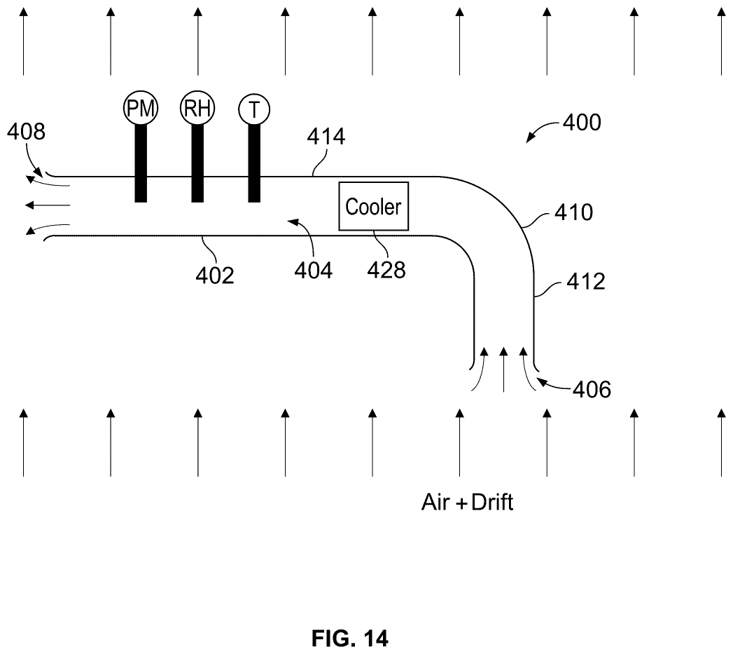

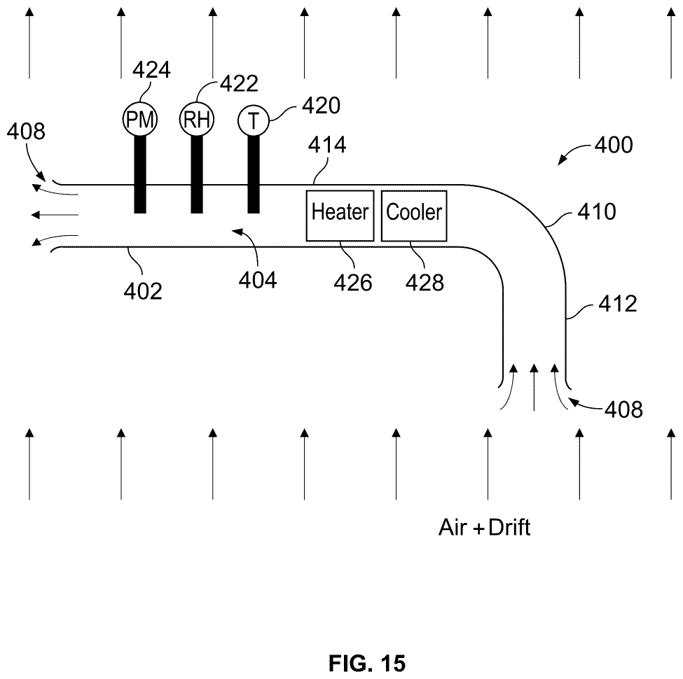

With reference to FIG. 14, the drift measurement sensor 400 may include a cooler 428 to cool and condense moisture from the air. The cooler 428 may thus dry the air flowing through the passageway 404 before the air flows over the sensors 420, 422, 424. The cooler 428 may be mounted downstream of the bend 410 to dry the air after some of the water is removed from the air flowing around the bend 410 as described above. With respect to FIG. 15, the drift measurement sensor 400 may include both the heater 426 and the cooler 428 that may be operated to heat and dry the air before the air flows over the sensors 420, 422, 424.

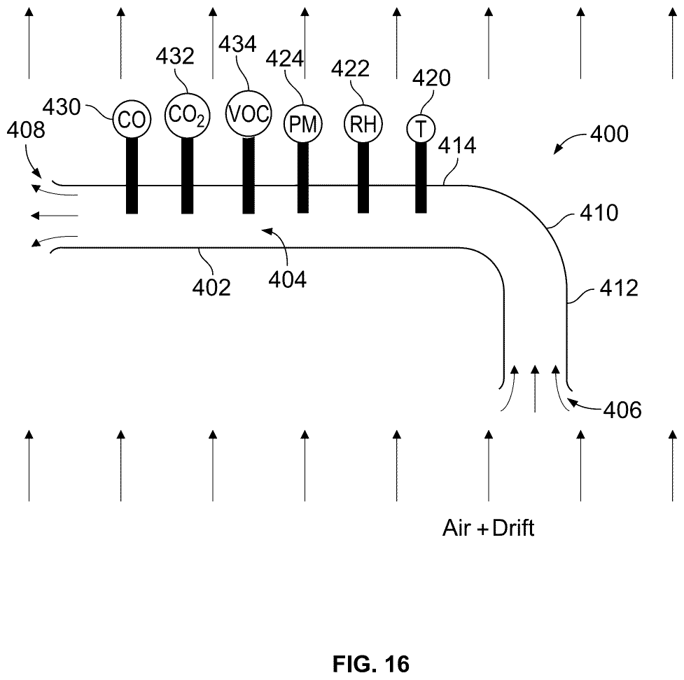

With reference to FIG. 16, the drift measurement sensor 400 may include additional sensors for monitoring other conditions of the air flowing through the drift measurement sensor 400. The drift measurement sensor 400 may include a CO sensor 430, a CO2 sensor 432, and a VOC sensor 434. These sensors may be mounted within the passageway 404 of the drift measurement sensor 400 to monitor the amount of carbon monoxide, carbon dioxide, and volatile organic compounds are in the air. The CO sensor 430, CO2 sensor 432, and VOC sensor 434 may be mounted downstream of the bend 410 after some of the larger liquid droplets are removed from the flow of air around the bend 410. Where the drift measurement sensor 400 includes the heater 426 and/or cooler 428, the CO sensor 430, CO2 sensor 432, and VOC sensor 434 may be mounted in the passageway 172 downstream from the heater 426 and/or cooler 428. Other sensors may similarly be included in the drift measurement sensor to measure the air quality, for example, the amount of other chemicals, bacteria, or organisms within the air.

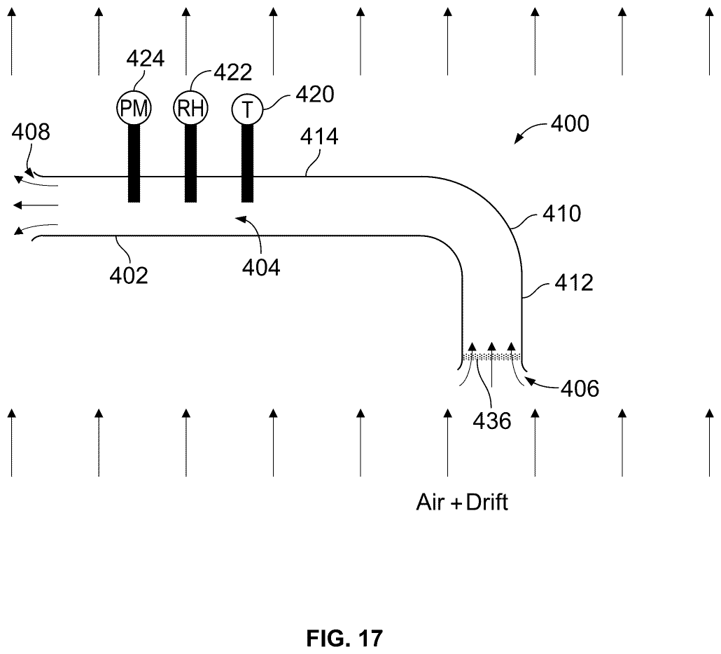

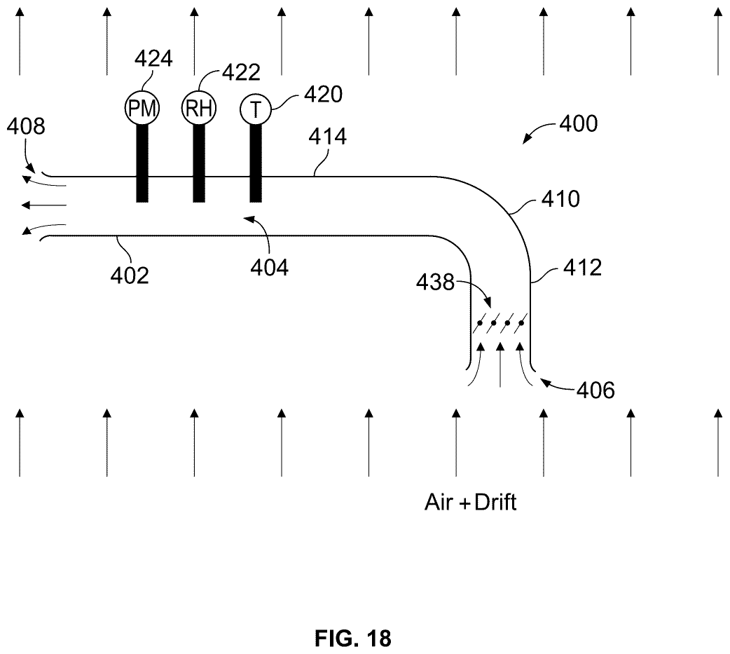

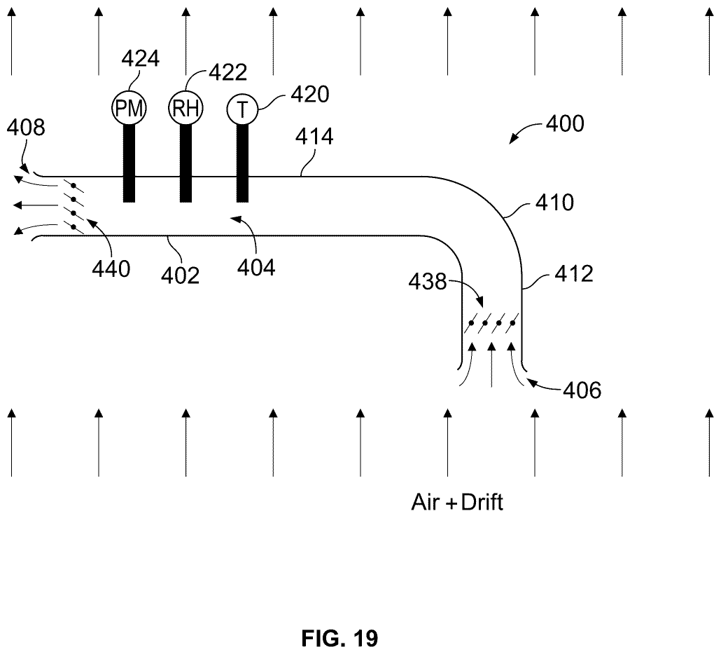

With reference to FIG. 17, the drift measurement sensor 400 may include a filter 436 mounted at the inlet 406 of the drift measurement sensor 400 to inhibit debris from flowing into or through the drift measurement sensor 400 as described above with respect to the embodiments above. With reference to FIG. 18, the drift measurement sensor 400 may include a damper 438 mounted at the inlet 406 to selectively open or close the inlet 406 and/or to inhibit debris from flowing into or through the drift measurement sensor 400 as described above. With reference to FIG. 19, the drift measurement sensor 400 may further include a damper 440 mounted at the outlet 408 to selectively open or close the outlet 408 and/or to inhibit debris from flowing into the drift measurement sensor 400 via the outlet as described with respect to the embodiments above.

With respect to FIG. 20, the cooler 428 may include a drain line 442 to drain condensation from the drift measurement sensor 400. For example, the cooler 428 may be operated to condense the moisture from the air as the air flows through the passageway 404 of the conduit 402. The condensed moisture may be aggregated and/or directed to the drain line 442 to remove moisture from the drift measurement sensor 400. The condensed moisture may flow through a passageway 444 of the drain line 442 and away from the drift measurement sensor 400. For example, the condensed moisture may flow through the drain line 442 into the sump 132 of the cooling tower 100. The drift measurement sensor 400 may include a conductivity sensor 446 for measuring the conductivity of the liquid flowing through the drain line 442. In another embodiment, the drift measurement sensor 400 includes a pH sensor instead of, or in addition to, the conductivity sensor 446. Data from the drift measurement sensor 400 regarding the pH of water collected by the drift measurement sensor 400 may be used to determine abnormal changes in drift in a manner similar to the approaches discussed herein with respect to conductivity data and particulate matter data.

The controller 162 may receive the conductivity data of the condensate liquid from the conductivity sensor 446 and may use the conductivity data in evaluating the drift condition of the cooling tower 100. For example, the conductivity of the condensate of a drift measurement sensor 400 mounted at the air outlet 130 of the cooling tower 100 may be compared to the conductivity of the condensate of the drift measurement sensor 400 mounted at the air inlet 118. As another example, the conductivity of the condensate may be compared with the conductivity of the fluid in the sump 132 to detect whether the drift rate of the cooling tower 100 is increasing. In one example where no drift is occurring, the conductivity of the liquid collected in the drift measurement sensor 400 may be about 0 μS/cm. Where there is a normal or acceptable amount of drift in the cooling tower 100, a portion of the liquid collected by the drift measurement sensor 400 may be drift that will raise the conductivity of the liquid collected by drift measurement sensor 400. For example, where the conductivity of the fluid in the basin is 1500 μS/cm, and the drift rate is a normal amount of about 0.005%, the conductivity of the liquid collected by the drift measurement sensor 400 may be about 50 μS/cm. Where there is an abnormally high amount of drift, a larger portion of the liquid collected by the drift measurement sensor 400 is drift that further raises the conductivity of the collected liquid. Continuing the example above where the conductivity of the fluid in the basin is 1500 μS/cm, with a higher drift rate of about 0.015%, the conductivity of the liquid collected by the drift measurement sensor 400 may be about 150 μS/cm. The controller 162 may determine that the drift rate is high based on the conductivity of the liquid collected by the drift measurement sensor 400, for example, that the conductivity of the collected liquid is outside of an expected range for a normal drift rate, e.g., a range of 50 μS/cm+/−25 μS/cm.

With respect to FIG. 21, the drift measurement sensor 400 may include the cooler 428 which may be used to condense and sample the condensate without including the temperature sensor 420, relative humidity sensor 422, and/or the particulate matter sensor 424.

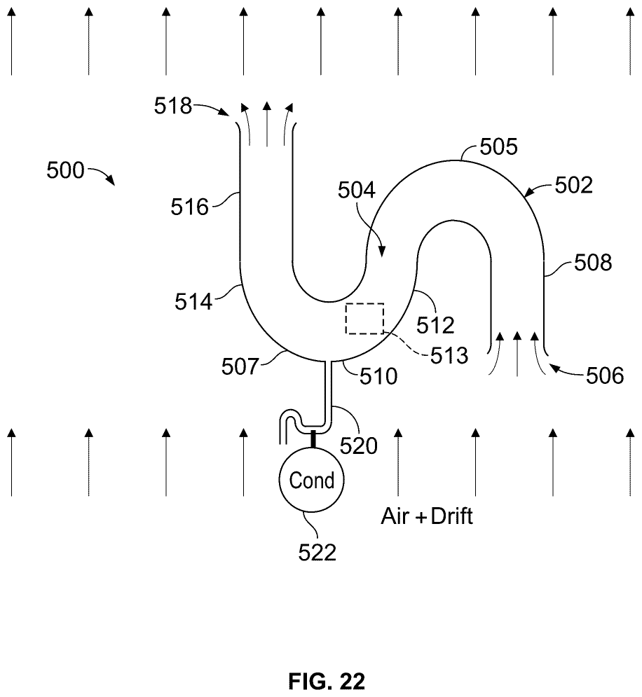

With reference to FIG. 22, a drift measurement sensor 500 is shown according to another embodiment that is similar in many respects to the drift measurement sensors discussed above such that the differences will be highlighted in the following discussion. The drift measurement sensor 500 has a conduit 502 defining a passageway 504. The conduit 502 includes a first bend 505 and a second bend 507. Air and drift enters the conduit 502 through an inlet 506 and flows through a straight portion 508 of the passageway 504 to the first bend 505. The first bend 505 is a U-shaped bend and curves about 180 degrees. As the air flows around the first bend 505, drift carried in the air is separated from the air as the air flows around the bend 505 due to inertial impaction as described above. The air and remaining drift flow from the first bend 505 to the second bend 507 where the drift may further be separated from the air by inertial impaction. The second bend 507 is a U-shaped bend and curves about 180 degrees. The drift removed from the air via the redirection of the air at first and second bends 505, 507 may be aggregated in the second bend 507 for testing and/or removal from the drift measurement sensor 500. The second bend 507 may be oriented such that a central portion 510 of the second bend 507 is vertically lower than the end portions 512, 514 of the bend 507 to aid in aggregating the separated drift due to the force of gravity. The air and any remaining drift in the air flow from the second bend 507, through a straight portion 516, and to an outlet 518.

A drain line 520 may be mounted to the conduit 502 at the second bend 507 to drain the aggregated drift (e.g., water and particulate) from the drift measurement sensor 500 as described above. The drain line 520 may be mounted at the central portion 510, for example, at the vertically lowest point, such that the aggregated drift is collected and directed into the drain line 520. A conductivity sensor 522 may be mounted to the drain line 520 to measure the conductivity of the aggregated drift flowing through the drain line 520. The conductivity of the aggregated drift may be used to determine the amount of particulate in the air, for example, the amount of particulate removed due to inertial impaction as the air and drift flowed around the first bend 504 and second bend 507.

In one embodiment, the drift measurement sensor 500 of FIG. 22, or other figures, includes a dehumidifier 513 to increase the water collection. The water collected by the dehumidifier is drift water which may make analysis of the collected water more accurate than if the water were combined with water condensed from the ambient air. The dehumidifier may include, for example, a cooler, a heater and cooler combination, and/or a vapor permeable membrane.

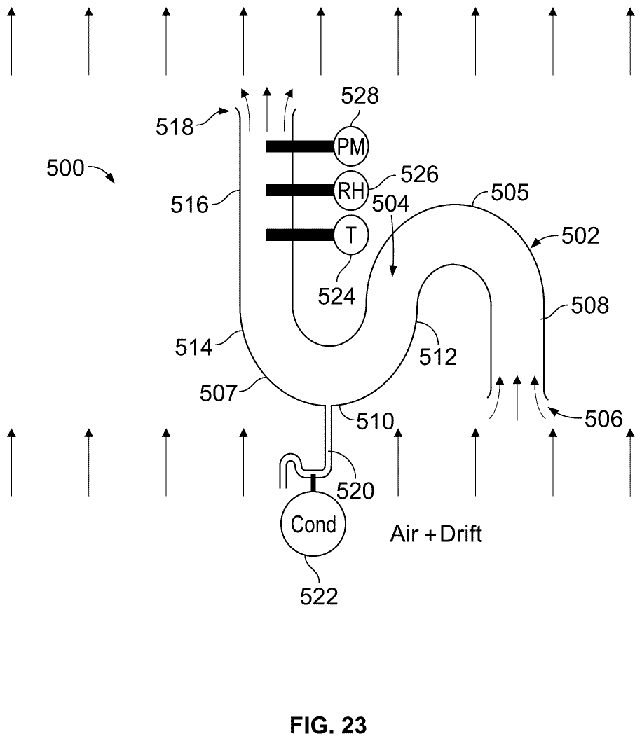

With respect to FIG. 23, in one embodiment the drift measurement sensor 500 includes a temperature sensor 524, a relative humidity sensor 526, and particulate matter sensor 528 for monitoring other aspects of the air flowing through the drift measurement sensor 500. The temperature sensor 524, relative humidity sensor 526, and particulate matter sensor 528 may be mounted in a portion of the conduit 502 to contact the air after the drift has been separated from the air at the first bend 504 and/or second bend 507. Other sensors may also be in communication with the passageway 504 of the drift measurement sensor 500 including, as examples, a CO sensor, CO2 sensor, and/or a VOC sensor. The sensors may be mounted in the straight portion 516 of the conduit, downstream of the second bend 507.

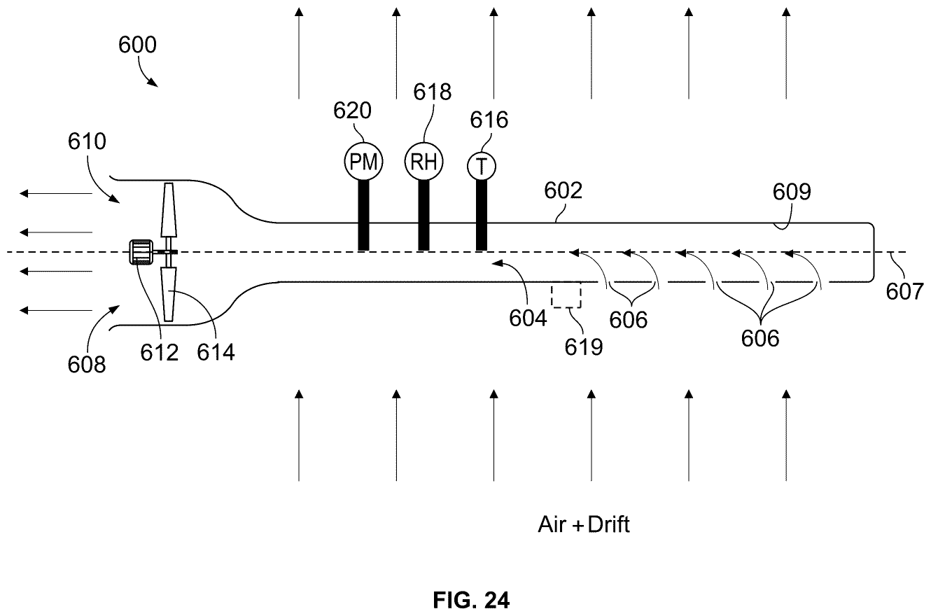

With respect to FIG. 24, a drift measurement sensor 600 is shown according to another embodiment that is similar in many respects to the drift measurement sensors of the other embodiments discussed above such that the differences will be highlighted in the following discussion. The drift measurement sensor 600 includes an air sampling apparatus having a body such as conduit 602 having an interior or passageway 604 through which air and drift may flow. The conduit 602 may include a sidewall extending about the passageway 604. The conduit 602 includes one or more inlet openings 606 and an outlet 608. Air and drift may enter the conduit 602 through the inlet openings 606 and flow along the passageway 604 to the outlet 608. The inlet openings 606 may be through openings formed in the sidewall of the conduit 602 such that air enters the conduit 602 substantially perpendicular to a central axis 607 of the passageway 604. Some of the drift may be separated from the air by inertial impaction of the air against an inner surface portion 609 as the airflow changes direction to flow along the passageway 604.

The air sampling apparatus of the drift measurement sensor 600 of FIG. 24 includes a fan assembly 610 having a motor 612 that turns a fan 614. The fan assembly 610 may be mounted at an end of the conduit 602 near the outlet 608. The fan assembly 610 may be operable to move the air through the conduit 602 from the inlet openings 606 to the outlet 608. Operation of the fan assembly 610 may draw air and drift into the conduit 602 via the inlet openings 606 and drive the air out of the conduit 602 through the outlet 608. Operating the fan assembly 610 may aid to ensure that a representative sample of the air flowing over the drift measurement sensor 600 flows through the passageway 604 of the drift measurement sensor 600 for monitoring the quality of the air. For example, the fan assembly 610 may be operated to achieve a constant air velocity through the drift measurement sensor 600, providing a more uniform drift measurement at all fan speeds of the associated heat exchange apparatus. The fan assembly 610 may be operated to move air through the drift measurement sensor 600 at approximately the same rate as the air flowing through the cooling tower about the drift measurement sensor 600. The drift measurement sensor 600 (e.g., a controller of the drift measurement sensor 600) may receive a signal indicative of an air flow speed about the drift measurement sensor and increase, decrease, or maintain the speed of the the fan assembly 610 to cause the speed of the airflow in the drift measurement sensor 600 to match the speed of the airflow external to the drift measurement sensor 600 in the cooling tower. For example, the drift measurement sensor 600 may include an air speed sensor 619 mounted to the conduit to measure the speed of the airflow external to the drift measurement sensor 600. As another example, the cooling tower includes an air speed sensor in the interior, inlet, or outlet of the cooling tower and the controller of the cooling tower communicates air speed data to the drift measurement sensor 600. In some forms, the drift measurement sensor 600 receives an operating variable of the fan assembly 102 (e.g., the electrical power or current provided to the fan assembly, or a speed of the fan assembly) from the cooling tower indicative of the speed of airflow through the cooling tower. It will be appreciated that the other embodiments of drift measurement sensors discussed herein that include fan assemblies may operate similarly to the drift measurement sensor 600.

The drift measurement sensor 600 includes a temperature sensor 616, relative humidity sensor 618, and a particulate matter sensor 620 mounted in the passageway 604 between the inlet openings 606 and the outlet 608. The temperature sensor 616, relative humidity sensor 618, and particulate matter sensor 620 may be used to evaluate the condition of the air flowing through the conduit 602 which may be used to determine whether the drift rate of the cooling tower 100 is increasing as discussed above.

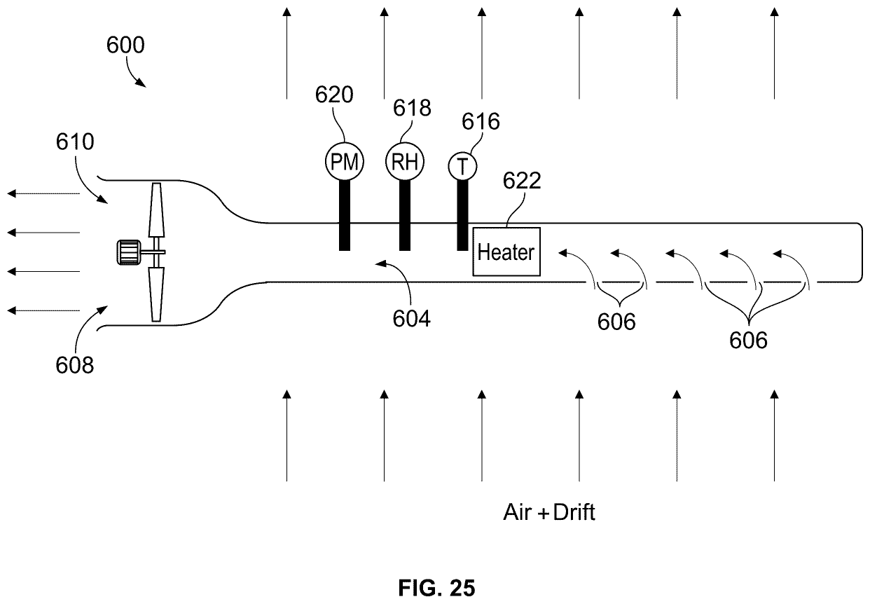

With respect to FIG. 25, the drift measurement sensor 600 may include a heater 622. The heater 622 may be positioned within the passageway 604 between the inlet openings 606 and the sensors. The heater 622 may be operable to raise the temperature of the air and/or dry the air, as discussed above with respect to the other embodiments, to reduce or remove water droplets from the air to inhibit the water from collecting on the sensors and interfering with the measurements.

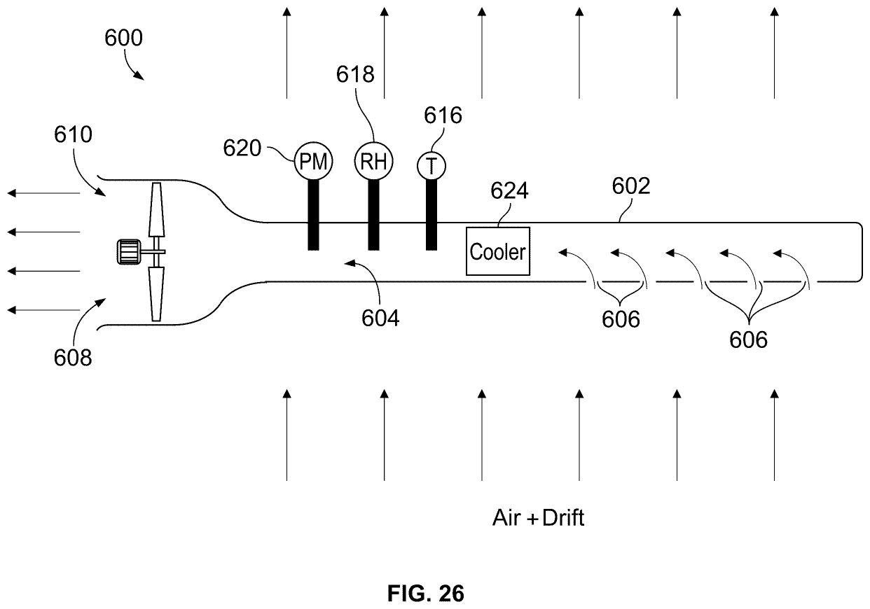

With respect to FIG. 26, the drift measurement sensor 600 may include a cooler 624. The cooler 624 may be positioned within the passageway 604 between the inlet openings 606 and the sensors. The cooler 624 may be operable to dehumidify the air as discussed above with respect to the other embodiments. The cooler 624 may condense moisture from the air and drift which may air to inhibit the moisture or water from collecting on the sensors and interfering with the measurements.

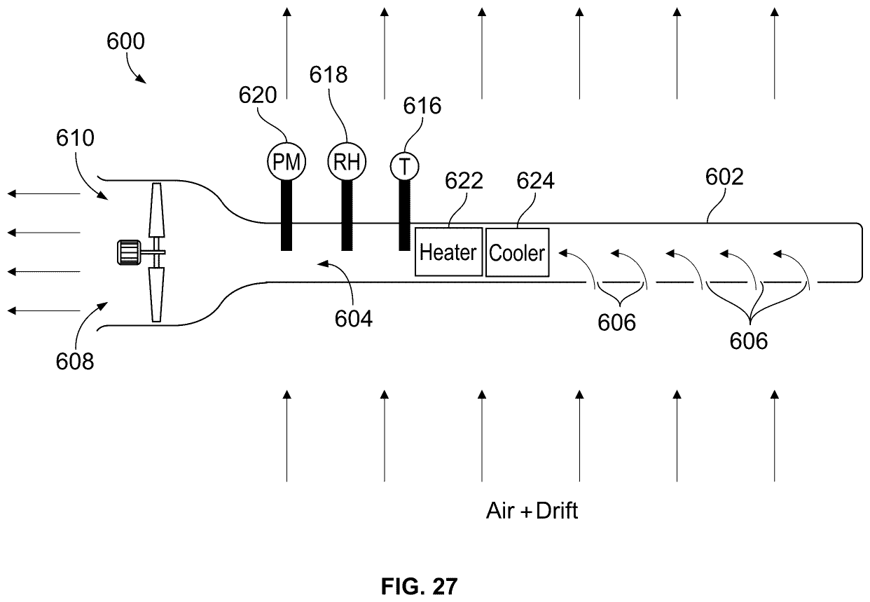

With respect to FIG. 27, the drift measurement sensor 600 may include both the heater 622 and the cooler 624. The heater 622 and the cooler 624 may be mounted within the passageway 604 between the inlet openings 606 and the sensors. The heater 622 and cooler 624 may be operated to dry the water droplets from the air and/or dehumidify the air upstream of the sensors as discussed above with respect to the other embodiments.

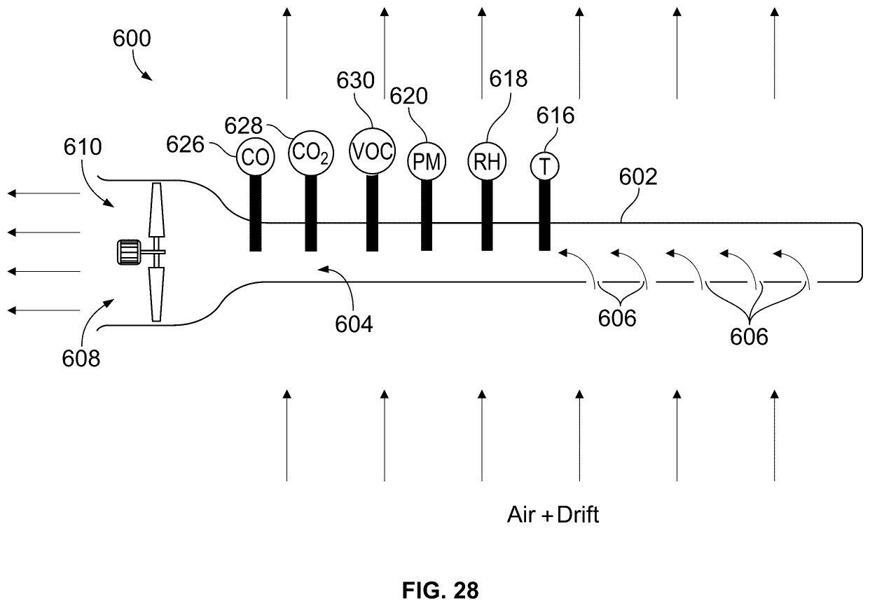

With respect to FIG. 28, in one embodiment the drift measurement sensor 600 includes additional sensors for measuring and monitoring other conditions of the air flowing through the drift measurement sensor 600. The drift measurement sensor 600 may include a carbon monoxide (CO) sensor 626, a carbon dioxide (CO2) sensor 628, and a volatile organic compound (VOC) sensor 630. These sensors may be mounted in the passageway 604 of the drift measurement sensor 600 to monitor the amount of carbon monoxide, carbon dioxide, and volatile organic compounds within the air. Where the drift measurement sensor 600 includes a heater 622 and/or cooler 624, the CO sensor 626, CO2 sensor 628, and VOC sensor 630 may be mounted within the passageway 604 downstream from the heater 622 and/or cooler 624. Other sensors may similarly be included in the drift measurement sensor to measure the amount of other chemicals, bacteria, or organisms within the air.

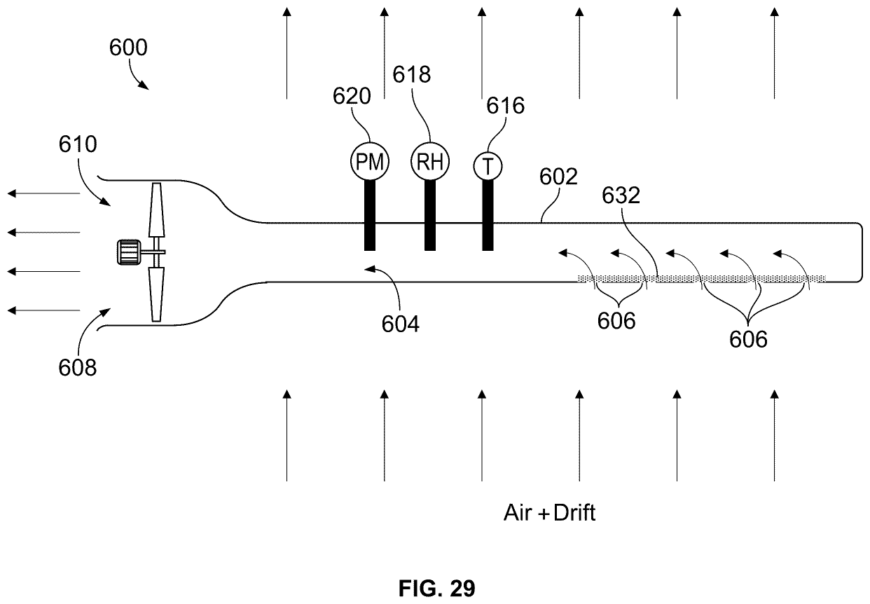

With respect to FIG. 29, in one embodiment the drift measurement sensor 600 includes a filter 632 at the inlet openings 606. The filter 632 may inhibit debris and large particles (relative to drift particulate) from entering the drift measurement sensor 600. The filter 632 may be, for example, a mesh screen.

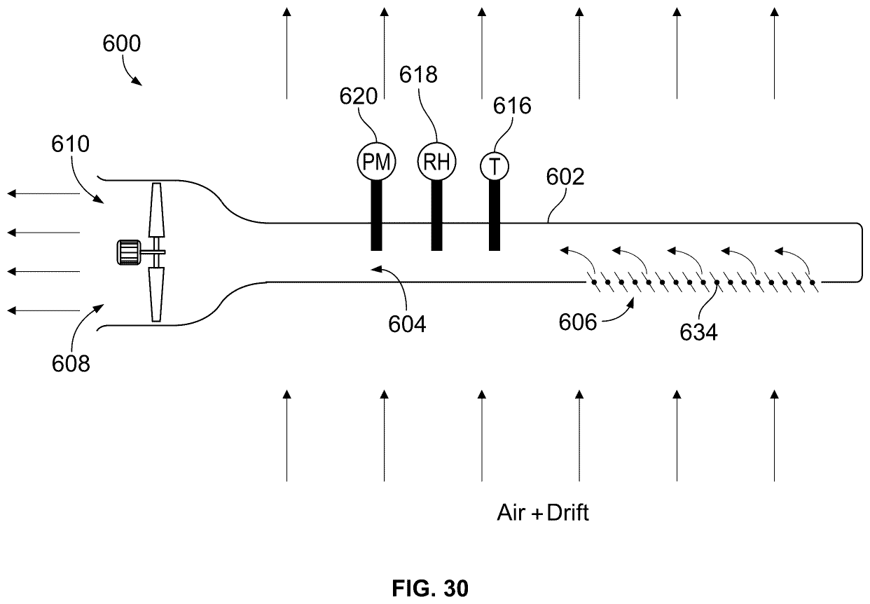

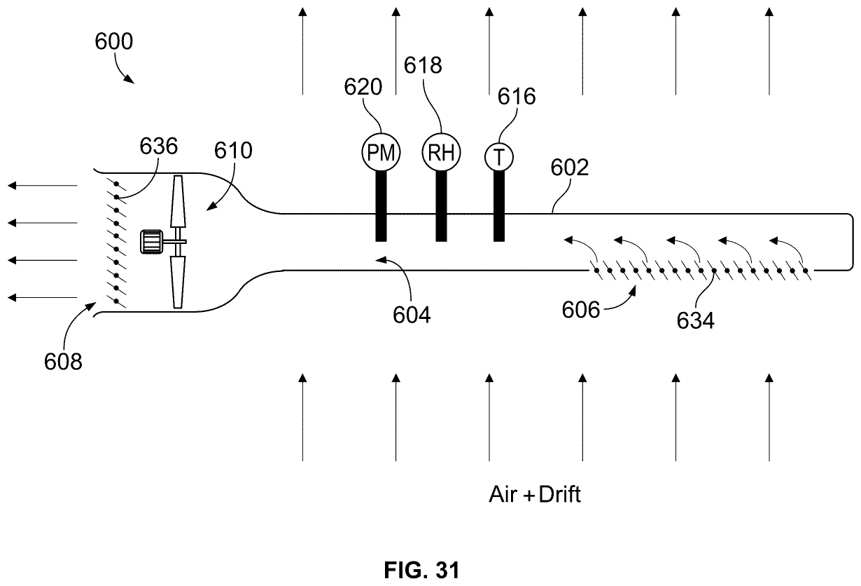

With respect to FIG. 30, the drift measurement sensor 600 may include dampers 634 at the inlet openings 606. The dampers 634 may be pivotable to selectively open or close the inlet openings 606 and/or to inhibit debris (e.g., leaves) from entering the drift measurement sensor 600 as described above with respect to the other embodiments. With respect to FIG. 31, the drift measurement sensor 600 may also include dampers 636 mounted at the outlet 608. The dampers 636 may be pivotable to selectively open or close the outlet 608 and/or to inhibit debris from entering the drift measurement sensor 600 via the outlet 608 as described above with respect to the other embodiments.

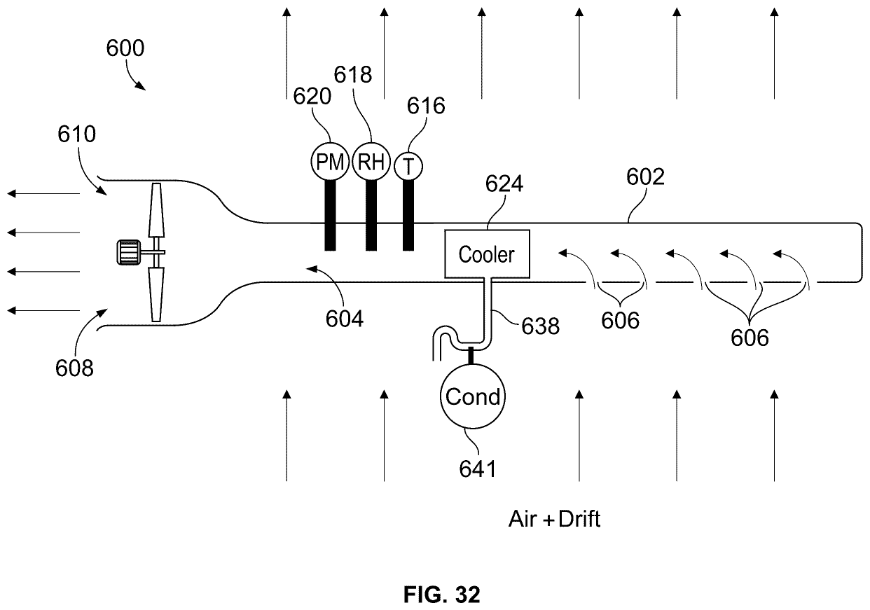

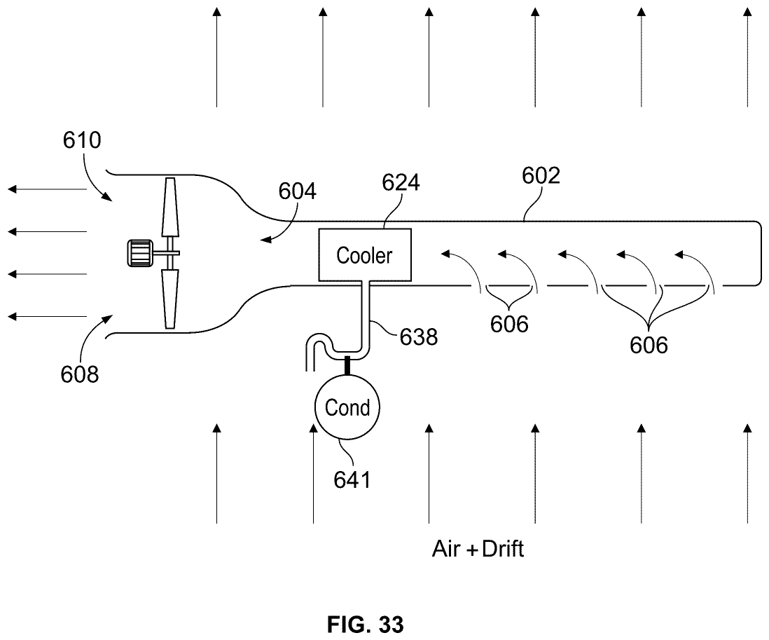

With respect to FIGS. 32 and 33, the drift measurement sensor 600 may include a cooler 624 with (see FIG. 32) or without (see FIG. 33) temperature sensor 616, relative humidity sensor 618, and/or the particulate matter sensor 620. The cooler 624 may include a drain line 638 through which moisture condensed from the air flowing through the drift measurement sensor 600 may be removed from the drift measurement sensor 600 as described above. The cooler 624 may collect the condensate and direct the moisture to the drain line 638. The drift measurement sensor 600 may include a conductivity sensor 641 for measuring the conductivity of the condensate flowing through the drain line 638 as discussed above. In one embodiment wherein the drift measurement sensor 600 includes the temperature sensor 616 and relative humidity sensor 618, the temperature sensor 616 and relative humidity sensor 618 may be used to control the operation of the cooler 624. For example, temperature and humidity measurements may be used to determine the amount of cooling to provide via the cooler 624 to condense the moisture from the air. Alternatively or additionally, the temperature sensor 616, relative humidity sensor 618, and/or the particulate matter sensor 620 may be used to monitor the drift as described above.

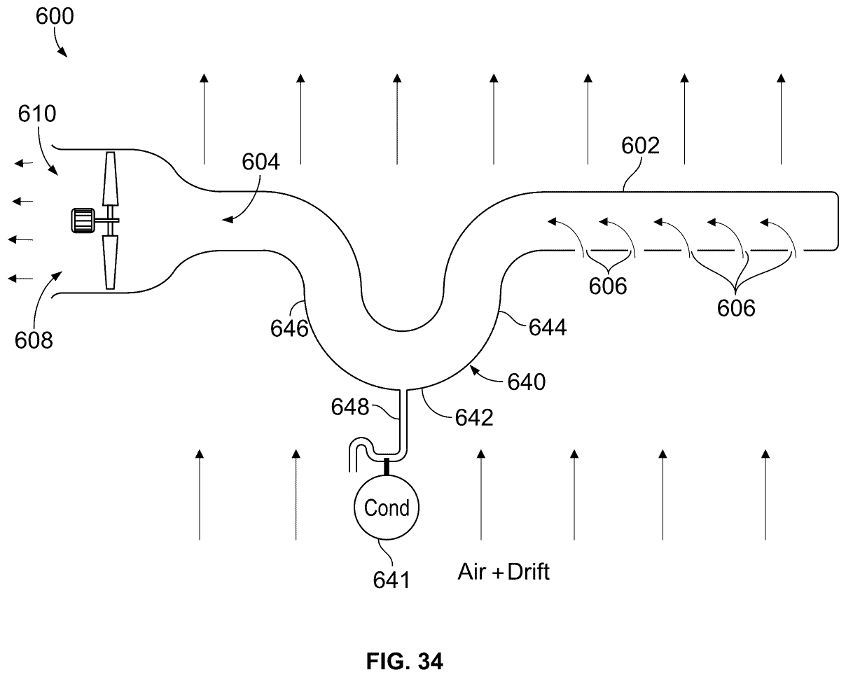

With respect to FIG. 34, in one embodiment conduit 602 of the drift measurement sensor 600 may include a bend 640 for inertial impaction separation of the drift from the air as discussed above. The bend 640 may be a substantially U-shaped bend between the inlet 606 and the outlet 608. As the air flows along the passageway 604 through the bend 640, the drift may impact an interior surface portion of the conduit 602 and collect on the interior surface portion. The drift may flow along the sidewall of the bend 640 and pool in the bend 640. For example, a central portion 642 of the bend 640 may be positioned vertically lower than the inlet portion 644 and outlet portion 646 of the bend 640 such that the drift flows along interior surface portions of the conduit 602 to the central portion 642 of the bend 640 due to the force of gravity. The drift measurement sensor 600 may include a drain line 648 connected to the bend 640, for example, at the lowermost point of the bend 640 where the drift collects or pools. The drift flows through the drain line 648 and is removed from the drift measurement sensor 600. The drift measurement sensor 600 may include the conductivity sensor 641 for measuring the conductivity of the condensate flowing through the drain line 648 as discussed above. In another embodiment, the drift measurement sensor 600 has a liquid flow rate sensor instead of or in addition to the conductivity sensor 641. The controller 162 may utilize data from the liquid flow rate sensor to determine changes in the amount of drift in the cooling tower.

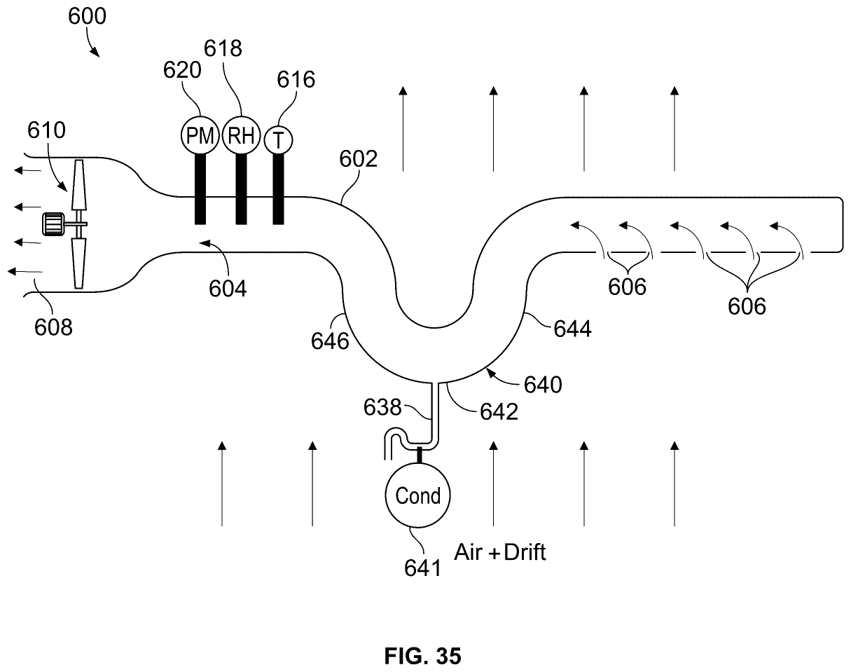

With respect to FIG. 35, the drift measurement sensor 600 may further include the temperature sensor 616, relative humidity sensor 618, and/or the particulate matter sensor 620 positioned after the bend 640 where at least a portion of the drift has been removed from the air by the bend 640 as discussed above.

With respect to FIG. 36A, a heat exchange apparatus 700 is provided according to another embodiment. The heat exchange apparatus 700 may operate as a fluid cooler, such as a closed-circuit cooling tower, or an evaporative condenser as some examples. The heat exchange apparatus 700 is similar in many respects to the cooling tower 100 of FIG. 1A discussed above such that the differences will be highlighted in the following discussion. The heat exchange apparatus 700 includes an airflow generator, such as fan assembly 702, indirect heat exchangers 704, and an evaporative liquid distribution system 706 for distributing liquid, such as water, onto the indirect heat exchanger 704.

The indirect heat exchangers 704 each include an inlet header 705 for receiving a fluid, an outlet header 707, and heat exchange elements 715 such as pillow plate heat exchangers 717 connecting the inlet and outlet headers 705, 707. In other embodiments, different heat exchange elements 715 may be utilized instead of or in addition to the pillow plate heat exchangers 717, such as a coil, a plate heat exchanger, and/or a fin-and-tube heat exchanger. The fluid enters the inlet header 705, travels through the pillow plate heat exchangers 717, and is collected at outlet header 707 before flowing out of the indirect heat exchanger 704. The fluid received at the inlet header 705 may include, for example, liquid water, water vapor (e.g., steam), a mixture of liquid water and water vapor, ammonia, brine, and/or a glycol (e.g., propylene, ethylene). In one embodiment, the fluid received by the inlet header 705 may include a refrigerant such as R-134a, R410, R404, and/or R744. The positions of the inlet header 705 and outlet header 707 may be reversed in some embodiments, with the outlet header 707 above the inlet header 705.

In an embodiment wherein the heat exchange elements 715 include one or more coils, each coil may have a plurality of runs intermediate the inlet and outlet headers 705, 707. In one embodiment, the coil includes one or more tubes each having an interior that permits fluid to travel therethrough and a sidewall extending about the interior. The coil may have a number of configurations, such as straight tubes extending between the headers or serpentine tubes having straight runs connected by bends. The coil may or may not include fins.

The rotation of the fan of the fan assembly 702 causes air to move from an air inlet 711, through a filter 709, across the pillow plate heat exchangers 717, through drift eliminators 734, upward through the fan assembly 702, and out of an air outlet 713 of the heat exchange apparatus 700. In one approach, the fluid in the pillow plate heat exchangers 717 has a higher temperature than the air flowing over the pillow plate heat exchangers 717 such that heat transfers through the tube sidewalls of the pillow plate heat exchangers 717 from the higher temperature fluid in the interior of the pillow plate heat exchangers 717 to the cooler airflow moving over the exterior of the pillow plate heat exchangers 717.

The evaporative liquid distribution system 706 includes a liquid supply valve connected to a liquid supply. The liquid utilized by the evaporative liquid distribution system 706 may include, for example, water (e.g., tap water, rainwater, and/or non-potable water). In some embodiments, the liquid distribution system 706 receives water from a water treatment system that converts raw water into processed water having properties and/or additives (e.g., anti-fungal, anti-microbial) suitable for distribution in the heat exchange apparatus 700. In one embodiment, the liquid supply valve includes a makeup valve 716, that may be opened to distribute liquid into a sump 720 of the heat exchange apparatus 700. The makeup valve 716 may be opened to dispense liquid into the sump 720 when the sump 720 is empty, when the liquid level in the sump 720 is low, and/or to introduce fresh liquid into the heat exchange apparatus 700.

The evaporative liquid distribution system 706 includes a pump 722, conduit 718, and nozzles 714. The pump 722 pumps liquid from the sump 720 through the conduit 718 to the nozzles 714 positioned above the pillow plate heat exchangers 717 of the indirect heat exchangers 704. The pump 722 may be operated to dispense the liquid from the sump 720 over the pillow plate heat exchangers 717 to aid in cooling the fluid flowing through the pillow plate heat exchangers 717. The evaporative liquid absorbs heat from the pillow plate heat exchangers 717 to remove heat from the pillow plate heat exchangers 717. Further, a portion of the evaporative liquid evaporates which further removes heat from the pillow plate heat exchangers 717. The unevaporated liquid falls back to the sump 720.

The liquid distribution system 706 may thus be operated in conjunction with the fan assembly 702 to aid in removing heat from the fluid flowing through the pillow plate heat exchangers 717. For example, the heat exchange apparatus 700 may have a dry mode wherein the controller 162 operates the fan assembly 702 to generate airflow across the pillow plate heat exchangers 717 and does not operate the pump 722. The controller 162 may determine the heat exchange apparatus 700 in the dry mode thereof is unable to satisfy a return fluid set point requested by an HVAC controller (for example). The controller 162 may reconfigure the heat exchange apparatus 700 to a wet mode to satisfy the return fluid set point. As another example, the controller 162 may reconfigure the heat exchange apparatus 700 to operate in the wet mode to conserve electrical power or when the heat exchange apparatus 700 would be more cost efficient to operate in the wet mode.

In the wet mode, the controller 162 operates the pump 722 to cause evaporative liquid from the sump 720 to be sprayed onto the pillow plate heat exchangers 717. The heat exchange apparatus 700 may include a flowmeter 726 and a temperature sensor 728 attached to the conduit 718 for monitoring the flow rate and temperature of the liquid being distributed over the pillow plate heat exchangers 717.

The heat exchange apparatus 700 may include a temperature sensor 730 and a conductivity sensor 732 of the sump 720 for monitoring the temperature and conductivity of the fluid in the sump 720. The controller 162 may receive data from the temperature sensor 730 and/or the conductivity sensor 732. The sump 720 may have a drain valve 724 that may be opened (e.g., by the controller 162) to drain fluid from the sump 720 and out of circulation within the heat exchange apparatus 700. The drain valve 724 may be opened to drain liquid from the sump 720, for example, when there is too much liquid in the sump 720 or to completely drain the liquid from the sump 720 as part of a liquid changeover process, for example, when the conductivity or pH of the liquid exceeds a threshold.

The drain valve 724 may likewise be opened to drain the liquid from the sump 720 as part of a failsafe operation of the heat exchange apparatus 700. For example, if the controller 162 detected an abnormal change in the drift of the heat exchange apparatus 700 and the controller 162 detected a heightened risk of bacterial contamination, then the controller 162 may open the drain valve 724 and notify a maintenance worker of the issue. The controller 162 may monitor the liquid in the sump 720 for a risk of bacterial contamination using a water sample analysis and/or a biofilm sensor.

The heat exchange apparatus 700 may include one or more drift measurement sensors 150 according to the embodiments discussed above to monitor one or more variables of the cooling tower 100, for example, variables relating to air quality conditions. As shown in FIG. 36A, the heat exchange apparatus 700 may include a drift measurement sensor 150 at the air outlet 713 of the heat exchange apparatus 700 and one or both of the air inlets 711. As discussed in greater detail above, the drift measurement sensors 150 include sensors to monitor variables indicative of drift. The controller 162 may monitor changes in the monitored variables and determine whether the change is indicative of an increase in the drift rate of the cooling tower beyond an expected or acceptable amount. For example, when the liquid distribution system 706 is turned on, the controller 162 will expect there to be an increase in the amount of particulate matter detected by the drift measurement sensor 150 downstream of the pillow plates heat exchangers 717 at the outlet 713. The controller 162 may monitor the increase in particulate matter at the air outlet 713 and determine whether the increase in particulate matter exceeds the expected or acceptable amount. If the increase in particulate matter exceeds the acceptable amount (e.g., beyond a predetermined margin of error of an upper threshold), the controller 162 determines that the drift rate of the heat exchange apparatus 700 has increased significantly.

The drift measurement sensors 150 may be positioned at various locations of the heat exchange apparatus 700 to monitor drift. With respect to FIG. 36B, an alternative configuration of the heat exchange apparatus 700 is provided, wherein the drift measurement sensor 150 is mounted downstream of the indirect heat exchanger 704 and upstream of the fan assembly 702.

The controller 162 may compare the air variables detected at the air inlets 711 upstream of the indirect heat exchangers 704 and downstream of the indirect heat exchangers 704 after the drift eliminators 734 to determine a drift condition using the techniques discussed above. For example and with reference to FIG. 3A, the controller 162 may determine heat exchange apparatus 700 has an unacceptable drift condition based upon the speed of the fan assembly 102, the spray water status (e.g., whether the pump 722 is operating), the conductivity of the liquid in the sump 720, and the air variables (e.g., particulate matter, relative humidity, and dry bulb temperature) detected by the drift measurement sensors 150 at the air inlets 711 and the air outlet 713 of the heat exchange apparatus 700.

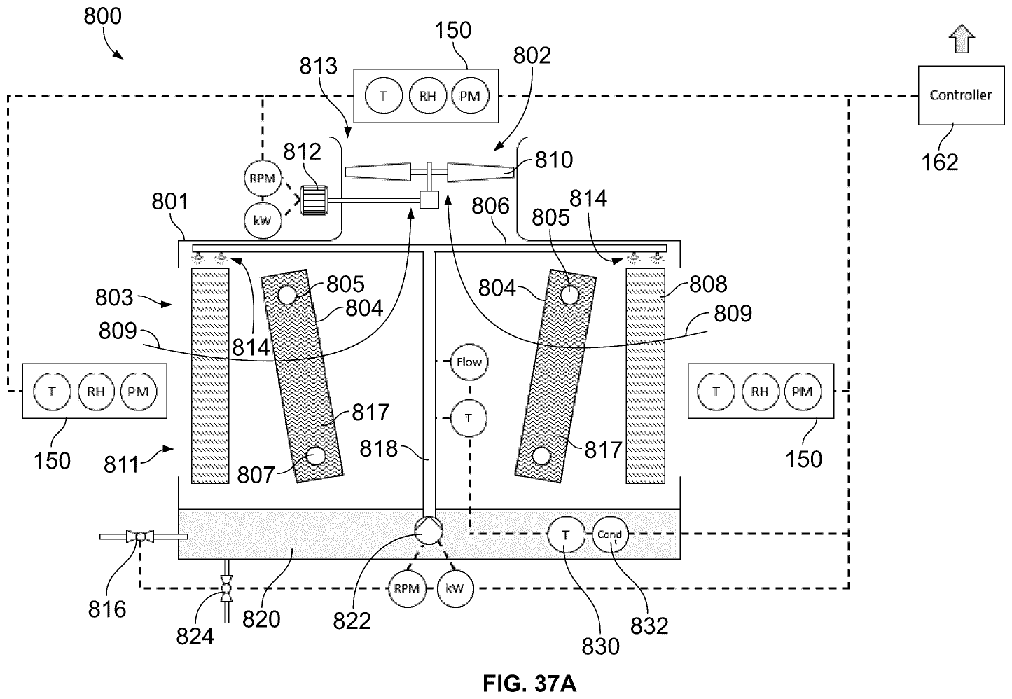

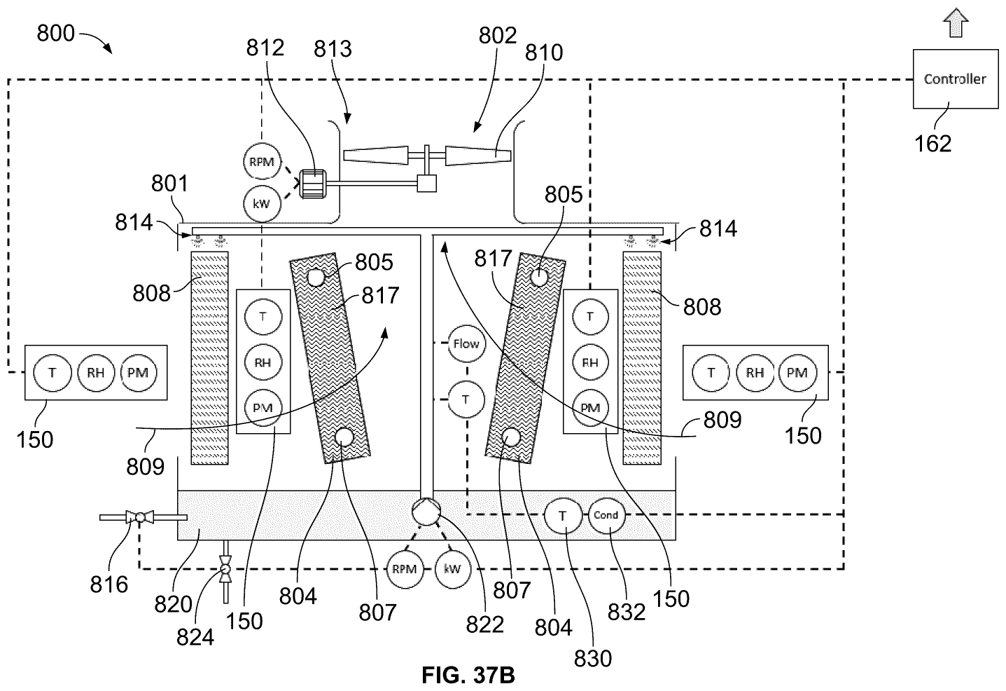

With respect to FIG. 37A, a cooling tower 800 is provided according to another embodiment. The cooling tower 800 is similar in many respects to the cooling towers discussed above such that the differences will be highlighted in the following discussion. The cooling tower 800 includes an airflow generator such as a fan assembly 802, indirect heat exchangers 804, a liquid distribution system 806, and an adiabatic precooler system 803. The adiabatic precooler system 803 includes a liquid absorbent material, such as one or more adiabatic pads 808, and an evaporative liquid distribution system 806 for distributing a liquid such as water onto the adiabatic pads 808 upstream of the indirect heat exchangers 804.

The fan assembly 802 includes a fan 810 and motor 812 that rotate the fan 810 to generate airflow along paths 809 relative to a housing 801 of the cooling tower 800. Specifically, the fan assembly 802 draws air into air inlets 811 of the housing 801, through the adiabatic pads 808, and from the adiabatic pads 808 to the indirect heat exchangers 804. The adiabatic pads 808 may be made from any liquid absorbing material that permits air to flow therethrough including, as an example, cellulose and/or impregnated cellulose fiber. As another example, the liquid absorbing material may include an inorganically impregnated glass fiber. As yet another example, the adiabatic pads 808 may be an adiabatic pre-cooler and include microporous membranes that permit liquid water to permeate through the membranes. The drift sensors 150 downstream of the adiabatic pads 808 may detect droplets that are entrained by airflow across the membranes.

The indirect heat exchangers 804 each include an inlet header 805 for receiving a fluid, an outlet header 807, and a heat exchange element such as finned tube heat exchangers 817 connecting the inlet and outlet headers 805, 807. Other heat exchange elements may be used, such as microtubes, serpentine tubes, plate heat exchangers, etc. The fluid enters the inlet header 805, travels through the finned tube heat exchangers 817, and is collected at outlet header 807 before flowing out of the indirect heat exchanger 804. The fluid received at the inlet header 805 may include, for example, liquid water, water vapor (e.g., steam), a mixture of liquid water and water vapor, ammonia, brine, and/or a glycol (e.g., propylene, ethylene). In one embodiment, the fluid received by the inlet header 805 may include a refrigerant such as R-134a, R410, R404, and/or R744.

The rotation of the fan 810 causes air to move from the air inlet 811, through the adiabatic pads 808, across the finned tube heat exchangers 817, upward through the fan assembly 802, and out from the heat exchange apparatus 800 via an air outlet 813. In one approach, the fluid in the finned tube heat exchangers 817 has a higher temperature than the air flowing over the finned tube heat exchangers 817 such that heat transfers through finned tube heat exchangers 817 from the higher temperature fluid in the interior of the finned tube heat exchangers 817 to the cooler airflow moving over the exterior of the finned tube heat exchangers 817.

The evaporative liquid distribution system 806 includes a liquid supply valve connected to a liquid supply. The liquid utilized by the liquid distribution system 806 may be, for example, water (e.g., tap water, rain water, and/or non-potable water). In some embodiments, the liquid distribution system receives water from a water treatment system that converts raw water into processed water having properties and/or additives (e.g., anti-fungal, anti-microbial) suitable for use in the heat exchange apparatus 800. In one embodiment, the liquid supply valve includes a makeup valve 816 that may be opened to distribute liquid into the sump 820 of the cooling tower 800.

The evaporative liquid distribution system 806 further includes a pump 822 within the sump 820. The pump 822 is operable to pump liquid from the sump 820 through a conduit 818 to one or more outlets of the evaporative liquid distribution system 806, such as nozzles 814. The nozzles 814 direct the liquid onto the adiabatic pads 808. The controller 162 may control the pump 822 to cause the evaporative liquid distribution system 806 to distribute liquid onto the adiabatic pads 808 to increase the efficiency of the indirect heat exchanger process. For instance, the adiabatic pad 808 is positioned in the flow path of the air upstream of the finned tube heat exchangers 817. When the adiabatic pad 808 has been soaked with liquid from the liquid distribution system 806, the liquid in the adiabatic pad 808 evaporates into the air passing through the pad 808 which lowers the temperature of the air before the air passes over the finned tube heat exchangers 817. The cooler air passing over the finned tube heat exchangers 817 improves the efficiency of the indirect heat exchange process. Liquid that is not absorbed by the adiabatic pads 808 may be collected in the sump 820 positioned below the adiabatic pads 808.

The cooling tower 800 may include a temperature sensor 830 and a conductivity sensor 832 associated with the sump 820 for monitoring the temperature and conductivity of the fluid within the sump 820. The controller 162 may receive data from the temperature sensor 830 and/or the conductivity sensor 832. The sump 820 may have a drain valve 824 that may be opened (e.g., by the controller 162) to drain fluid from the sump 820 and out of circulation within the cooling tower 800. The drain valve 824 may be opened to drain liquid from the sump 820, for example, when there is too much liquid in the sump 820 or to drain the liquid from the sump 820 as part of a liquid changeover process, for example, when the conductivity or pH of the liquid exceeds a threshold.

The cooling tower 800 may include one or more drift measurement sensors 150 according to the embodiments discussed above to monitor one or more variables of the cooling tower 800, for example, variables relating to air quality conditions. As shown in FIG. 37A, the cooling tower 800 may include a drift measurement sensor 150 at the air outlet 813 of the cooling tower 800 and one or more of the air inlets 811. As discussed in greater detail above, the drift measurement sensors 150 include one or more sensors to monitor one or more variables indicative of properties of the airflow received at the drift measurement sensors 150. The controller 162 may monitor changes in the monitored variables and determine whether the change is indicative of an increase in the drift rate of the cooling tower beyond an expected or acceptable amount. For example, when the evaporative liquid distribution system 806 is turned on and the pump 822 beings pumping fluid, the controller 162 will expect there to be an increase in the amount of particulate matter detected by the drift measurement sensor 150 downstream of the finned tube heat exchangers 817, for example, at the air outlet 813. The controller 162 may monitor the increase in particulate matter at the air outlet 813 and determine whether the increase in particulate matter exceeds the expected or acceptable amount such that the controller 162 determines the heat exchange apparatus 800 has an undesirable or unacceptable drift condition. The controller 162 may determine that there is no drift when the heat exchange apparatus 800 is operating in a dry mode wherein liquid distribution system 806 has been turned off for a period of time (e.g., the adiabatic pad 808 is dry) because there are no evaporative liquid particles to be carried away in the flow of air toward the air outlet 813.

The drift measurement sensors 150 may be mounted at various locations of the heat exchange apparatus 800 to monitor drift. With respect to FIG. 37B, the heat exchange apparatus 800 includes drift measurement sensors 150 mounted downstream of the adiabatic pad 808 and upstream of the of the indirect heat exchanger 804. The controller 162 may compare the change in air variables of the air as the passes through the adiabatic pads 808. Further, because the drift measurement sensors 150 are immediately downstream of the adiabatic pads 808, the drift measurement sensors 150 are positioned to detect drift from the adiabatic pads 808 as the drift contacts the finned tube heat exchangers 817. The positioning of the drift measurement sensors 150 intermediate the adiabatic pads 808 and the finned tube heat exchangers 817 may also permit a more accurate determination of the magnitude of an increase in the amount of drift. The controller 162 may be programmed to adjust operation of the heat exchange apparatus 800 to address the unacceptable drift condition and limit fouling, scaling, and/or corrosion.

In some embodiments, the drift measurement sensor utilized for a heat exchange apparatus may include a sensor configured to detect microorganisms instead of, or in addition to, a conductivity measurement. The microorganisms may include, for example, fungi, algae, and bacteria. The sensor may detect, for example, a particular microorganism and/or a total bacteria count in a sample. The controller of the heat exchange apparatus may utilize the bacteria detection to determine the onset of drift with undesirable microorganism content, e.g., drift containing an amount of microorganisms in an amount above a predetermined threshold. The drift measurement sensor may be cleaned periodically using manual or automated approaches, such as chlorine injection, ultraviolet light treatment, and/or a water rinse. The drift measurement sensor may also utilize deactivation or killing of the detected bacteria post-measurement, such as a UV light treatment system mounted in-line to treat collected water before the water is routed back to the sump of the unit.

In some embodiments, the airflow generator of an air contactor includes a housing or other structure of the air contactor that produces an airflow. For example, the hyperboloid housing of a natural draft cooling tower has a shape that cooperates with heated, rising air in the cooling tower to draw air into the cooling tower and direct the heated air upward, out of the cooling tower.

As another example, some air contactors includes nozzles that spray liquid and the spraying of liquid causes movement of air. The air contactor has a housing or other structure that directs the moving air into an airflow through the air contactor. In some embodiments, the air contactor does not include a fan.

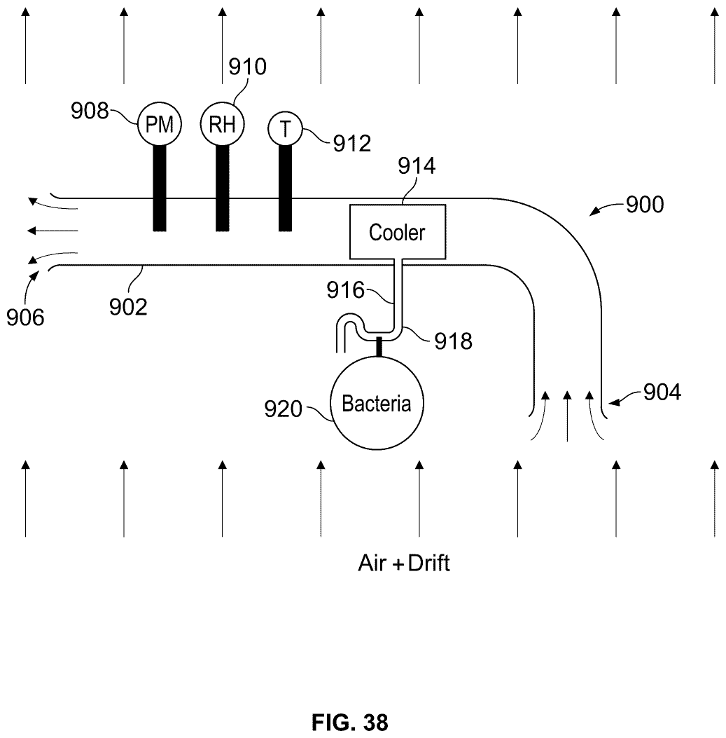

With reference to FIG. 38, a drift measurement sensor 900 is provided that includes a body such as a primary conduit 902 having an inlet 904 to receive air and an outlet 906. The drift measurement sensor 900 includes one or more sensors such as a particulate matter sensor 908, a relative humidity sensor 910, and a temperature sensor 912 configured to detect the relevant variables of the air traveling through the primary conduit 902. The drift measurement sensor 900 further includes a dehumidifier, such as a cooler 914, that removes water from the air and directs the collected water into a secondary conduit 916. The secondary conduit 916 has a collecting portion, such as a U-shaped bend 918, to collect the water and a bacteria sensor 920 to detect one or more variables relating to bacteria in the water in the bend 918.

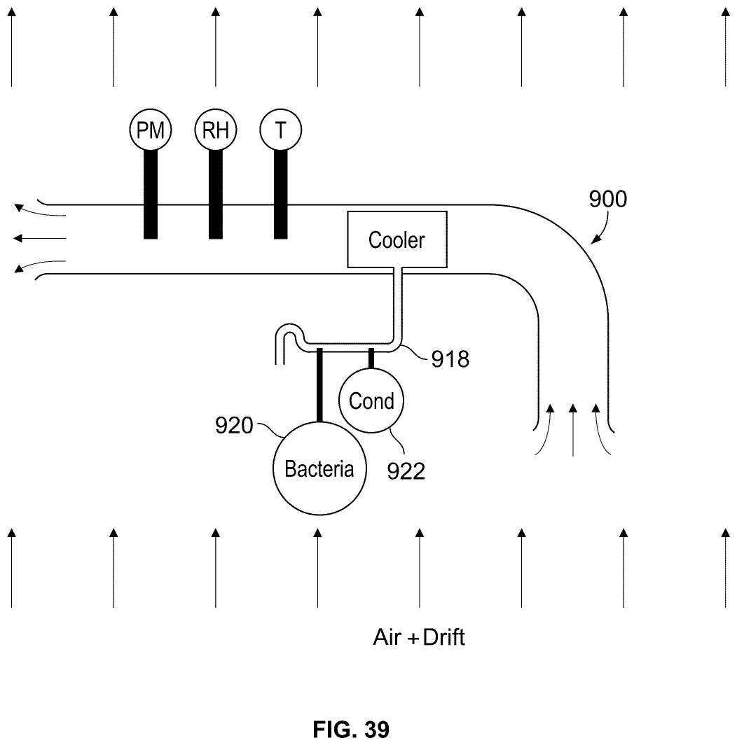

With reference to FIG. 39, the drift measurement sensor 900 is provided in another embodiment wherein the drift measurement sensor 900 includes a conductivity sensor 922. The conductivity sensor 922 is configured to detect the conductivity of the water in the bend 918 in addition to the bacteria sensor 920 detecting the one or more variables of bacteria in the water of the bend 918.

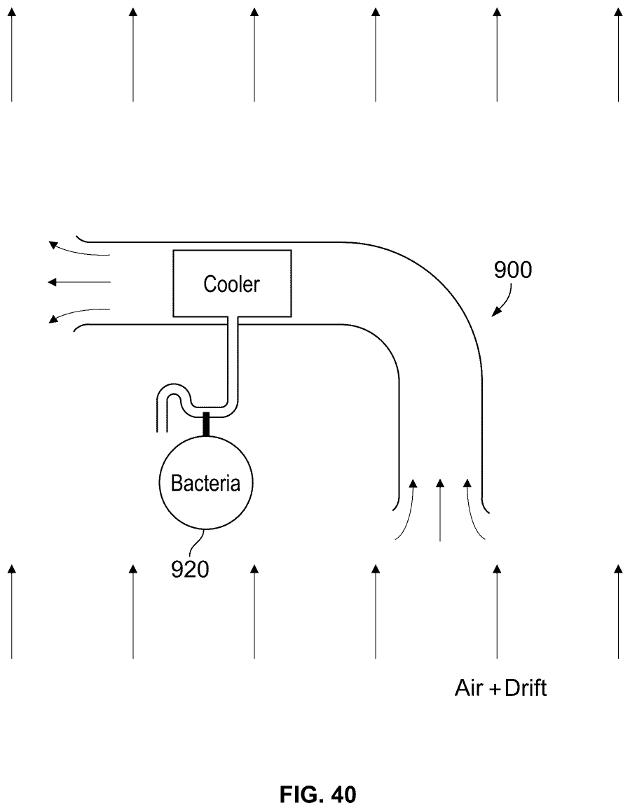

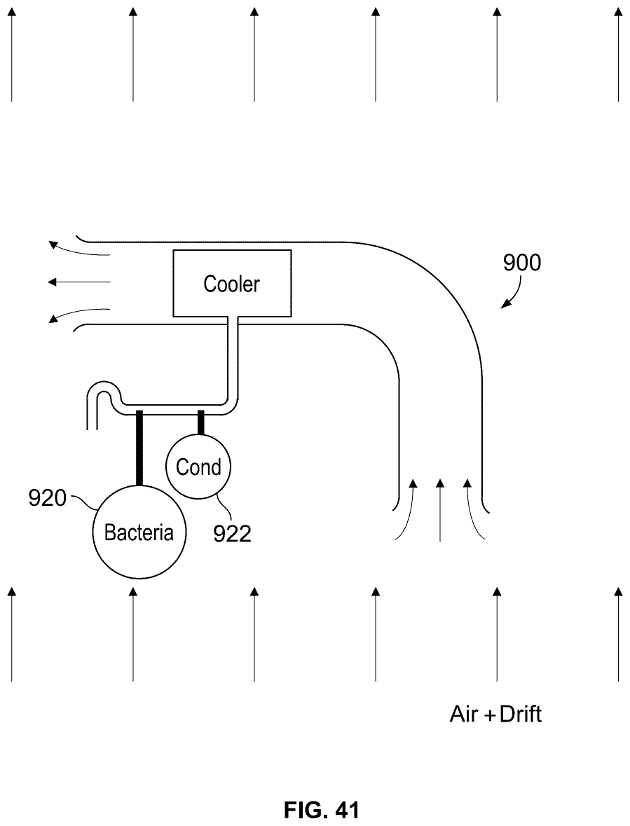

Various other configurations of the drift measurement sensor 900 may be provided. For example, FIG. 40 shows an embodiment of the drift measurement sensor 900 wherein the drift measurement sensor 900 includes the bacteria sensor 920 but not the particulate matter sensor 908, relative humidity sensor 910, and temperature sensor 912. The embodiment of FIG. 41 adds the conductivity sensor 922.

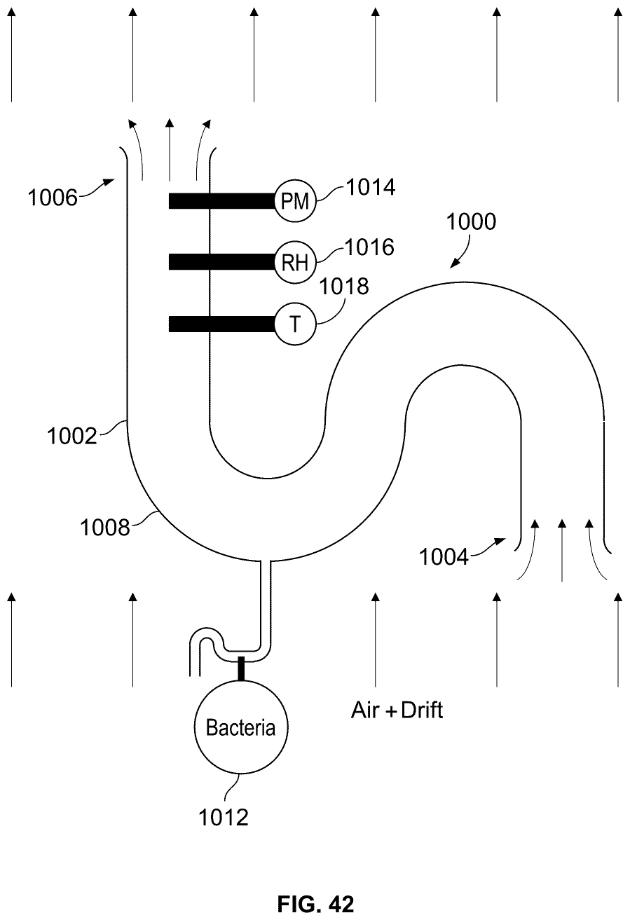

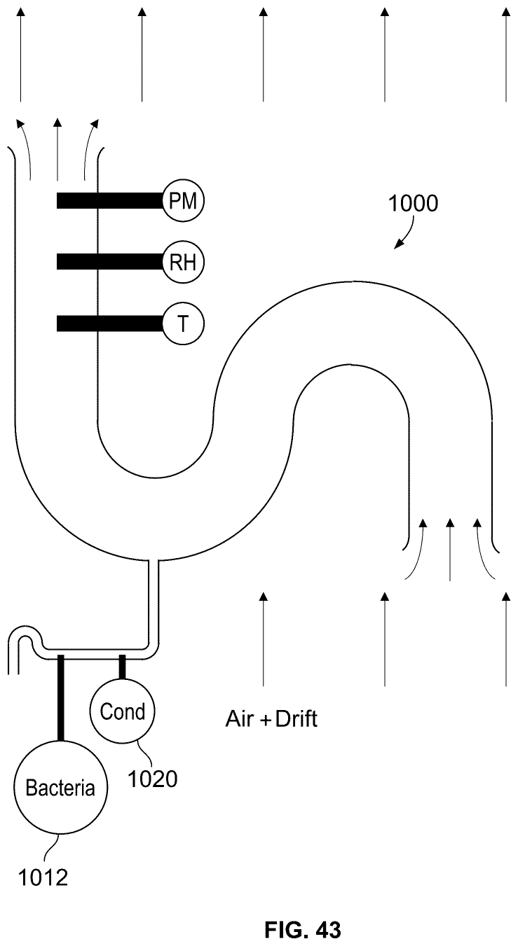

With reference to FIG. 42, a drift measurement sensor 1000 is provided that includes a body 1002 having an inlet 1004 for receiving air, an outlet 1006, and a collecting portion such as a bend 1008 wherein drift in the air may collect. The drift measurement sensor 1000 has a conduit 1010 that directs the collected drift to a bacteria sensor 1012. The drift measurement sensor 1000 further includes a particulate matter sensor 1014, a relative humidity sensor 1016, and a temperature sensor 1018. In another embodiment, the drift measurement sensor 1000 may be provided with a conductivity sensor 1020 as shown in FIG. 43.

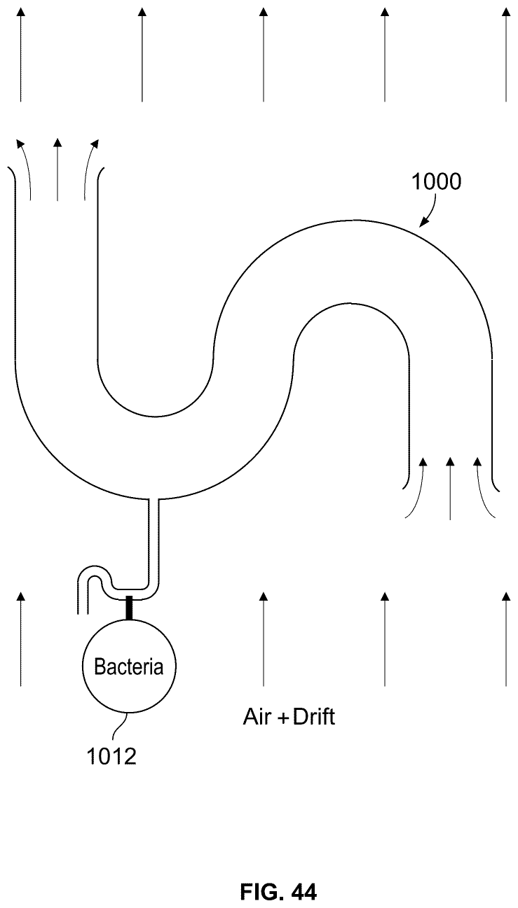

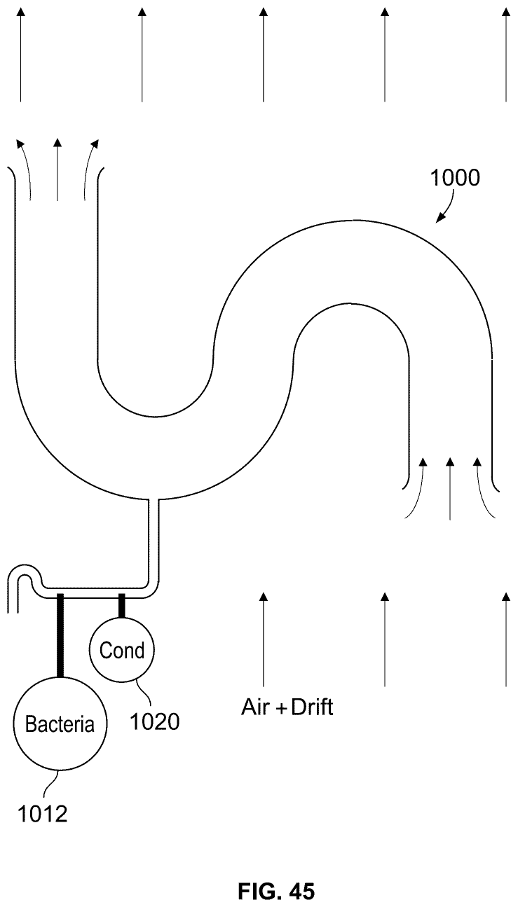

In yet another embodiment, the drift measurement sensor 1000 may be provided without the particulate matter sensor 1014, relative humidity sensor 1016, and temperature sensor 1018 as shown in FIG. 44. Similarly, the drift measurement sensor may be provided with the bacteria sensor 1012 and the conductivity sensor 1020 as shown in FIG. 45.

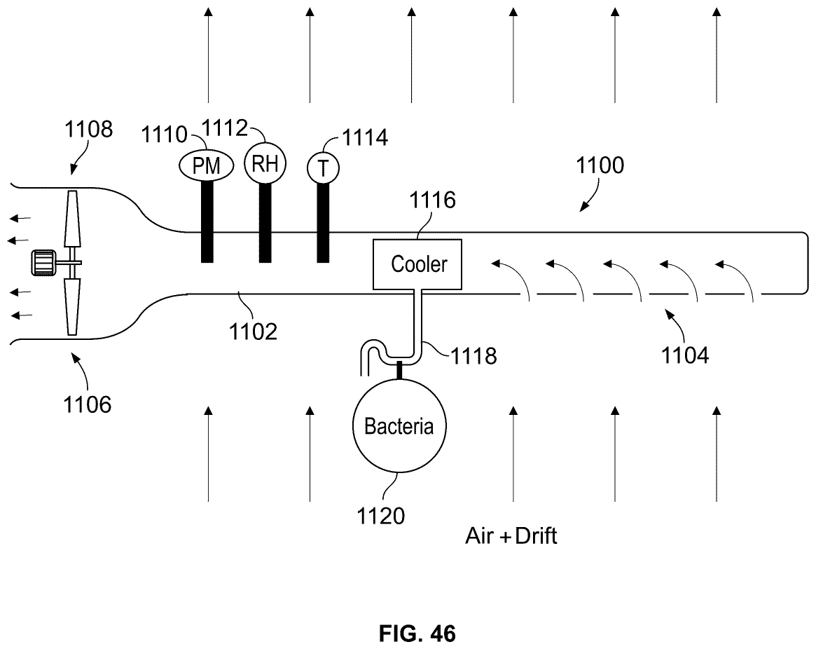

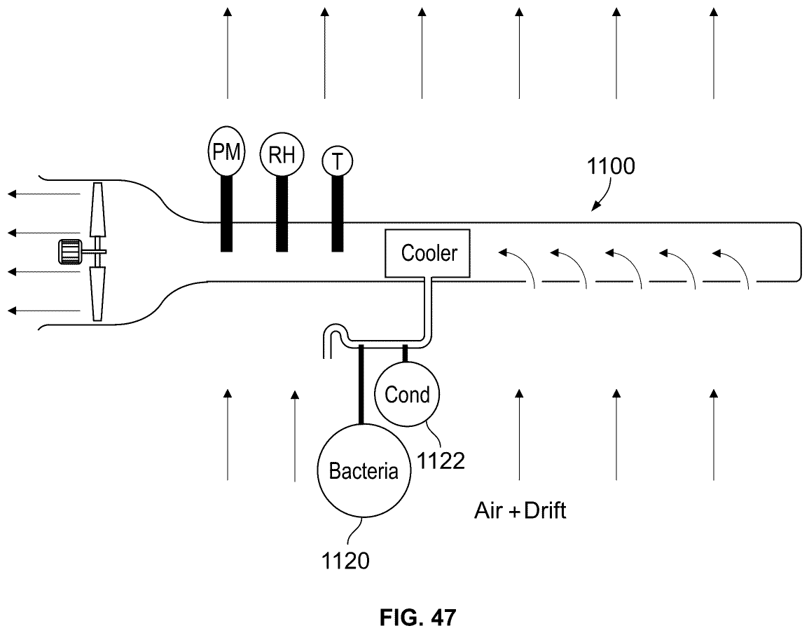

With reference to FIG. 46, a drift measurement sensor 1100 is provided that includes a body 1102, inlet openings 1104, an outlet 1106, and a fan assembly 1108 to generate airflow through the body 1102. The drift measurement sensor 1100 has a particulate matter sensor 1110, a relative humidity sensor 1112, and a temperature sensor 1114. The drift measurement sensor 1100 has a dehumidifier such as a cooler 1116 that removes water from the air and a conduit 1118 configured to direct the collected water to a bacteria sensor 1120. In another embodiment, the drift measurement sensor 1100 has a conductivity sensor 1122 as shown in FIG. 47.

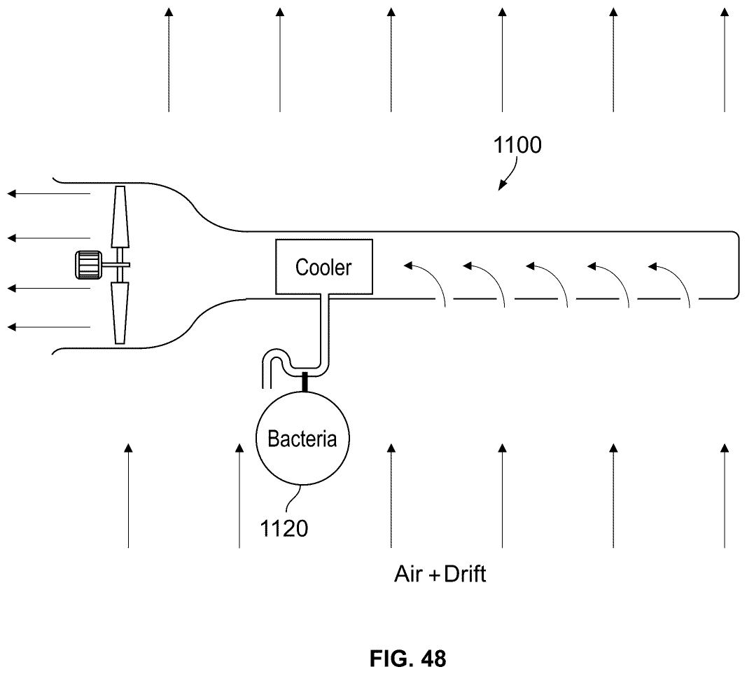

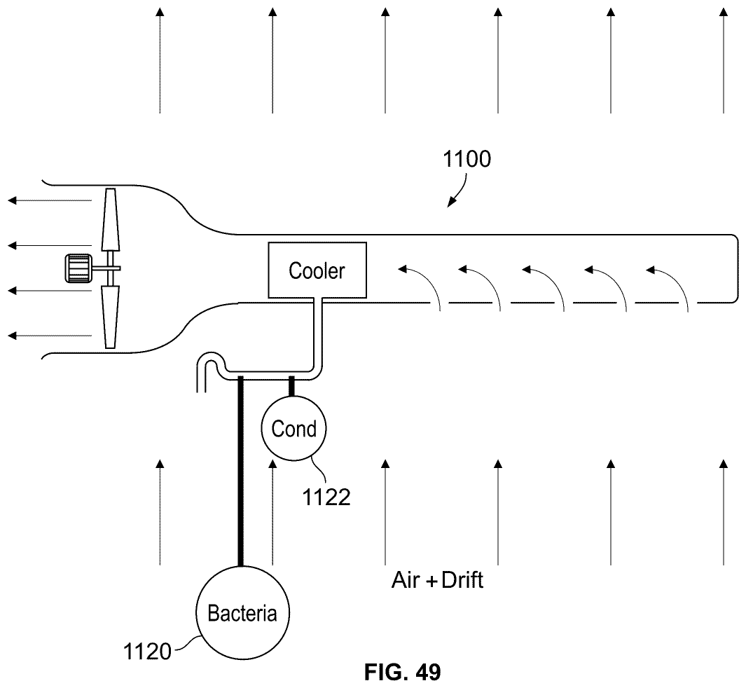

In yet another embodiment, the drift measurement sensor 1100 is provided without the particulate matter sensor 1110, relative humidity sensor 1112, and temperature sensor 1114 as shown in FIG. 48. The drift measurement sensor 1100 may be provided with the bacteria sensor 1120 and the conductivity sensor 1122 as shown in FIG. 49.

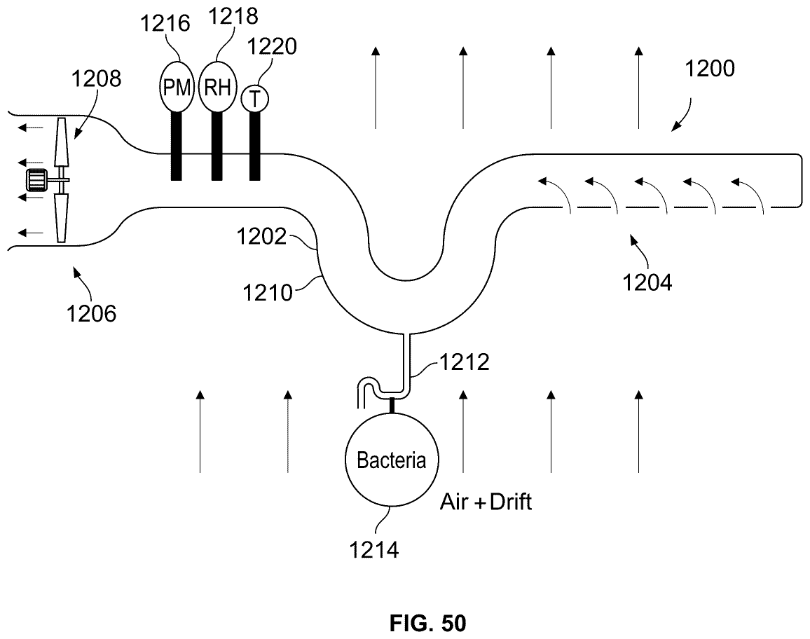

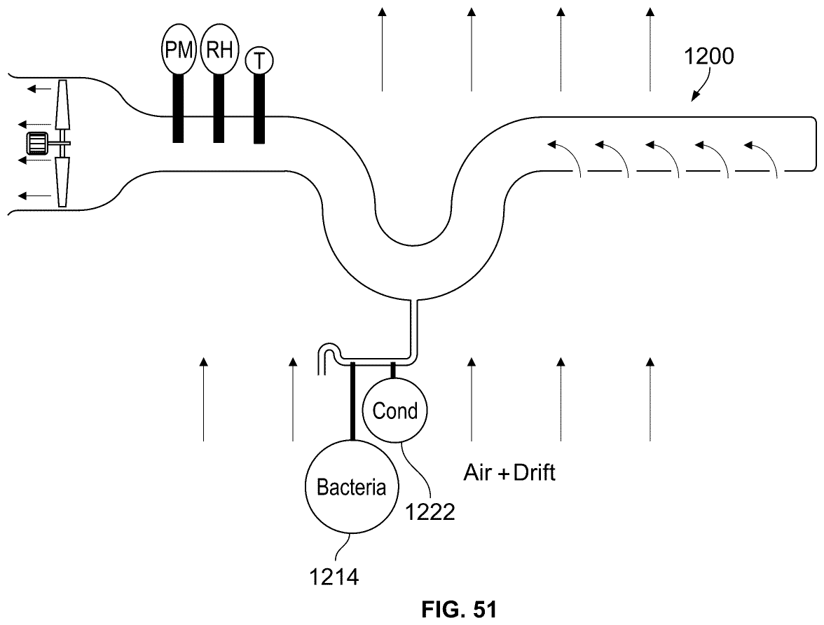

With reference to FIG. 50, a drift measurement sensor 1200 is provided that is similar to the drift measurement sensor 600 of FIG. 35. The drift measurement sensor 1200 includes a body 1202 having air inlets 1204, an outlet 1206, a fan assembly 1208, and a collecting portion such as a bend 1210 to collect water (e.g., drift) in the air traveling through the body 1202. The drift measurement sensor 1200 has a conduit 1212 that directs the collected water to a bacteria sensor 1214. The drift measurement sensor 1200 further includes a particulate matter sensor 1216, a relative humidity sensor 1218, and a temperature sensor 1220. In one embodiment, the drift measurement sensor 1200 is provided with a conductivity sensor 1222 as shown in FIG. 51.

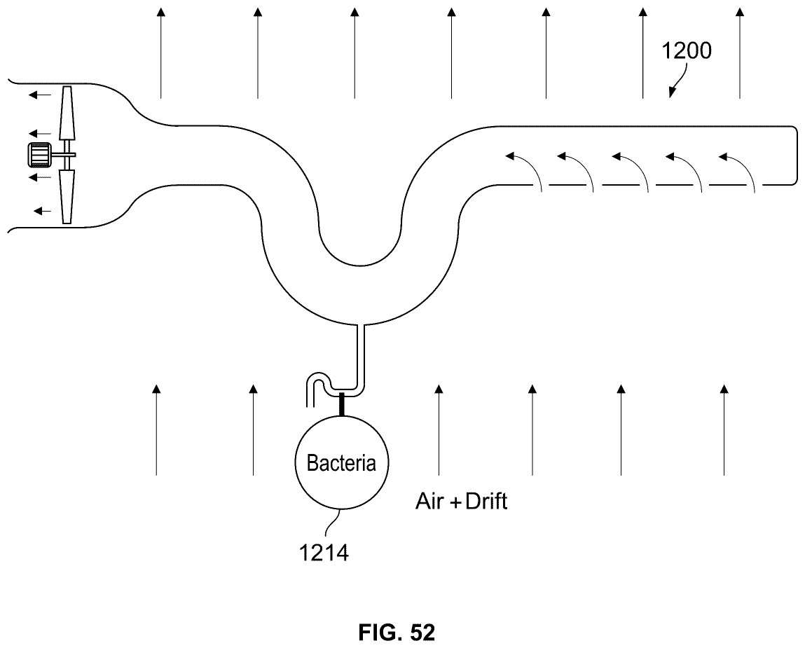

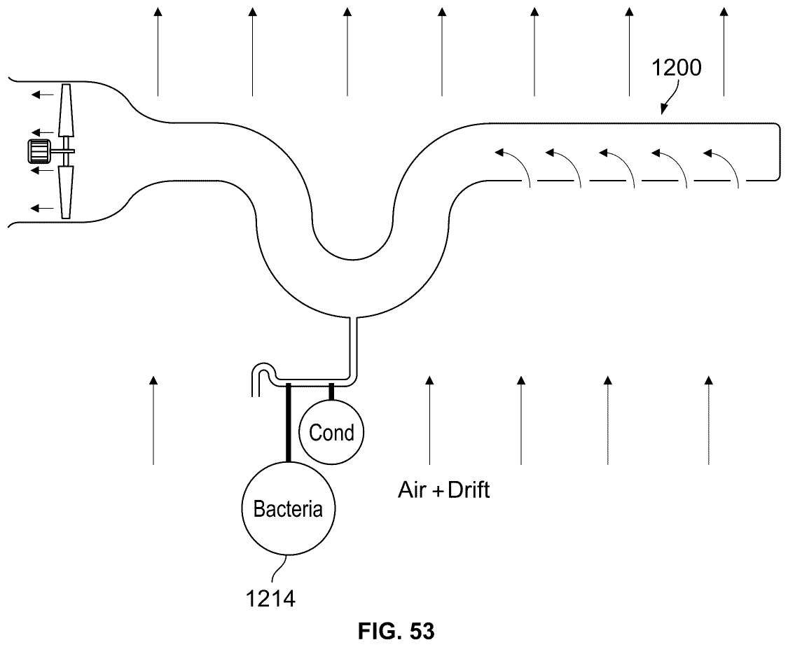

The drift measurement sensor 1200 may be provided without the particulate matter sensor 1216, the relative humidity sensor 1218, and the temperature sensor 1220 as shown in FIG. 52. The drift measurement sensor 1200 may include the conductivity sensor 1222 as shown in FIG. 53.

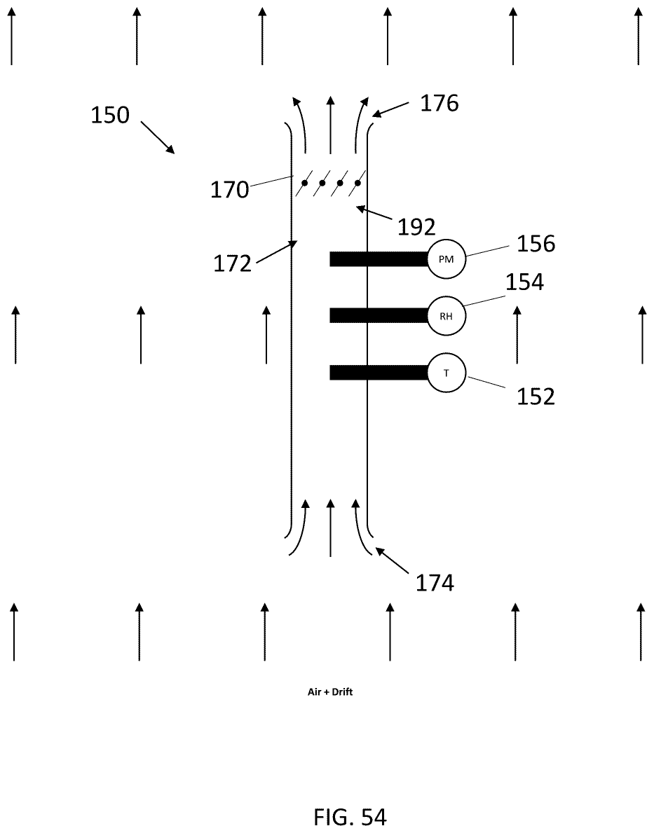

With respect to FIG. 54, another embodiment of the drift measurement sensor 150 is provided that is similar to the embodiment shown in FIG. 11. One difference between the drift measurement sensors 150 in FIGS. 11 and 54 is that the drift measurement sensor 150 of FIG. 54 has dampers 192 mounted at the outlet 176 and does not have dampers at the inlet 174.

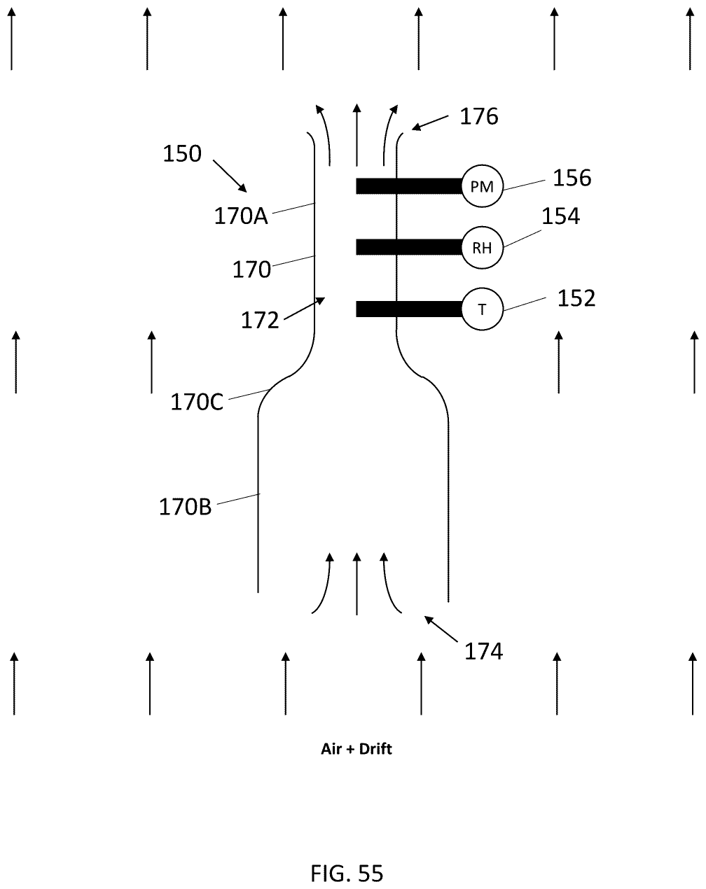

With respect to FIG. 55, another embodiment of the drift measurement sensor 150 is provided that is similar in many respects to the embodiment shown in FIG. 4 such that the differences are highlighted. In the embodiment of FIG. 55, the tube 170 of the drift measurement sensor 150 has a large diameter portion 170B, a small diameter portion 170B, and a neck portion 170C that connects the large diameter portion 170B and the small diameter portion 170B. The large diameter portion 170B includes the air inlet 174. The neck portion 170C funnels the air and drift in the large diameter portion 170B into the small diameter portion 170A. The sensors 152, 154, 156 detect variables (such as particulate matter, relative humidity, and temperature) of the airflow in the small diameter portion 170A. The ratio of the diameters of the large diameter portion 170B and the small diameter portion 170A, and the shape of the neck portion 170C, may be selected such that air flowing through the small diameter portion 170A has the same speed as the airflow outside of the tube 170.

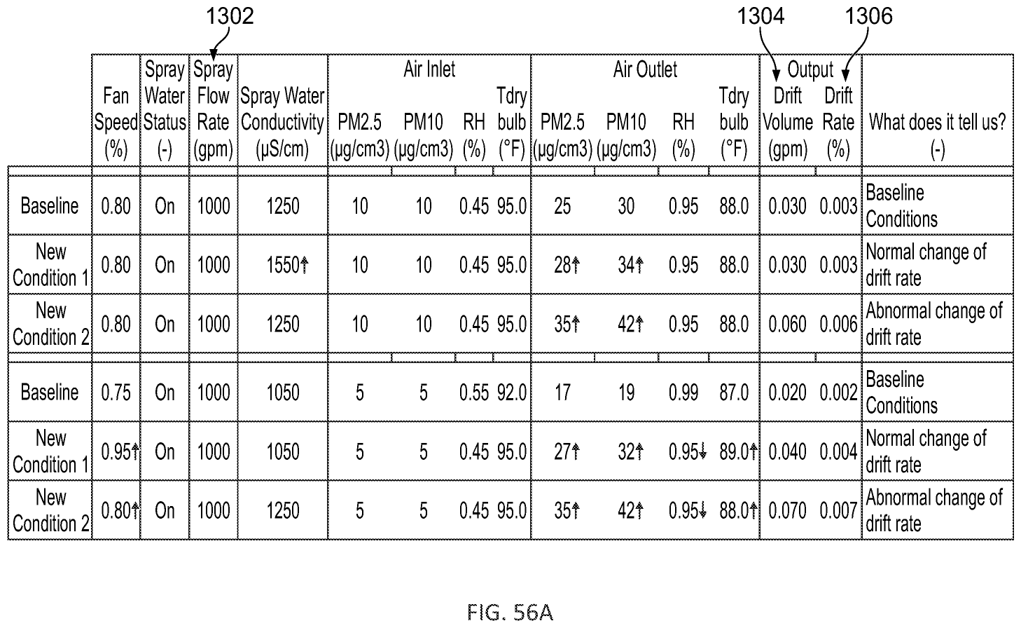

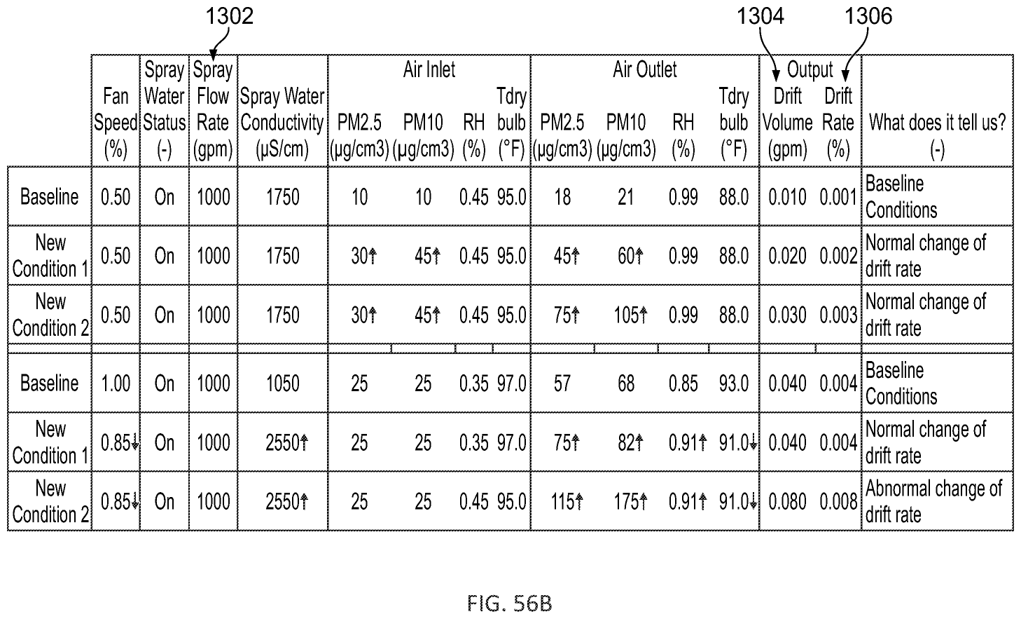

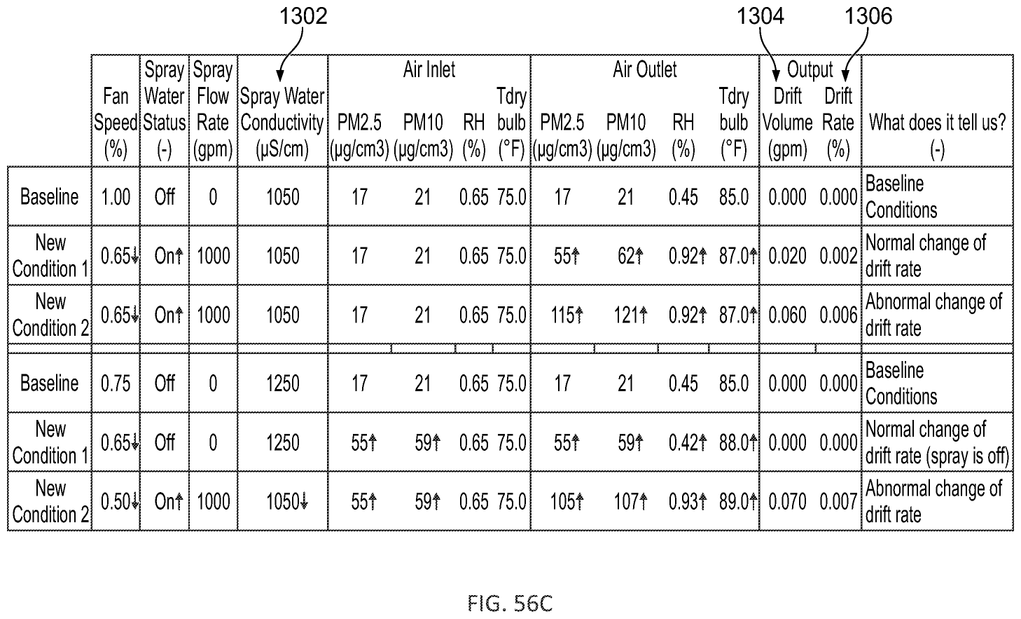

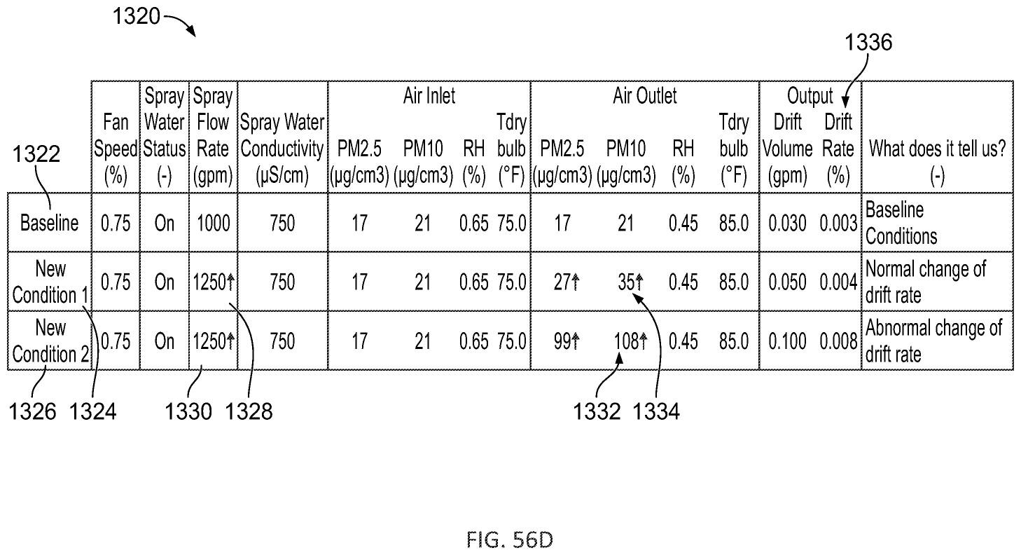

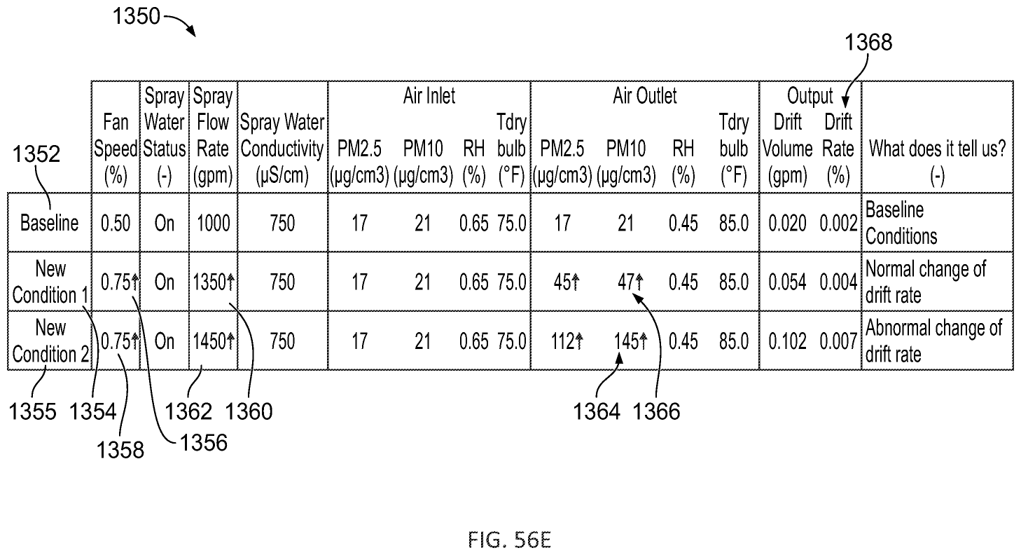

With respect to FIGS. 56A-56E, example charts are provided that include data showing how changing conditions of the cooling tower 100 may be used to detect changes in the drift rate of the cooling tower 100 similar to the charts of FIGS. 3A-3F discussed above. The charts of FIGS. 56A-56E have additional columns for the spray flow rate 1302 of the liquid distribution system 106, the drift volume 1304, and drift rate 1306 of the cooling tower 100. The spray flow rate 1302 and the drift volume 1304 may be in gallons per minute (gpm) while the drift rate 1306 is a dimensionless quantity, e.g., a percentage.

The drift rate 1306 is calculated by dividing the drift volume 1304 by the spray flow rate 1302, then multiplying by 100. In other words, the drift rate 1306 is the percentage of the spray from the liquid distribution system 106 that leaves the cooling tower 100 as drift. With respect to FIGS. 56A-56C, the controller 162 may calculate the drift rate 1306 based on the data collected by the sensors of the cooling tower 100. The controller 162 may determine whether the drift rate 1306 of the cooling tower is normal or abnormal by comparing the change in drift rate 1306 from a baseline condition to a new condition. For example and with reference to FIG. 56A, the controller 162 may determine an abnormal drift rate 1306 as the cooling tower 100 changes from the Baseline condition to New Condition 2 since the drift rate doubles 1306, i.e., changes from 0.003% to 0.006%. The threshold change that triggers the abnormal drift condition determination may be fixed or variable, such as a 25% increase in drift rate given a particular change in operating condition of the cooling tower 100. By contrast, the controller 162 may determine a normal drift rate 1306 as the cooling tower 100 changes from the Baseline condition to New Condition 2 since the drift rate 1306 remains the same (0.003%).

Alternatively or additionally, the controller 162 may determine whether the drift rate 1306 is normal or abnormal by comparing the drift rate 1306 for a given condition with a threshold drift rate, for example, 0.005%. For example, when the drift rate 1306 for a given condition is equal to or less than 0.005%, the change in drift between the air inlet and the air outlet of the cooling tower 100 is normal. When the drift rate 1306 for a condition is greater than 0.005%, the change in drift between the air inlet and the air outlet of the cooling tower 100 is abnormal.

With respect to FIG. 56D, an example chart 1320 is provided illustrating an evaluation of the change in the spray flow rate of the liquid distribution system 106. In changing from the baseline condition 1322 to New Condition 1324 and New Condition 1326, the spray flow rate 1328, 1330 of the water increases. In New Condition 1326, however, the amount of PM2.5 and PM10 particulate matter 1332 at the air outlet 130 of the cooling tower 100 is greater than the amount of particulate matter 1334 in New Condition 1324. In New Condition 1324, the increase in the PM2.5 and PM10 particulate matter 1334 at the air outlet 130 is attributable to the increase in the spray flow rate 1328 of the liquid distribution system 106 and thus there has been no significant increase in drift rate 1336. In New Condition 1326, the amount of particulate matter 1332 at the air outlet 130 increased significantly and/or disproportionately relative to the increase in the spray flow rate 1330 of the liquid distribution system 106 (e.g., compared to the change to New Condition 1326). The controller 162 determines that the increase in particulate matter 1332 at the air outlet 130 is the result of an abnormal increase in the drift rate of the cooling tower 100 beyond an acceptable or expected drift rate at these conditions because the increase in particulate matter 1332 is not entirely attributable to the increase in the spray flow rate 1330 or any other monitored variable. Alternatively or additionally, the controller 162 may calculate a drift rate 1336 for each condition and determine whether the drift rate is abnormal or normal based on a comparison with a drift rate threshold.

With respect to FIG. 56E, an example chart 1350 is provided illustrating an evaluation of the change in the speed of the fan assembly 102 and in the spray flow rate of the liquid distribution system 106. In changing from the baseline condition 1352 to New Condition 1354 or New Condition 1355, the speed 1356, 1358 of the fan assembly 102 is increased 25% and the spray flow rate 1360, 1362 of the water increases. In New Condition 1355, however, the amount of PM2.5 and PM10 particulate matter 1364 at the air outlet 130 of the cooling tower 100 is significantly greater (e.g., nearly three times greater) than the amount of particulate matter 1366 in New Condition 1354. In New Condition 1354, the increase in the PM2.5 and PM10 particulate matter 1366 at the air outlet 130 is attributable to the increase in the spray flow rate 1360 of the liquid distribution system 106 and the speed of the fan assembly 102 such that the drift rate 1368 increased a normal amount. In New Condition 1355, the amount of particulate matter 1364 at the air outlet 130 increased significantly and/or disproportionately relative to the increase in the spray flow rate 1362 of the liquid distribution system 106 and increased speed 1358 of the fan assembly 102 (e.g., compared to the change to New Condition 1354). The controller 162 determines that the increase in particulate matter 1364 at the air outlet 130 is the result of an abnormal increase in the drift rate of the cooling tower 100 beyond an acceptable or expected drift rate at these conditions because the increase in particulate matter 1364 is not entirely attributable to the increase in the spray flow rate 1362, fan speed 1358, or any other monitored variable.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims. For example, it will be appreciated that this disclosure can be applied to other processes, such as manufacturing processes, that spray water or another liquid.

1. An air contactor comprising:
an airflow generator to generate an airflow;
a liquid distribution system operable to distribute liquid that is contacted by the airflow;
a sensor configured to detect an air variable of the airflow;
a controller operably connected to the liquid distribution system and the sensor, the controller configured to:
determine an operating variable of at least one of the airflow generator and the liquid distribution system; and
determine a drift condition of the air contactor based at least in part upon the air variable of the airflow and the operating variable of the at least one of the airflow generator and the liquid distribution system.

2. The air contactor of claim 1 wherein the drift condition includes an abnormal drift condition of the air contactor; and
wherein the controller is configured to determine the abnormal drift condition in response to:
the air variable being sufficiently different than an expected air variable; and/or
the operating variable being sufficiently different than an expected operating variable.

3. The air contactor of claim 1 wherein the drift condition includes a drift rate of the air contactor.

4. The air contactor of claim 1 wherein the drift condition includes an abnormal drift condition of the air contactor;
wherein the controller is configured to determine a drift rate of the air contactor; and
wherein the controller is configured to determine the abnormal drift condition in response to the drift rate of the air contactor being an abnormal drift rate.

5. The air contactor of claim 1 wherein the drift condition includes an abnormal change in the drift of the air contactor.

6. The air contactor of claim 1 wherein the air variable comprises an upstream air variable and a downstream air variable;
wherein the sensor comprises:
an upstream sensor configured to detect the upstream air variable of the airflow upstream of the airflow contacting the liquid; and
a downstream sensor configured to detect the downstream air variable of the airflow downstream of the airflow contacting the liquid.

7. The air contactor of claim 6 wherein the drift condition includes an abnormal drift condition; and
wherein the controller is configured to determine the drift condition based at least in part upon the downstream air variable being abnormal relative to the upstream air variable.

8. The air contactor of claim 1 wherein the air variable comprises a first air variable associated with a first operating condition of the air contactor and a second air variable associated with a second operating condition of the air contactor;
wherein the operating variable comprises a first operating variable associated with the first operating condition and a second operating variable associated with the second operating condition;
wherein the drift condition includes an abnormal drift condition; and
wherein the controller is configured to determine the abnormal drift condition of the air contactor in response to:
the second air variable changing abnormally from the first air variable; and/or
the second operating variable changing abnormally from the first operating variable.

9. The air contactor of claim 8 wherein the airflow generator comprises a fan assembly;
wherein the first operating condition comprises the controller being configured to operate the fan assembly at a first speed and control the liquid distribution system to distribute liquid; and
wherein the second operating condition comprises the controller being configured to operate the fan assembly at a different, second speed and control the liquid distribution system to distribute liquid.

10. The air contactor of claim 1 wherein the drift condition is an abnormal drift condition; and
wherein the controller is configured to determine the abnormal drift condition based at least in part upon a comparison of the air variable and the operating variable to a dataset of variables corresponding to normal drift conditions.

11. The air contactor of claim 1 wherein the operating variable includes a variable of the liquid; and
wherein the controller is configured to determine the drift condition based at least in part upon the air variable and the variable of the liquid.

12. The air contactor of claim 1 wherein the controller is configured to determine the drift condition using a machine learning algorithm to process the air variable and the operating variable.

13. The air contactor of claim 1 wherein the operating variable of at least one of the airflow generator and the liquid distribution system comprises a first variable of the airflow generator and a second variable of the liquid distribution system.

14. The air contactor of claim 1 wherein the airflow generator includes a fan assembly operable to generate the airflow; and
wherein the operating variable comprises a fan assembly operating variable.

15. The air contactor of claim 1 wherein the air sensor comprises a particulate matter sensor; and
wherein the air variable comprises a particulate variable indicative of particulate matter in the airflow.

16. The air contactor of claim 15 wherein the particulate matter sensor comprises:
a first particulate matter sensor configured to detect particles of a first size; and
a second particulate matter sensor configured to detect particles of a smaller, second size; and
wherein the particulate variable comprises:
a first particulate variable indicative of particulate matter in the airflow having the first size; and
a second particulate variable indicative of particulate matter in the airflow having the second size.

17. The air contactor of claim 1 wherein the sensor comprises a particulate matter sensor, a relative humidity sensor, and a temperature sensor; and
wherein the air variable comprises a particulate matter variable, a relative humidity variable, and an air temperature variable.

18. The air contactor of claim 1 wherein the airflow generator comprises a fan assembly;
wherein the operating variable of at least one of the airflow generator and the liquid distribution system includes:
a fan speed of the fan assembly; and
an operating condition of the liquid distribution system.

19. The air contactor of claim 1 wherein the operating variable of at least one of the airflow generator and the liquid distribution system includes:
an operating condition of the liquid distribution system; and
a variable of the liquid.

20. The air contactor of claim 1 wherein the sensor comprises:
a passageway to receive a portion of the airflow; and
a particulate sensor to detect a particulate variable of the portion of the airflow.

21. The air contactor of claim 1 wherein the sensor comprises:
a passageway to receive a portion of the airflow;
an airflow sensor to detect the air variable of the portion of the airflow in the passageway; and
a heater, cooler, or both in the passageway upstream of the airflow sensor.

22. The air contactor of claim 1 wherein the controller is configured to adjust operation of at least one of the airflow generator and the liquid distribution system in response to the determination of the drift condition.

23. The air contactor of claim 1 further comprising a pad, fill, and/or an indirect heat exchanger; and
wherein the liquid distribution system is operable to distribute the liquid onto the pad, fill and/or indirect heat exchanger.

24. The air contactor of claim 1 wherein the liquid is an air pollutant capture solution.

25. The air contactor of claim 1 wherein the air contactor is a hyperbolic cooling tower;
wherein the airflow generator is a shell of the hyperbolic cooling tower; and
wherein the operating variable is an operating variable of the liquid distribution system.

26. The air contactor of claim 1 wherein the operating variable of at least one of the air generator and the liquid distribution system comprises a plurality of variables of the liquid distribution system, the plurality of variables including:
a first variable indicative of whether a pump of the liquid distribution system is operating; and
a second variable indicative of a conductivity of the liquid.

27. A method of operating an air contactor having an airflow generator that produces an airflow, the method comprising:
operating a liquid distribution system of the air contactor to distribute a liquid, the airflow contacting the liquid;
detecting, via a sensor of the air contactor, an air variable of the airflow;
determining an operating variable of at least one of the airflow generator and the liquid distribution system; and
determining a drift condition of the air contactor based at least in part upon the air variable of the airflow and the operating variable of the at least one of the airflow generator and the liquid distribution system.

28. The method of claim 27 wherein the airflow generator comprises a fan assembly, the method further comprising:
operating the fan assembly to generate the airflow from an air inlet to an air outlet of the air contactor.

29. The method of claim 27 wherein the drift condition of the air contactor is an abnormal drift condition, a drift rate of the air contactor, or an abnormal change in drift of the air contactor.

30. The method of claim 27 wherein the air variable comprises an upstream air variable and a downstream air variable;
wherein the sensor of the air contactor includes an upstream sensor and a downstream sensor; and
wherein detecting the air variable of the airflow comprises:
detecting, via the upstream sensor, the upstream air variable of the airflow upstream of the airflow contacting the liquid; and
detecting, via the downstream sensor, the downstream air variable of the airflow downstream of the airflow contacting the liquid.

31. The method of claim 30 wherein the drift condition is an abnormal drift condition; and
wherein determining the abnormal drift condition comprises determining the drift condition based at least in part upon the downstream air variable being abnormal relative to the upstream air variable.

32. The method of claim 27 wherein the air variable comprises a first air variable associated with a first operating condition of the air contactor and a second air variable associated with a second operating condition of the air contactor;
wherein the operating variable comprises a first operating variable associated with the first operating condition and a second operating variable associated with the second operating condition;
wherein the drift condition includes an abnormal drift condition; and
wherein determining the abnormal drift condition of the air contactor is based at least in part upon:
an abnormal change of the first air variable to the second air variable; and/or
an abnormal change of the first operating variable to the second operating variable.

33. The method of claim 27 wherein the drift condition includes an abnormal drift condition; and
wherein determining the abnormal drift condition includes comparing the air variable and the operating variable to a dataset of variables corresponding to normal drift conditions.

34. The method of claim 27 wherein determining the drift condition comprises using a machine learning algorithm to process the air variable and the operating variable.

35. The method of claim 27 wherein the operating variable of at least one of the airflow generator and the liquid distribution system comprises a first variable of the airflow generator and a second variable of the liquid distribution system.

36. The method of claim 27 wherein the air variable comprises a particulate variable indicative of particulate matter in the airflow.

37. The method of claim 36 wherein the air variable further comprises a relative humidity variable and an air temperature variable.

38. The method of claim 27 wherein detecting the air variable of the airflow comprises:
operating a fan of the sensor to direct a portion of the airflow through a passageway of the sensor;
heating, cooling, or both heating and cooling the at least a portion of the airflow; and
detecting the airflow variable of the portion of the airflow.

39. The method of claim 27 wherein operating the liquid distribution system of the air contactor comprises distributing the liquid onto at least one of:
a liquid absorbent material;
fill; and
an indirect heat exchanger.

40-63. (canceled)
